(19) United States
(12) Patent Application Publication
(10) Pub. No.: US 2025/0101823 A1
(43) Pub. Date: Mar. 27, 2025

(54) COALESCER FOR DOWNHOLE SEPARATION IN A MULTI-BORE WELL

(71) Applicant: Halliburton Energy Services, Inc., Houston, TX (US)

(72) Inventors: David J. Steele, Carrollton, TX (US); Matthew Bradley Stokes, Carrollton, TX (US)

(21) Appl. No.: 18/651,918

(22) Filed: May 1, 2024

Related U.S. Application Data
(60) Provisional application No. 63/585,588, filed on Sep. 26, 2023.

(51) Int. Cl. E21B 21/06; E21B 21/01

(52) U.S. Cl. CPC E21B 21/066; E21B 21/01

(57) ABSTRACT

Some implementations relate to a downhole separation system configured to be positioned downhole in a well formed in a subsurface formation, wherein the downhole separation system is configured to receive a formation fluid from the subsurface formation and configured to separate the formation fluid into a first fluid primarily comprised of a production fluid and a second fluid primarily comprised of a nonproduction fluid, the downhole separation system including, at least a first coalescer to be positioned within a downhole tubular, wherein the first coalescer is configured to separate out at least a portion of debris and the production fluid from the second fluid.

### BACKGROUND

Oil and gas wells may produce significant amounts of water in their lifetime. The percentage of water produced from these wells may be referred to as the water cut, which is the ratio of the water produced from the well compared to the volume of the total liquids produced. Most wells produce an ever-increasing water cut throughout their productive life. The end of a well's productive life is often determined by the water cut. A well is typically shut in when the value of the hydrocarbons produced is no longer sufficient to economically cover the operating costs of the well and the cost of disposing the produced water. Produced water disposal may also be referred to as saltwater disposal, or SWD, when the water comprises larger quantities of brine and/or salt. Energy is used to power the pump to lift the produced water to the surface, to separate the produced water from the oil, and to transport the separated water to a (traditionally remote or off-site) disposal well where the produced water is reinjected into a subterranean storage formation. Therefore, decreasing the water cut of a well increases the value of the produced fluids and directly decreases the disposal costs of the produced water.

One method of reducing the water cut of a well may separate produced water from the hydrocarbons downhole rather than at the surface. Downhole separation increases the overall value of the fluids produced to the surface, as much of the water/brine in the subsurface remains downhole. Downhole separation also facilitates disposal of the separated water. The separated water may be reinjected into the same zone it was produced from or into a different zone. For example, in a multilateral well having a primary borehole and one or more secondary boreholes, separated water downhole may be injected into a secondary borehole for storage without being produced to the surface. However, separating solids from the disposal fluid downhole has traditionally proven to be a challenge. Solids, including formation fines, sediments, etc., may be dislodged from a production formation and may impair fluid and plug downhole equipment.

### BRIEF DESCRIPTION OF THE DRAWINGS

Implementations of the disclosure may be better understood by referencing the accompanying drawings.

FIG. 1 is a perspective view in partial cross section of a multilateral well system that includes downhole fluid separation, according to some implementations.

FIG. 2 is a side view of an example downhole separation system (including a fluid separator, sediment separator(s), and sediment injector(s)), according to some implementations.

FIG. 3 is a perspective view of a downhole coalescer, according to some implementations.

FIG. 4 is a perspective view of a downhole coalescer having a plurality of coalescer plates, according to some implementations.

FIG. 5 is an illustration depicting a conical configuration of the coalescer plates, according to some implementations.

FIG. 6 is a longitudinal section depicting an example coalescer and solids catcher, according to some implementations.

FIG. 7 is a longitudinal section depicting an example coalescer, solids catcher, and an access door, according to some implementations.

FIG. 8 is a first illustration depicting example coalescing devices in both high-oil cut and high-water cut flow paths, according to some implementations.

FIG. 9 is a second illustration depicting coalescing devices in both high-oil cut and high-water cut flow paths, according to some implementations.

FIG. 10 is a side view of an example jet tool cleaning a downhole coalescer and then cleaning downhole solid consolidation and storage equipment, according to some implementations.

FIG. 11 is a cross sectional side view of an example cleaning of a downhole coalescer, according to some implementations.

FIG. 12 is a cross sectional side view of an example cleaning of downhole solid consolidation and storage equipment, according to some implementations.

FIG. 13 is a cross sectional view of example flow paths, according to some implementations.

FIG. 14 is a first cross-sectional view of an example coalescer in a DOWS assembly, according to some implementations.

FIG. 15 is a second cross-sectional view of an example coalescer in a DOWS assembly, according to some implementations.

FIG. 16 is a first perspective view of an example three-dimensional offset coalescer, according to some implementations.

FIG. 17 is a second perspective view of an example three-dimensional offset coalescer, according to some implementations.

FIG. 18 is a cross-sectional side view of placement of a coalescer with respect to a junction, according to some implementations.

FIG. 19 is an illustration depicting example coalescer configurations in an inclined portion of multi-bore well, according to some implementations.

FIG. 20 is an illustration depicting an enhanced image of the coalescer of FIG. 19, according to some implementations.

FIG. 21 is an illustration depicting an example coalescer and solids separation equipment positioned in an inclined portion of a multi-bore well, according to some implementations.

FIG. 22 is a perspective view of a helical oil separator, according to some implementations.

FIG. 23 is a perspective view of an example cyclonic separator, according to some implementations.

FIG. 24 is a perspective view of an example cyclonic separator performing separation on an intake fluid, according to some implementations.

FIG. 25 is a partial cross sectional side view of an example cyclonic solids separator, according to some implementations.

FIG. 26 is a partial cross sectional side view of an example group of cyclonic solids separators, according to some implementations.

FIGS. 27-28 is a flowchart of example operations for downhole fluid and solid separation, according to some implementations.

FIG. 29 is a flowchart of an example method of operations, according to some implementations.

FIG. 30 is a perspective view of an example of a Level 5 (mechanical) junction assembly for use with a downhole oil, water, and solids separator system, according to some implementations.

FIG. 31 is a cross-sectional view of an example of a Level 5 junction assembly for use with a downhole oil, water, and solids separator system, according to some implementations.

FIGS. 32A-32C are cross-sectional views of an example DOWSS positioned in a casing, according to some implementations.

FIG. 33 is a cross-sectional view of an implementation where the isolation sleeve may be shifted out of the way (or retrieved) and a deflection device installed to aid in deflecting one or more tools or devices out into a lateral bore, according to some implementations.

FIG. 34 is a cross-sectional view of a multilateral tool implementation of one or more DOWS (Downhole Oil Water Solids Separation) implementations with a non-Level 5 junction, according to some implementations.

FIG. 35 is a perspective view of a first example subsea DOWSS, according to some implementations.

FIG. 36 is a perspective view of a second example subsea DOWSS, according to some implementations.

FIG. 37 is a perspective view of types of offshore wells that may benefit from example implementations, according to some implementations.

FIG. 38 is a perspective view of an example subsea downhole oil water solids separation, according to some implementations.

FIG. 39 is a perspective view of example locations in which example implementations may be used.

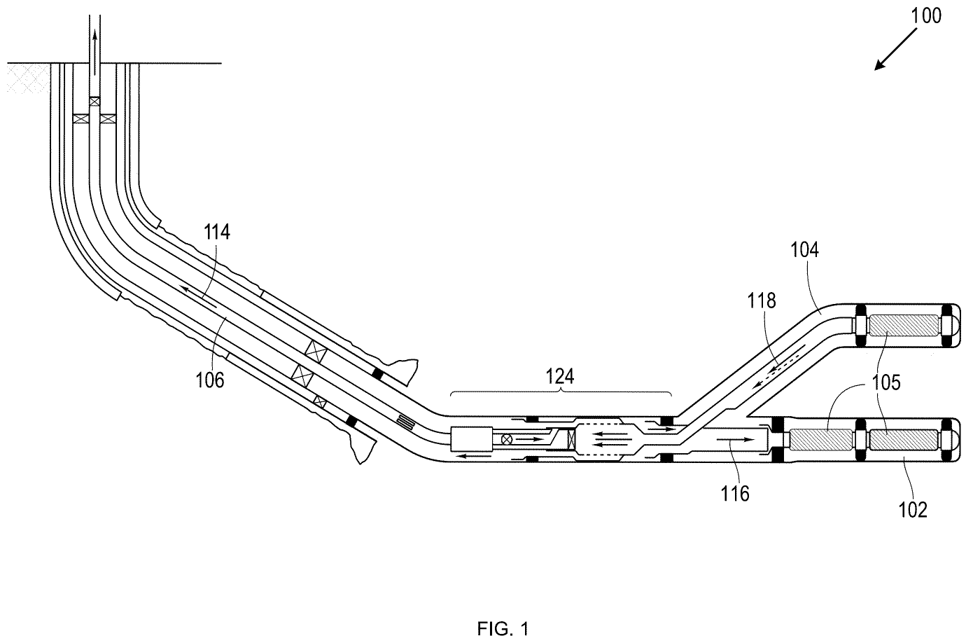

FIGS. 1-39 and the operations described herein are examples meant to aid in understanding example implementations and should not be used to limit the potential implementations or limit the scope of the claims. None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

### DESCRIPTION

The description that follows includes example systems, methods, techniques, and program flows that embody aspects of the disclosure. However, it is understood that this disclosure may be practiced without these specific details. In some instances, well-known instruction instances, protocols, structures, and techniques have not been shown in detail in order not to obfuscate the description.

To solve the challenge of separating solids from the disposal fluid downhole, one or more downhole coalescers may be deployed downhole to separate residual hydrocarbons and remove solids from the disposal fluid. Separating solids from the disposal fluid may avoid injectivity impairment caused by solids plugging. Separating oil from the disposal fluid may ensure that oil is not re-injected downhole.

Any of the devices described herein (such as the coalescers) may be used with or otherwise integrated into any of the systems and devices described herein. Some implementations may utilize a downhole coalescer. The downhole coalescer is a device used to separate fluid mixtures. Coalescence is a process whereby fluid molecules may agglomerate (come together) to form a larger whole. Typically, oil may coalesce into on the underside of the coalescer and flow upwards. Solids may slide off the top side portion of the coalescer plates and settle into a collecting area.

A coalescer may be a device or mechanism used to merge separate elements or components into a single unified whole. The term “coalesce” means to come together, aggregate, and/or to form one mass or whole. In various industries and applications, coalescers may be employed to combine dispersed particles or substances into larger groups, often to facilitate more efficient processing, separation, or filtration.

For example, in oil and gas processing, coalescers may be used to merge tiny droplets of oil into larger ones, making it easier to separate them from water. In air pollution control systems, coalescers may be utilized to combine fine aerosol particles, allowing for their removal from the air stream. Coalescers may also be used in chemical engineering processes, water treatment, and various other industrial applications where the consolidation of substances may be beneficial for effective operation.

Each downhole coalescer may include a plurality of coalescer plates. The coalescer plates may allow hydrocarbons such as oil to coalesce along their underside. The coalescer plates may be angled upward in the direction of flow to allow the coalesced oil to flow upwards. Solids in a disposal fluid sent through the coalescer plates may slide off a top side portion of each of the plates and settle into a collecting area.

Example implementations may include a wellbore system that includes a downhole fluid diverter. For example, the system may be part of a multilateral well completion that includes a fluid diverter at or near a junction between the main bore and a lateral well on the upper completion. A fluid diverter may provide separation of different types of fluids. For example, the fluid diverter may separate a formation fluid (received from the formation surrounding on the main bore) into production fluid and nonproduction fluid. For instance, the fluid diverter may include an oil and water diverter and a gas, oil, and water diverter, etc. In some implementations, the system may include a pump (such as an electrical submersible pump (ESP)) at the junction to pump the nonproduction fluid (such as water) into the lateral well so that the nonproduction fluid is injected into the subsurface formation surrounding the lateral well.

Production of water with oil increases the “lifting” and production costs of an oil well. As wells get older, the wells often begin to produce more water. To decrease the lifting and production cost related to produced water, Downhole Oil-Water Separation (DOWS) operations may be implemented to separate the water downhole and inject such water into another portion of the well. This may include disposing of the separated produced water into one or more legs of a multilateral well.

In horizontal wells, the formation fluid may separate into at least two different immiscible phases with a mixing layer in between that leads to what is called a flow structure. Example implementations may address the problem of efficiently separating the formation fluid into a nonproduction fluid (such as water) from the production fluid (such as hydrocarbons (e.g., oil)) downhole. By taking advantage of the 2-layer flow structure, most of the separation process may be handled by taking advantage of the naturally occurring 2-layer flow structure. Example implementations may include a configurable (controllable) downhole to separate a production fluid into a production fluid and a nonproduction fluid.

The one or more diverters may be self-adjusting (such as respond or adjust position, inclination, orientation, shape, composition, etc.) via external and/or internal parameters. For example, changes may be made when the fluid composition changes (such as an increase in water-cut), when the flow rate changes, when one or more flow streams change (such as oil-cut stream and water-cut stream), when the density of one or more fluids changes, when temperature, pressure, resistance, electrical conductivity, salinity, fluid composition, gas content, solids content, pH, buoyancy, viscosity, radiation level (natural radiation or radiation from a tracer or other device). The one or more diverters may be self-adjusting and remotely adjustable (such as from a control signal). Other device(s) located near a diverter may be adjusted in concert with the diverters. One or more diverters may be automatic, semi-automatic, comprise over-ride features (such as from a control signal), etc. Other device(s) located near a diverter or related to the performance of the diverters, may be self-controlled, and/or have automatic, semi-automatic, and comprise over-ride features.

Example implementations may include a wellbore system that includes a downhole fluid separator. For example, the system may be part of a multilateral well completion design that includes a fluid separator at the junction between the main bore and a lateral well on the upper completion. A fluid separator may provide separation of different types of fluids. For example, the fluid separator may separate a formation fluid (received from the formation surrounding on the main bore) into production fluid and nonproduction fluid. For instance, the fluid separator may include an oil/water separator and a gas/oil/water separator, etc. In some implementations, the system may include a pump (such as an electrical submersible pump (ESP)) at the junction to pump the nonproduction fluid (such as water) into a lateral well so that the nonproduction fluid is injected into the subsurface formation surrounding the lateral well.

Example implementations may also include downhole separation of solids from the fluids (formation fluid(s), production fluid(s) and/or nonproduction fluid(s) or any combination thereof)-thereby avoiding injectivity impairment caused by solids plugging. For instance, example implementations may include separation of solids from the nonproduction fluid to minimize or prevent plugging of the subsurface formation surrounding the lateral well where the nonproduction fluid is to be disposed. As part of hydrocarbon recovery from a wellbore, solids (formation fines, sediments, etc.) may be dislodged from the formation and produced with the formation fluids being delivered to the surface of the wellbore. In some implementations, the nonproduction fluid may be transported to a different location, at the surface and/or downhole, for further processing such as removal of remaining oil, demulsification treatment, solids removal, etc. Like operations where the fluids are produced at the surface, solids need to be dealt with when using Downhole Oil-Water Separation (DOWS) operations. The solids in a DOWS operation may provide an extra challenge of being separated downhole because these solids need to be either transported to surface of the well, disposed of downhole, or other places such as a subsea container. During processing and/or disposal, these solids may be prone to accumulate and plug off water separation and injection equipment.

Example implementations may address the downhole separation, processing, and/or disposal of these solids using a downhole coalescer. An oil coalescer is a device that may be used to separate fluid mixtures, separate solids from fluid mixtures, separate gases from fluid mixtures, etc. Coalescence may be defined as a process whereby fluid molecules agglomerate (come together) to form a larger whole. Example implementations may be applicable to Downhole Oil Water Separator Systems.

Some implementations are in reference to a “multilateral well” and “multi-bore well.” Such terms may be used interchangeably. In other words, a multilateral well may be defined to include any type of well having more than one bore, wellbore, branch, lateral, etc. For example, a multilateral well may include a main bore with one or more laterals branching therefrom. In another example, a multilateral well may also include any type of multi-bore well configuration with such bores at any angles relative to each other. Additionally, while example implementations may be used in reference to a multilateral or multi-bore well, some implementations may also be used in a single bore well. Also, the terms Downhole Oil-Water Separation (DOWS) System and Downhole Oil-Water-Solids Separation (DOWSS) System herein may be used interchangeably. Moreover, the acronyms DOWS and DOWSS herein may be used interchangeably.

Example implementations refer to a coalescer for downhole filtering. Such a screen may be designed to stop sand production before the flow enters the pump or tubing downhole. While described in reference to a coalescer, example implementations may include other types of devices for performing this filtering. For example, a screen, a sieve, etc. may be used for this filtering. A sieve may be defined as a device with meshes or perforations through which finer particles of a mixture (sand, silt, etc.) of various sizes may be passed to separate them from coarser ones.

Some implementations may refer to one or more screens. A screen as described herein may be a sand screen (also referenced as a sand control screen or a gravel pack screen). The sand screen may be considered a specialized tool installed in hydrocarbon recovery wells. A function of the sand screen is to filter out sand and other solid particles from the reservoir fluid (preventing them from entering the wellbore during production). By doing so, sand screens prevent sand production, which may be highly detrimental to well integrity and productivity.

Example implementations may coalesce fluids/solids/oil/water in downhole. Example implementations may allow solids to coalesce downhole and be accumulated downhole. Example implementations may collect coalesced oil and produce it. Example implementations may collect coalesced solids, process, and dispose of them. Example implementations may collect coalesced water, process and dispose it. Example implementations may perform maintenance on the downhole coalescer. Example implementations may exchange coalescer media. Example implementations may detect & measure solids, oil, water, and other items (volume, %, salinity, etc.). Example implementations may detect the accumulation of solids, oil, water, and other items (weight, volume, size, etc.). Example implementations may have the ability to detect the performance of a coalescer in the accumulation and processing of solids, oil, water and other items. Example implementations may signal the operator (or other device) that the solids must be removed. Example implementations may enable flushing/dislodging/scrapping/chemically treating/fluidically treating/mechanically treating, etc. of downhole coalescer and its byproducts (solids and fluids) from one or more locales. Example implementations may displace solids and related debris from the downhole coalescer and/or DOWS system. Example implementations may enable collecting solids and other materials from downhole coalescer and/or DOWS system. Example implementations may transport the solids and other materials from the downhole coalescer and/or DOWS system. Example implementations may sense one or more operational parameters and then control the coalescer and related components based up those sensed parameters and/or other information.

Example implementations may include installing the coalescer, which may include a) ability to monitor the start and operation of the system, b) ability to sidetrack the system if something happens, and c) automatically shut down and/or conduct safe mode functions.

Example implementations may include monitoring and maintaining the coalescer, which may include a) the condition of the system may be monitored real time, b) the internals of the coalescer may be replaced without pulling ESP, motors, or other major components and coiled tubing, wireline or segmented pipe may be used for removing and running. Additionally, debris may be a) flushed via produced water, oil, produced fluids, b) flushed via coiled tubing, c) stored for later transport, removal, disposal, and d) debris container may be removed without removing coalescer.

Thus, in some implementations, the separators, pumps, and an injector may be installed at the junction between the main bore and the lateral bore. In other implementations, such devices may be installed below this junction or above this junction. Further, the main bore or one or more lateral bores may include one or more orientation devices which provides depth and/or orientation control. While example implementations include a given gravity-type separator, other types of separators may be used. For example, other gravity-type separators and other non-gravity separators, such as cyclonic separators, may be used.

In some implementations, the lateral well may be drilled through a target formation. In this implementation, the main bore passes through a target production formation and the lateral bore passes through a target injection formation which is a separate formation from the production formation. The existing wells may not require a tangent section at the junction for the placement of the fluid separator, significantly increasing the number of oil well candidates for installation of the fluid separator, according to example implementations.

The design of the installed completion equipment may be critical for the downhole fluid separator to function as intended. By installing the fluid separators, pumps, and a sediment injector in the main bore at or near the junction between the main bore and the lateral bore, an existing watered-out well may be re-entered. This may decrease the overall costs involved in installing the separators, pumps, and sediment injector as compared with installation upon completion of the well at the beginning of the well's operating life. Installing the above-described equipment upon reentry into the well may also decrease the risks associated with installing these devices. For example, converting existing, poor-production wells for downhole fluid and solids separation may present a lower risk than would selecting a potential well for downhole separation equipment installation before the well completion is finished. This is because the poor producer may present a lower opportunity cost should adverse effects occur during or after installation of the downhole separation equipment.

Example implementations reference a tubing string for the delivery of fluids, sediment, etc. to the surface of the multilateral well or other downhole location. However, example implementations may use any type of flow channel, conduit, etc. for such delivery. For example, the sediment flow channel may be the annular space around the production flow tubing. Additionally, while depicting the separation being performed uphole relative to the junction between the main bore and the lateral well, example implementations may position the separation at any other location downhole. For instance, the separation may be performed at the junction, below the junction, etc.

Aspects of this disclosure may be applied to other types of remote operations where the tools, operations, processes are separated from the operators by distances, barriers, adverse environments, etc. The ability to remotely test to determine or verify whether functions were performed successfully and then communicate or report the tests results to a locale inhabitable by humans (e.g. the earth's surface) makes this disclosure suitable for use in other remote locations with harsh environments such as outer space (e.g., satellites, spacecrafts, etc.), aeronautics (aircrafts, drones), on-ground (swamps, marshes, power generation, hydrogen or other gas extraction and/or transportation, etc.), below ground (mines, caves, etc.), ocean (on surface and subsea), subterranean (mineral extraction, storage wells (carbon sequestration, carbon capture and storage (CCS), etc.)), and other energy recovery activities (geothermal, steam, etc.). The unhabitable environments may comprise corrosive fluids (hydrocarbons, H2S fluids, CO2 fluids, acids, bases, gases, etc.), contaminants (sand, debris, paraffins, asphaltenes, etc.), high-temperature fluids (fluids from geothermal formations, injected fluids, etc.), cryogenic fluids, etc. The implementations disclosed within may be utilized in harsh conditions (e.g., corrosive environments or contaminated fluids), extreme pressures (e.g., >5,000-psi differential), extreme temperatures (e.g., >−20° F. or >300° F.), etc. In other instances, well-known instruction instances, protocols, structures, and techniques have not been shown in detail to avoid confusion.

Example implementations may include coalescers may be designed so they are substantially flexible and movable without uninstalling. For example, the coalescers may be made so one or more parts (especially the coalescers sheets/elements) may be moved out of the way so other tools (tool string) may pass without damage or concern for the coalescer, the tool string, etc. For example, a jetting tool may be used to clean and remove debris from the coalescing equipment. Then the jetting tool may be moved further down hole, past the coalescer, to clean/jet other equipment such as the Downhole Solid Consolidation and Storage Equipment shown in the following figures.

The following Processing Steps mention “DOWS equipment”; DOWS equipment may imply the Coalescing System, its components and/or related equipment (i.e. solid gathering, storage, disposal system, etc.). “DOWS equipment” may also imply the one or more of the other systems related to the overall DOWS system, and/or the DOWS in total, and/or the entire Well System and its components.

It should be noted that the DOWS system and components noted may be inclusive of items from the wellhead to the toe of each wellbore and more. The cables and/or energy conduits that provide power to the one or more ESPs and/or other pumps and prime movers (downhole and on surface) may be inclusive. The surface components that transport the fluids and solids (everything) out of the well may be included. Subsea trees, subsea DOWS equipment, platform, land-base, jack up, drillship, etc. types of equipment may be inclusive. Data lines, data processing, sensors, in the well and outside of the well may be inclusive. Fluid processing equipment and processes in the well and outside of the well may be inclusive. Solids processing equipment and processes in the well and outside of the well may be inclusive.

All fluid processing equipment and processes in the well and outside of the well are inclusive. All solids processing equipment and processes in the well and outside of the well are inclusive.

The DOWS system, including, but not limited to flow inlet devices, oil-separation devices, water-separation devices, solid-separation devices, flow outlet devices, flow outlet conduits (tubing, screens, Y conduits, tees, splitters, etc.), fluid transport devices, fluid screening devices, formation support devices (liners, casings, screens, injection ports, and valves (including Outflow Control Devices (including automatic, chokes, restrictors, regulating, etc.). The outflow control devices may comprise one or more features similar to inflow control devices such as Inflow Control Devices (ICD's), Automatic Inflow Control Devices (AICD's), Gravity-based ICD's, AIDC's, Viscous-based ICD's, etc., Inertial-based ICD's, pumps, regulators, sensors, controllers, relays, transmitters, floats, etc. This list in not to limit the scope of this invention, but only to serve as providing some examples of tools, equipment, processes that may benefit from the invention(s) disclosed herein.

### Example System

FIG. 1 is a perspective view in partial cross section of a multilateral well system that includes downhole fluid separation, according to some implementations. FIG. 1 depicts a multilateral well that includes a main bore 102 and a lateral bore 104. The main bore 102 may include an open hole horizontal well. The lateral bore 104 may be an open hole inclined well. Screens 105 may be positioned in the main bore 102 and the lateral bore 104. For example, one of the screens 105 may be positioned in the lateral bore 104 at the point where the formation fluid 118 enters the tubing to prevent the larger solids from even entering the tubing. While described as being screens, alternatively or in addition, slotted liners, perforated tubing, etc. may be used to prevent the larger solids from entering the tubing. In some implementations, the screens 105 may prevent larger solids from entering the formation (such as when the formation is being utilized to store non-production fluid). The screens may also be used to prevent larger solids from entering the formation in the scenario where non-production fluid is returned to a downhole reservoir.

Example implementations may use different types of sand screens (depending on the specific well conditions and production requirements). For example, one type of sand screen is a gravel pack screen. A gravel pack screen may be used in unconsolidated formations where sand influx is a major concern. Gravel pack screens may provide additional support to the wellbore and prevent sand production effectively. Another type of sand screen is a wire-wrapped screen. Such a screen may be used in wells with fine sand particles-because such screens may filter out even the tiniest sand grains. This type of screen may offer a balance between sand control and well productivity. Another type of sand screen is a pre-packed screen that may include a pre-installed filtration media, eliminating the need for additional gravel packing. Such screens may be suitable for wells with challenging downhole conditions.

These different types of sand screens are needed in the hydrocarbon recovery industry for a number of reasons. A first reason for using sand screens is to control sand production. Uncontrolled sand influx may lead to equipment damage, reservoir damage, and even wellbore collapse (jeopardizing the entire production process). A second reason is related to well productivity. By preventing sand production, sand screens maintain the integrity of the wellbore, ensuring that production rates remain steady and consistent. A third reason for sand screens is equipment protection. Sand screens protect surface facilities and downhole equipment from abrasive sand particles that could cause wear and tear, reducing maintenance costs. A fourth reason is reservoir management. Effective sand control enhances reservoir management, allowing for optimal recovery of oil and gas resources.

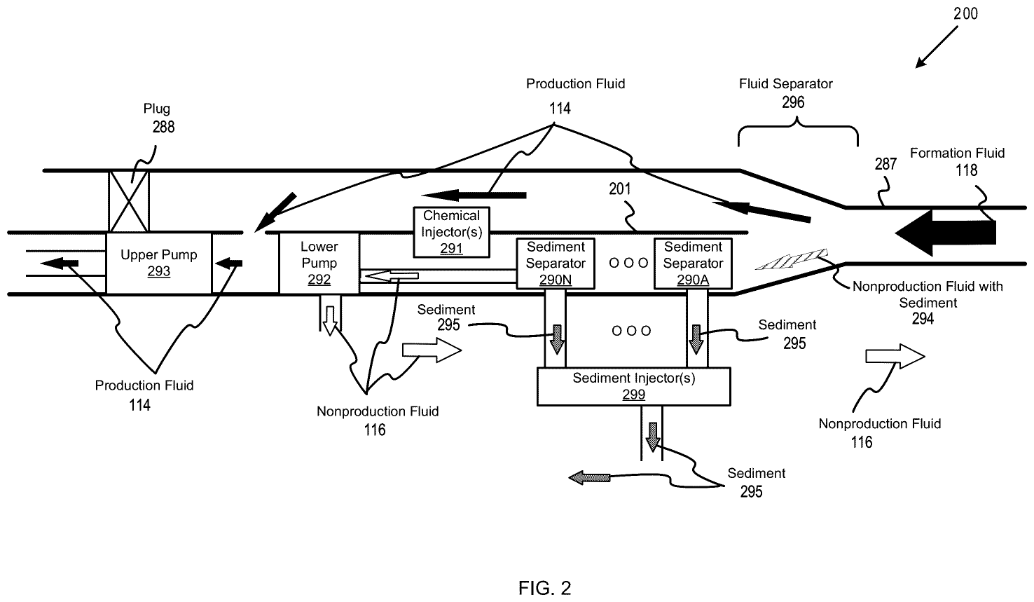

In FIG. 1, a system 100 includes a separation system 124 that may include a combination of separators for both fluid and solids (such as sediment). The separation system 124 may include pumps and sediment injectors. An example of the separation system 124 is depicted in FIG. 2 (which is further described below). A formation fluid 118 from the lateral bore may be drawn into the separation system 124. The separation system 124 may include at least one fluid separator to separate the formation fluid 118. For example, the separation system 124 may include a high-water cut separator to separate the majority of water, and then the hydrocarbon stream may have a second low-water cut separator. In some implementations, a gas separator may be included in the hydrocarbon stream, although other locations may be possible. The fluid separator may separate the formation fluid 118 into a production fluid (such as hydrocarbons (e.g., oil)) 114 and a nonproduction fluid (such as water) 116. The production fluid 114 may be delivered uphole through a production tubing such as the tubing string 106. The nonproduction fluid 116 may be delivered to the main bore 102 for injecting into the surrounding formation. Thus, example implementations may separate the nonproduction fluid downhole such that the nonproduction fluid may be directed back to the formation (or any other formation (such as a non-productive formation)) without any need to pump it back to the surface for separation and any transportation needed for storage.

The nonproduction fluid 116 may include sediment. In some implementations, the sediment may be separated out from the nonproduction fluid 116 prior to the nonproduction fluid 116 being injected back into a subsurface formation. Therefore, the separation system 124 may also include sediment separator(s) to separate out sediment from the nonproduction fluid 116.

In some implementations, the sediment that has been separated out may be stored downhole (at least temporarily in a temporary downhole storage location). In some implementations, the sediment may be delivered to the surface of the multilateral well or another downhole location using a flow channel (such as a tubing string). Examples of another downhole location may include a cavern, a disposal wellbore, a thief zone, etc. This flow channel may be the tubing string 106 used to deliver production fluid to a surface of the multilateral well. In some implementations, this flow channel may be a separate tubing string for delivery of the sediment and/or other fluids to the surface of the multilateral well or to a different downhole location. In some implementations, the sediment and/or other fluids may be injected at a different location, wellbore, storage device, etc. on the sea floor.

In some implementations, the separation system 124 may include sediment injector(s) to receive the sediment separated out by the sediment separator(s). The sediment injector(s) may inject this sediment into the tubing string 106 (used to deliver the production fluid to a surface of the multilateral well) to deliver this sediment to the surface of the multilateral well. Alternatively or in addition, the sediment injector(s) may inject this sediment into a separate tubing string to deliver this sediment to the surface of the multilateral well or to a different location.

FIG. 2 is a side view of an example downhole separation system (including a fluid separator(s), sediment separator(s), and sediment injector(s)), according to some implementations. For example, FIG. 2 depicts a separation system 200 that may be an example of the separation system 124 depicted in FIG. 1. The separation system 200 includes a tubing 287 that includes a fluid separator 296, separators 290A-290N, chemical injector(s) 291, a lower pump 292, an upper pump 293, sediment injector(s) 299, a separator 201, and a plug 288. Some implementations of the plug 288 may include a removable plug which may be removed to access equipment in, for example, a lower flow path. In some implementations, the upper pump 293 may include an electric submersible pump (ESP), although other pumps may be used. Some implementations of the sediment injector(s) 299 may also be referred to as solid debris injectors, solids injectors, injectors, injectors, debris injectors, or a variety of other names. One or more sediment injector(s) 299 may inject solid(s), non-solid(s), fluid(s) (including, but not limited to injection fluid(s), production fluid(s), nonproduction fluids, produced fluid(s), water, salt water, brines, acids, debris-laded fluid(s), lithium brine(s), lithium, minerals, formation fluid(s), etc.), gas(es) (including but not limited to natural gas(es), injected gas(es), CO2, O2, hydrogen, etc.), materials, chemicals, emulsion(s), emulsifiers, paraffin(s), a mixture of two or more of these, a mixture of one or more of these plus another matter (liquid, fluid, gas, supercritical fluid, etc.), etc. Also, while the separation system 200 is depicted in a given order, example implementations include a separation system with components that are reordered or changed (such as additions or deletions).

In some implementations, the sediment separators may also separate out fluid(s) (such as gas and/or water from oil-cut fluids, gas and/or oil from water-cut fluids, etc.). In some implementations, separators 290A-290N, may comprise one or more downhole coalescers. For example, the separators 290A-290N may include a coalescer including one or more coalescer plates to coalesce lighter fluids (including oil droplets, gases) and to separate out solids, basic sediments, etc. Basic sediment(s) may be defined as an unresolved emulsion between a clean (er) oil phase and a water (er) phase which may also include paraffins, asphaltenes, etc. Solids may be defined as material(s) or component(s) heavier than the water phase. Solids may include various sands, silts, clays, formation fines, scale, drilling mud, iron oxide, iron sulfide, manmade (proppants, cement, etc.), natural (e.g., igneious, metamorphic, sedimentary, etc.), etc. Some implementations of the separators 290A-290N may comprise one or more other coalescer-type devices having blades, fins, sheets, or other units configured to separate out solids and gases and/or lighter fluids. Also, while the separation system 200 is depicted in a given order, example implementations include a separation system with components that are reordered or changed (such as additions or deletions).

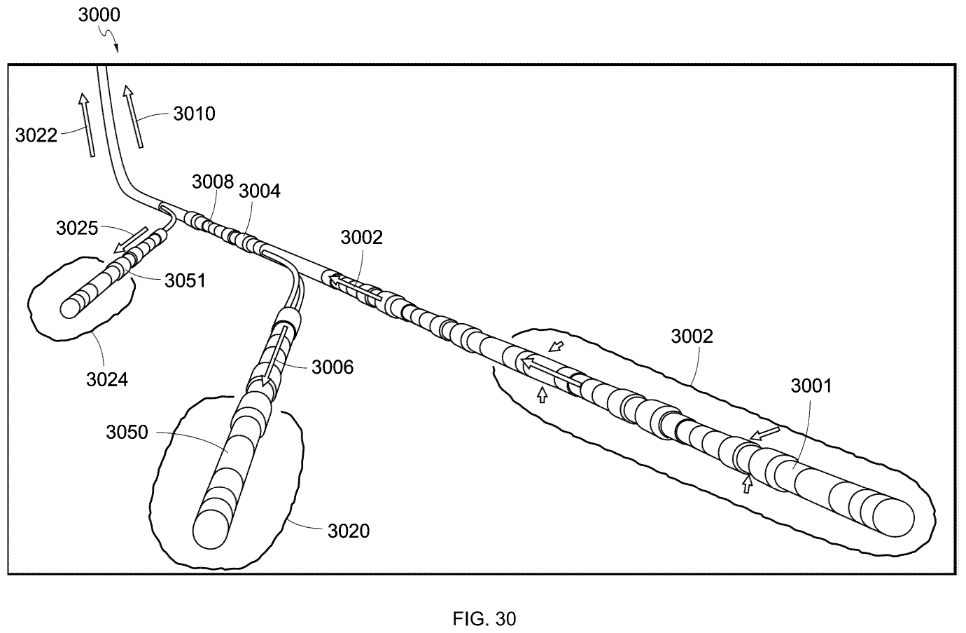

The formation fluid 118 flows into the fluid separator 296. In this example, the fluid separator 296 comprises a gravity-based separation that includes the separator 201. As shown, the formation fluid 118 moves from a smaller to a larger diameter of the tubing 287. The tubing 287 is shown as one continuous tubing for ease of clarification. However, in some implementations, the tubing 287 may comprise one or more devices with different configurations. For example, with reference to FIG. 30 (which is further described below), the tubing 287 may be connected to 3070 or the Level 5 “steel” junction. In some implementations, the larger diameter of the tubing 287 may be a part of the tubing string 106 shown in FIG. 1. In some implementations, the larger diameter of the tubing 287 may be part of an intermediate tubing string disposed between the tubing string 106 and the tubulars conducting fluid from the lateral leg.

This may decrease the velocity of the flow of the formation fluid 118—which allows the separation. In particular, most or at least a majority of the production fluid 114 may separate into a flow above the separator 201, while most or at least a majority of the nonproduction fluid with sediment 294 may separate into a separate flow below the separator 201. This allows most of the sediment to be captured in the lower portion of the tubing 287 (below the separator 201).

While depicted as having the separator 201, in some implementations, there is no separator 201. Rather, the production fluid 114 and the nonproduction fluid with sediment 294 may naturally separate in a horizontal pipe because of their differing densities. Accordingly, even in a same tubing without the separator 201, most of the production fluid 114 would be above the nonproduction fluid 116 because of the differences in weight (density) between the two types of fluid. In some implementations. the horizontal line formed between the separation of the production fluid 114 and nonproduction fluid 116 may be referred to as the oil-water contact (OWC).

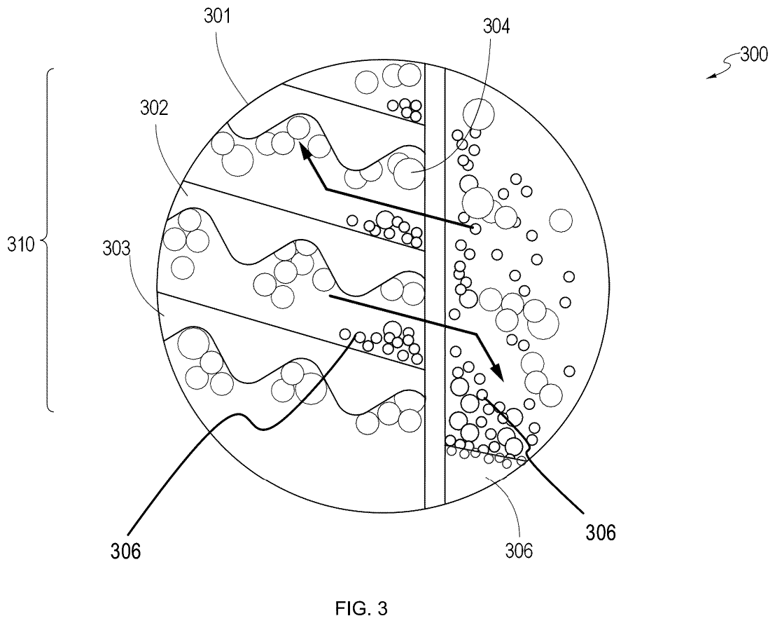

The nonproduction fluid with sediment 294 flows into the sediment separators 290A-290N, which may represent one to any number and type of sediment separators. In some implementations, each of the sediment separators 290A-290N may separate some of the sediment in the nonproduction fluid with sediment 294. For example, a first sediment separator 290A may be used to separate and collect the largest size (or highest density) sediment depending on its configuration. Some implementations of the sediment separator 290A (and also applicable to the sediment separators 290A-N for other sediment sizes and/or densities) may include a screen-type device configured to filter solids by size. The sediment separator 290A may separate out the largest-sized sediment. Some implementations of the sediment separators 290A-N may include a gravity-based or cyclonic-based separator configured to separate out solids by their density regardless of size. For example, the sediment separator 290A in the cyclonic configuration may be configured to separate out the highest density sediment. A second sediment separator 290B may be used to separate and collect the next largest size sediment (or next denser particles); the third sediment separator 290C may be used to separate and collect the next largest size sediment (or next denser particles); etc. (as the flow moves through the different sediment separators). For example, at least one of the sediment separators 290 may be a cyclonic separator-wherein denser particles in the rotating stream having too much inertia to follow the tight curve of the stream. Such particles may thus strike the outside wall and fall to the bottom of the cyclone where they may be removed. In some implementations, each of the sediment separators 290 may store the sediment that was collected into an associated storage area or tank. Examples of the different sediment separators 290 are depicted in FIGS. 3-12, which are further described below. It is denoted that the sediment separators shown in FIGS. 3-12 (and other places) may be classified as coalescers. The coalescers may have the prime function of separating out solids, however, they may also take on the role of separating out gases and/or high-density fluids.

Additionally, the chemical injector(s) 291 may inject one or more chemicals into at least one of the formation fluid 118, the production fluid 114, the nonproduction fluid with sediment 294, the nonproduction fluid 116, or the sediment 295. While depicted such that chemicals are injected downhole, alternatively or in addition, chemicals may be injected from the surface of the multilateral well or from a subsea locale. Also, different chemicals may be injected for different purposes. For example, a flocculant or deflocculant may be injected to promote or not promote aggregation or settling of suspended particles in a liquid. Other examples of chemicals being injected may include paraffin, solvents, dispersants, etc. being added to the production fluid 114, a scavenger being added to the production fluid 114 to protect components from corrosive gases (H₂S, CO₂, etc.) therefrom, etc. In particular, crude oils often contain paraffins which precipitate and adhere to the liner, tubing, sucker rods and surface equipment as the temperature of the producing stream decreases in the normal course of flowing, gas lifting or pumping. Heavy paraffin deposits are undesirable because they reduce the effective size of the flow conduits and restrict the production rate from the well. Where severe paraffin deposition occurs, removal of the deposits by mechanical, thermal, or other means is required, resulting in costly down time and increased operating costs.

In some implementations, these different collections of the sediment by the different sediment separators 290 may be injected into a same or different line or tubing for disposal. As shown, the sediment injector(s) 299 are coupled to receive the sediment collected by the different sediment separators 290.

In some implementations, the separation system 200 and/or any one or more of the components within the separation system 200 may be oriented with respect to gravity. For example, components such as the fluid separator 296, separator 201, sediment separators 290A-N, etc. may be oriented with respect to gravity such that gravity may assist in separating the phases of the formation fluid 118, sediment 295 from the formation fluid 118, etc.

Periodically, sediment may need to be emptied from the different sediment separators 290 via the sediment injector(s) 299. The decision of when may be based on different criteria. For example, pressure and/or production flow may be monitored at the surface of the multilateral well. If the pressure and/or production flow start to degrade, it may be an indication that sediment needs to be emptied from the sediment separators 290.

In some implementations, sensors may be coupled to each of the tanks of the sediment separators 290. A signal from a given sensor may indicate when the associated sediment separator 290 needs to be emptied. A controller (downhole and/or at the surface of the multilateral well) may be communicatively coupled to the sensors such that the controller may initiate a sequence to empty one or more of the tanks of the sediment separators 290. The controller may be human, electronic, computer, or any combination thereof. It may be Artificial Intelligence (AI) assisted, Deep Learning, Machine Learning, LLM assisted and/or assisted with software and hardware.

In some implementations, the sediment injector(s) 299 may dispose of these sediments by injecting them into a tubing for delivery to the surface of the multilateral well. For example, the sediment may be delivered to the surface using the production tubing or a separate tubing. If the production tubing is used, the solids may be included with the production fluid that is being delivered to the surface. In such implementations, separation operations may be performed at the surface to separate out the solids from the production fluid 114.

Accordingly, if sediment is being included with the production fluid 114 being delivered to the surface, the production fluid 114 may be delivered to surface equipment that provides for separation of the sediment. Alternatively, during the time when the sediment is not being included with the production fluid 114, the production fluid 114 may be delivered to different surface equipment that does not include such separation of sediment.

Alternatively or in addition, the sediment injectors 299 may deliver the sediment to a different downhole location (such as a different lateral well, a thief zone (having a high porosity, high permeability downhole zone that may include a low pressure), etc.). In some implementations, sediment may be disposed to different locations depending on their size. For example, for sediment having a size greater than X, such solids may be delivered to the surface of the multilateral well for disposal. For sediment having a size less than X but greater than Y, such sediment may be disposed in a first downhole location (such as a thief zone). For the remaining sediment that have a size less than Y, such solids may be disposed in a second downhole location (such as a lateral well).

In some examples, the sediment (or solid) Y may be larger, or the same size as sediment X. As an example, if the first hole location is very permeable and may accept larger-size solids (or sediments), the larger size solids may be injected or disposed into the first downhole location and the smaller size solids may be either produced to the surface and/or injected or disposed into a second downhole location.

In some examples, X may range from 0.01 mm (10 microns) to larger than 8.00 mm (8000 microns). For example, X may range from medium silt to larger than medium gravel. In some examples, Y may be 0.01 mm (10 microns) or smaller. In some examples, X may range from.02 mm (20 microns) to 8.00 mm (8000 microns). For example, X may range from medium silt to larger than medium gravel.

In some examples, Y may be.02 mm (20 microns) or smaller. In some examples, Y may be 0.01 mm (10 microns) to 02 mm (20 microns). In some examples, X may range from 0.063 mm to 2.00 mm (63 microns to 2000 microns) (e.g., solids defined as sand per ISO 14688-1:2002). In some examples, Y may be.063 mm (63 microns) or smaller. In some examples, Y may be 0.02 mm (20 microns) to 0.063 mm (63 microns). In some examples, X may range from 0.075 mm to greater than 4.75 mm (75 to greater than 4750 microns). In some examples, Y be.075 mm (75 microns) or smaller.

In some examples, Y may be 0.02 mm (20 microns) to 0.075 mm (75 microns). In some examples, X may be greater than 4750 microns. In some examples, Y be 4.75 mm (4775 microns) or smaller. In some examples, Y may be 0.02 mm (20 microns) to 4.75 mm (4775 microns). In some examples, X may be greater than 0.6 mm (600 microns) (e.g., coarse sand and larger). In some examples, Y be 7.5 mm (75 microns) or smaller. In some examples, Y may be 0.02 mm (20 microns) to 7.5 mm (75 microns).

Some example implementations may include weir skimmers that function by allowing the oil floating on the surface of the water to flow over a weir. In some implementations, the weir skimmers may require the weir height to be adjusted. In some implementations, the weir skimmers may be such that the weir height is automatic or self-adjusting. While manually adjusted weir skimmer types may have a lower initial cost, the requirement for regular manual adjustment makes self-adjusting weir types more popular in most applications. Weir skimmers may collect water if operating when oil is no longer present. To overcome this limitation, the weir type skimmers may include an automatic water drain on the oil collection tank.

Accordingly, example implementations may detect the accumulation of solids in DOWS equipment. An operator (or other device) may be signaled that the solids should be removed. In response, an operational change in the DOWS equipment may be initiated to allow solids removal. For example, this may include shut down or reduction of DOWS-related operations (decrease or shut down pumps, switch valves that direct fluids to the surface and/or other location, etc.). Preparation of the solid's removal process may be initiated. For example, access sleeves and flushing ports may be opened, solids directional control equipment may be adjusted (e.g., change position), injection devices, sleeves, ports, valves, etc. may be closed, solids processing/removal equipment (from surface and/or downhole) may be deployed, etc. Additionally, flushing, dislodging, scrapping, chemically treating, fluidically treating, mechanically treating, etc. of downhole solids from one or more locations downhole may be enabled. Solids and related debris from the DOWS system (DOWSS) may be displaced. In some implementations, debris including solids and other materials may be collected from the DOWSS. The solids and other materials may be transported from the DOWSS. Fluids, chemicals, solvents, acids, liquids, abrasive media, solids, and other materials may be transported from the surface to the DOWSS.

Items such as water, chemicals and other items listed above may be transported in a controlled manner. For example, the transporting in a controlled manner may be based on speed, velocity, volumes, ratios, time-based (e.g., until a certain amount of time has passed), function-based (e.g., until a certain pressure-drop is experienced, until fluid has been circulated “bottoms up”, etc.). For example, the transporting in a controlled manner may be based on when Z number of tubing strings of fluid has been pumped or until X-amount (e.g., pounds, mass, volume, etc.) of debris has been recovered, collected, injected, disposed, transferred, etc. Tools, devices, flow, etc. may be moved, shifted, directed, etc. to improve the solids collecting, removal, retaining, and flushing process(es). For example, a direction of a jetting nozzle may be changed, one flushing port may be closed while opening another, etc. Tools, devices, components, strings, etc. may be repositioned from one location to another to continue the one-or-more above processes. Additionally, tools, devices, components, strings, etc. may be repositioned to dispose of solids in a preferred location.

One or more fluids, chemicals, solvents, acids, liquids, abrasive media, solids, and other materials may be moved from the surface of the well to the DOWSS to enhance the longevity of the DOWSS. This may include applying and/or re-applying friction reducing coatings, replacing components-filters, stators, pumps, rotors, bearings, bearing assemblies, worn parts, eroded parts, electrical components, sensors, computers, controllers, logic devices, parts intend to be consumed including wear pads, erosion pads, corrosion pads, filters, screens, etc.

Also, the shutting down of the solid's removal process may be initiated. For example, access sleeves and flushing ports may be closed, solids directional control equipment may be adjusted. Injection devices, sleeves, ports, valves, etc. may be opened. Solids processing and removal equipment may be retrieved (from the surface and/or other location downhole. Used or worn devices from well may be retrieved. Such devices may include filters, stators, pumps, rotors, bearings, bearing assemblies, worn parts, eroded parts, electrical components, sensors, computers, controllers, logic devices, parts intend to be consumed including wear pads, erosion pads, corrosion pads, filters, screens, etc.

An operational change in the DOWS equipment may be initiated to allow fluid separation again. This may include “turning on” or increase of DOWSS-related operations (e.g., increase or turn-on pumps, switch valves that direct fluids to the surface and/or downhole, etc.). Also, the operator (or other device) may be signaled that the DOWSS equipment has been re-configured out of the solids-removal status and is ready to begin fluid separation operations. The DOWS may then return back to fluids separation mode. Additionally, there may be provided a continuous or occasional status check of the “health” of DOWS equipment.

It should be noted that the DOWS system and components noted may be inclusive of items from the wellhead to the toe of each wellbore and more. The cables and/or energy conduits that provide power to the one or more ESPs and/or other pumps and prime movers (downhole and on surface) may be inclusive. The surface components that transport the fluids and solids (everything) out of the well may be included. Subsea trees, subsea DOWS equipment, platform, land-base, jack up, drillship, etc. types of equipment may be inclusive. Data lines, data processing, sensors, in the well and outside of the well may be inclusive. Fluid processing equipment and processes in the well and outside of the well may be inclusive. Solids processing equipment and processes in the well and outside of the well may be inclusive.

The steel multilateral junction may be placed above or inside the target formation. In some implementations, this configuration may be accomplished in a two-trip multilateral completion that includes a lower completion and an upper completion that may comprise the fluid separator, a pump (such as an electrical submersible pump, rod pump, Rotaflex, etc.) and an upper packer. This may simplify the installation. This reduced complexity allows the fluid separator to be installed into existing wells, i.e., retrofitting existing wells. Further, the lateral well may be a target formation. In this implementation, the main bore passes into a target production formation and the lateral bore passes into a target injection formation which may be a separate formation from the production formation. The existing wells do not require a tangent section at the junction for the placement of the fluid separator, significantly increasing the number of oil well candidates for installation of the fluid separator according to example implementations.

Example implementations may be used in non-horizontal applications (inclined wells, extended reach wells, slant hole wells, vertical wells, S-wells, or combination thereof, etc.). In some applications, such as inclined wells, a flow diverter may be used in conjunction with other devices. The other devices may be one or more destabilizers, a gravitational separator, a non-gravitational separator, a combination of both gravitational and non-gravitational, a coalescing device, a cleaning device, another flow diverting device, a leveling device, an inclination device to monitor, sense, adjust, change the inclination of one or more devices with respect to gravity and/or the inclination of the well, an orientation device to monitor, sense, adjust, change the orientation and/or azimuthal position of one or more devices, systems etc. One or more orientation devices (powered and non-powered) may be used. Example implementations may also include cartridges.

The design of the installed completion equipment may be critical for the downhole fluid separator to function as intended. By installing the fluid separators, pumps, and sediment injector(s) in the main bore at or near the junction between the main bore and the lateral bore, an existing watered out well may be re-entered, and a new lateral added to it. This decreases the overall cost involved in installing the separators, pumps, and sediment injector according to example implementations as compared with installing it at the completion of the well at the beginning of the life of the well. It also decreases the risks associated with installing these devices according to example implementations in existing wells that may be poor producers and represent a smaller cost if the well is lost during the trial as compared with selecting a potential well before well completion is finished. Using these separators and injectors in a downhole setting combined with a multilateral junction may provide efficiency gains.

This includes converting poor performing wells, wherein the percentage of oil has decreased to about 2% for example, into a downhole water injector combined with a better producing well. Additional benefits include lower flow rate and pressure rating requirements, a lighter fluid column, and increased recovery. Example implementations may be particularly useful in low flow rate wells (in the 200 barrel per day range or less), which tend to be shallow, and relatively inexpensive to drill. Moderate flow rate wells, for example 500-5000 barrels of fluid per day, may also be potential candidates for incorporating example implementations. Finally, it will also be useful for most multilaterals with very high flow rate wells, up to 50,000 barrels of fluid per day, for example.

Example implementations reference a tubing string for the delivery of fluids, sediment, etc. to the surface of the multilateral well or other downhole location. However, example implementations may use any type of flow channel, conduit, etc. for such delivery. For example, one or more D-shaped tubes, referred to as D-Tubes, may be used. For instance, two D-Tubes may be used to optimize the use of the inner diameter of a casing to maximize flow area. In some implementations, the sediment flow channel may be the annular space around the production flow tubing. Additionally, while depicting the separation being performed uphole relative to the junction between the main bore and the lateral well, example implementations may position the separation at any other location downhole. For instance, the separation may be performed at the junction, below the junction, etc.

The DOWSS may include flow inlet devices, oil-separation devices, water-separation devices, self-deprecation devices, flow outlet devices, flow outlet conduits (tubing, screens, y's, tees, splitters, etc.), fluid transport devices, fluid screening devices, formation support devices (liners, casings, screens, injection ports, and valves (including Outflow Control Devices (including automatic, chokes, restrictors, regulating, etc.). The outflow control devices may comprise one or more features similar to inflow control devices such Inflow Control Devices (ICD's), Automatic Inflow Control Devices (AICD's), Gravity-based ICD's, AIDC's, etc., Viscous-based ICD's, AIDC's, etc., Inertial-based ICD's, AIDC's, etc., pumps, regulators, sensors, controllers, relays, transmitters, floats, etc.

Examples implementations may include an injecting-while-producing system —wherein one pump may be used to force fluid into one formation and a second pump may be used to produce fluid from a second zone. This single-bore water-flood solution maintains downhole pressure to reduce cycling and recover more oil in struggling wells. The injecting-while-producing system may inject from an upper zone and produce from the lower with the aid of isolation packers, or it may inject in the bottom zone and produce from a zone higher in the well.

### Example Downhole Coalescers

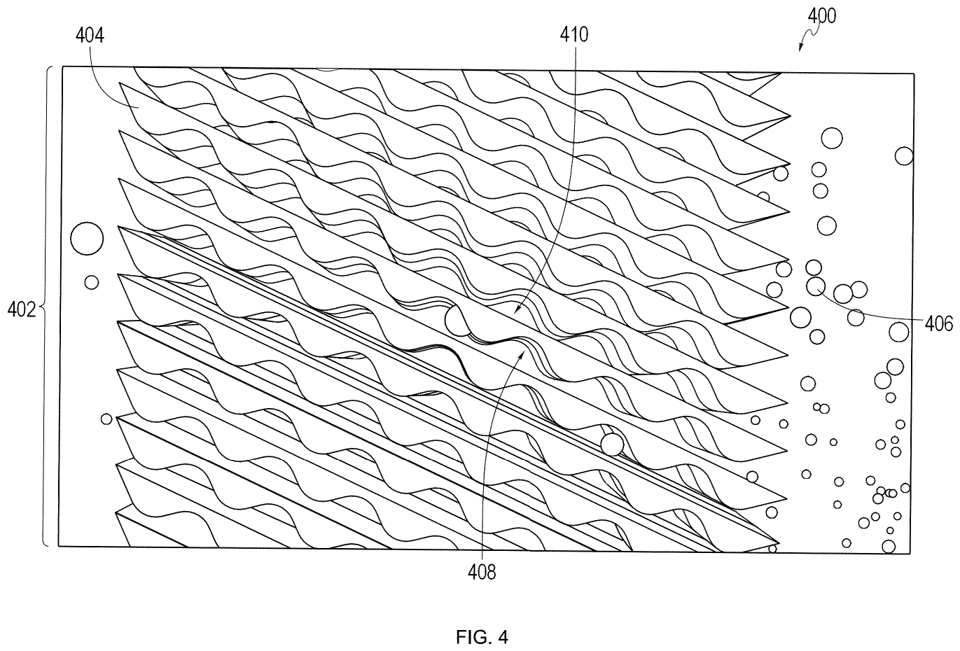

One or more downhole coalescers may be used within the sediment separators 290A-290N to facilitate water, residual oil, and solids separation downhole. FIG. 3 is a perspective view 300 of a downhole coalescer, according to some implementations. More specifically, the perspective view 300 includes at least a portion of a downhole coalescer 310 having a plurality of coalescer plates 301-303. The downhole coalescer 310 may be configured to separate a hydrocarbon 304 and solids 306. For example, oil may coalesce on the underside of each of the coalescer plates 301-303 of the downhole coalescer 310. The coalescer plates 301-303 may be angled to allow the hydrocarbon 304, which may include oil droplets, to flow upwards. The solids 306 may slide off a top side of the coalescer plates 301-303 and settle into a collection area. Example implementations may include accumulation of downhole solids in a DOWS operation using a coalescer to separate, accumulate, transport, and dispose of the solids to a location that will not interfere with the operation of the DOWS equipment and related equipment. Although only plates 301-303 are depicted, the downhole coalescer 310 may include additional coalescer plates, as depicted in FIG. 4.

FIG. 4 is a perspective view of a downhole coalescer having a plurality of coalescer plates, according to some implementations. Specifically, a perspective view 400 includes a downhole coalescer 402 similar to the downhole coalescer 302 of FIG. 3. The downhole coalescer 402 includes a plurality of coalescer plates 404. A hydrocarbon 406 may coalesce along an underside 408 of the coalescer plates 404 and slowly flow from one side of the downhole coalescer 402 to the other. The coalescer plates 404 may be angled such that each of the coalescer plates 404 are angled upwards in the direction of fluid flow such that solid particles hit and the coalescer plates 404 and slide off the end. In some implementations, the coalescer plates 404 made be comprised of a high-strength thermoplastic material such as polyvinyl chloride (PVC), high-density polyethylene (HDPE), polycarbonate (PC), etc. that may be robust in various types of hydrocarbons and downhole environments. However, other materials may be used. The coalescer plates 404 have no moving parts, no consumables, and are gravity operated. Therefore, the downhole coalescer 402 may last for years in downhole conditions.

The coalescer plates 404 may be shaped with a rounded underside 408 and a flat top side 410. In some implementations, the coalescer plates 404 may include at least one corrugated side (typically the underside 408), although other geometries may be possible. The coalescer plates 404 may be configured to separate droplets of production fluid (residual oil, gas, etc.) from the non-production fluid with sediment 294. The hydrocarbons 406 may, for example, initially impact the top side 410 of each of the coalescer plates 404. According to Stokes' Law, spherical oil droplets (such as the hydrocarbons 406) may rise to the underside 408 of an above coalescer plate due, in part, to a lesser density than the disposal fluid (fresh water, brine, etc.). Larger droplets may form, and multiple larger droplets may combine to form an oil film. Van der Waals forces may cause the hydrocarbons 406 to adhere to the undersides 408 of the coalescer plates 404.

In some implementations, buoyancy forces may allow the hydrocarbons 406 to flow upward, and continued axial fluid flow (e.g., from right to left in FIG. 4) may induce lateral movement of the hydrocarbons 406 along an underside of the coalescer plates 404. Therefore, droplets of the hydrocarbons 406 may coalesce within and eventually pass through the downhole coalescer 402. The droplets may coalesce into larger droplets or a film along the underside 408. Some implementations of the coalescer plates 404 may include holes at local maxima of the underside 408 to allow the hydrocarbons 406 to ascend the coalescer 402. The coalescer plates 404 may be angled such that each of the coalescer plates 404 are angled upwards, with respect to the direction of gravity, such that solid particles hit the coalescer plates 404 and slide off the center slots and/or edges of the coalescer plates. Oil particles may hit the coalescer plates 404 when they are angled upwards with respect to the direction of gravity. The oil particles may contact the coalescer plates 404 and float upwards (opposite direction of gravity) and collect in the top quadrant of the pipe (e.g., between the 10-o'clock to 2-o'clock positions).

In contrast to the hydrocarbons 406, solid debris and various sediments may be denser than the disposal fluid. As depicted in FIG. 3, the solid debris may impact the top side 410 of each of the coalescer plates 404. The solid debris, such as the solids 306 from FIG. 3, may not pass through the downhole coalescer 402.

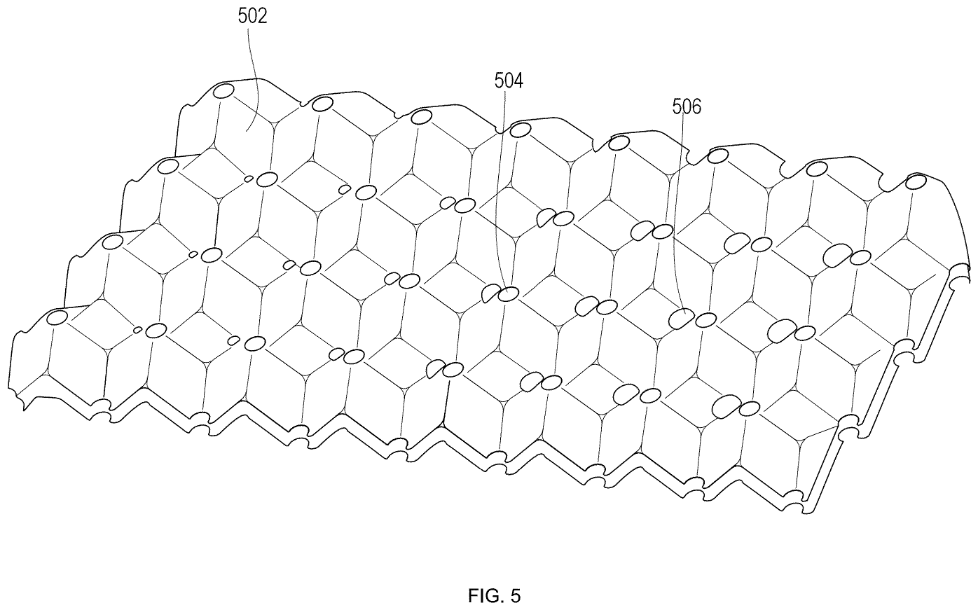

While the coalescer plates 404 of FIG. 4 are depicted as having a corrugated underside, other geometries may also be used. For example, FIG. 5 is an illustration depicting a conical configuration of the coalescer plates, according to some implementations. Rather than using a corrugated underside 408 and flat top side 410, a downhole coalescer may use one or more conical coalescer plates 502. Each conical coalescer plate may include a production fluid passthrough 504 and a solid debris passthrough 506. The passthroughs 504, 506 may be holes within each conical coalescer plate 502 that allow material to move through a stack of multiple coalescer plates 502. For example, the production fluid passthrough 504 may allow droplets of hydrocarbons to ascend through each conical coalescer plate 502. Eventually, hydrocarbons may coalesce at the top of a conical coalescer stack. The solid debris passthrough 506 may allow solid debris to fall through each conical coalescer plate 502. The conical coalescer plates 502 may include vertically-angled walls surrounding the production fluid passthrough 504. Some implementations of the vertically angled walls may be conical, although pyramidal walls and other geometries may be used. Solid material such as sediment may contact the angled walls and continue to fall through additional solid debris passthroughs until they are accumulated beneath the downhole coalescer. Another potential geometry of the coalescer plates 502 may include domed coalescer plates. For example, some implementations of the coalescer plates 502 may include a dome-shaped concave underside and a dome-shaped convex top side. Similar to the conical configuration, solids may fall through each solid debris passthrough 506 whereas production fluid may pass through the production fluid passthrough 504.

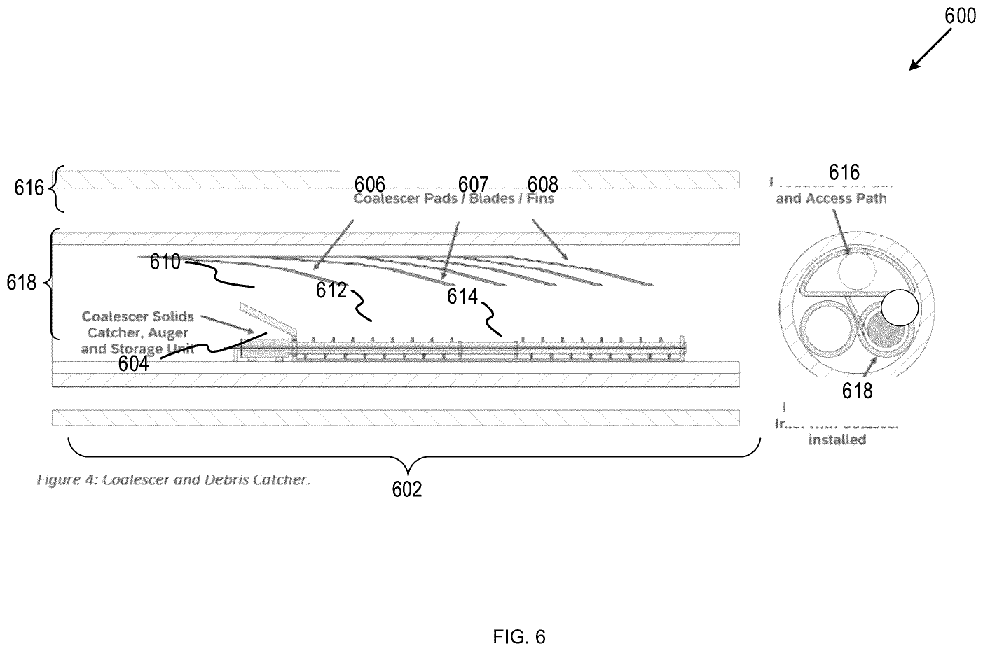

FIG. 6 is a longitudinal section depicting an example coalescer and solids catcher, according to some implementations. Specifically, a longitudinal section 600 includes a sediment separator 602 which may be similar to each of the sediment separators 290A-N of FIG. 2. The sediment separator 602 may include the coalescing devices 606, 607, and 608. The coalescing devices 606-608 may be coalescer pads, blades, and/or fins similar to the coalescer plates 404 of FIG. 4. However, other geometries may be used. For example, some implementations of the coalescing devices 606-608 may be formed from one or more flexible, rectangular strips. These rectangular strips may be flexible to allow for the passage of tools. The coalescing devices 606-608 may be configured to separate production fluid, like hydrocarbons, and solid debris from non-production fluid. In some implementations, various quantities of coalescing devices, such as the coalescing devices 606-608, may be used. Oil droplets separated via the coalescing devices 606-608 may flow into a produced oil path 616. The coalescing devices 606-608 may be positioned within a produced water inlet (also referred to as a water production path) 618.

Debris (such as solid debris) may be separated from a nonproduction fluid via the coalescing devices 606-608. Debris may refer to solids, sediment, sand, silt, salts, emulsion(s), fluids, basic sediment(s), paraffins, asphaltenes, a slurry, processed media (via filtration, separation, coalescence, etc.), a combination of any of the above materials, etc. In some implementations, “debris” and “solid debris” and/or “debris” and “solids”, etc. may be used interchangeably.

Debris may fall from the coalescing devices 606-608 to a solids catcher 610. The solids catcher 610 may guide solid debris into a solid debris transport device 612. In some implementations, the solid debris transport device 612 may include one or more augers, a drag chain, an inclined plane, a jetting device, and/or other devices to keep the solids or a slurry including the solids from accumulating at the discharge end of the solid debris transport device 612 which may cause the device to plug and become inoperable. The solid debris transport device 612 may be operated to move via a motor 604. As depicted in FIG. 6, an auger may guide collected solids to a solid debris storage unit 614 for temporary storage. The solid debris may be temporarily stored for later transport, removal, and disposal. In some implementations, a motor 604 may actuate the solid debris transport device 612. The motor 604 may operate intermittently and may be coupled to a processor (or controller), one or more sensors, an electrical line to provide power and/or commands to and from the processor, etc. Some implementations of the solid debris storage unit 614 may include a removable container that may be removed from the sediment separator 602 without pulling or dislodging the coalescing devices 606-608.

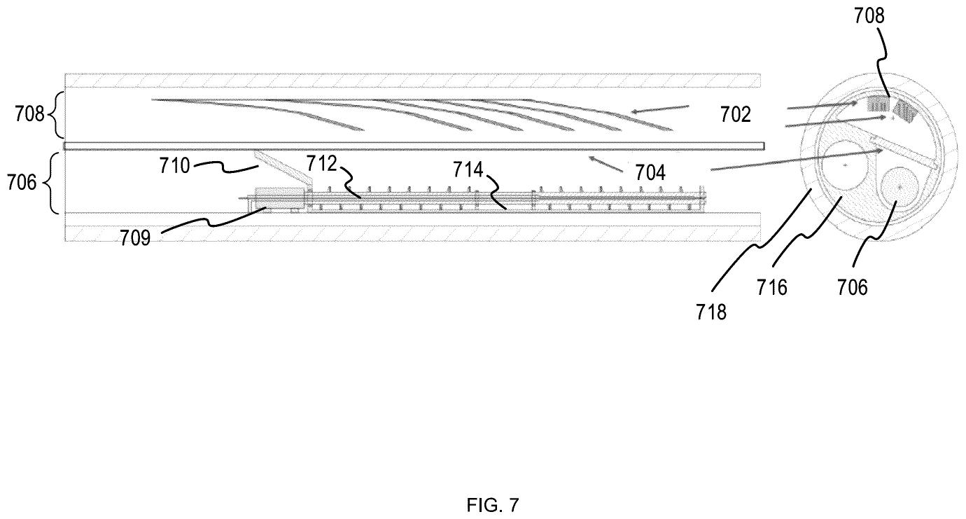

FIG. 7 is a longitudinal section depicting an example coalescer, solids

catcher, and an access door, according to some implementations. In contrast to FIG. 6, a plurality of coalescing devices 702 may be positioned within an oil production path 708. An access door 704 may separate the oil production path 708 from a water production path 706. Solid debris transport devices such as a motor 709, solids transport device 712, solids catcher 710, and solid debris storage unit 714.

The coalescing devices 702 may coalesce production fluid and filter out solid debris. The solid debris may accumulate along a top side of the access door 704 when the access door is closed. The access door 704 may be hinged along a single side of a divider section 716 within a downhole tubular 718, and a catch mechanism may be positioned along an opposing side of the water production path 706 from the access door 704. In some implementations, the access door 704 may swing down into the water production path 706 to allow solid debris to be collected by the solids catcher 710. In some implementations, the access door 704 may be configured to isolate pressure between the oil production path 708 and water production path 706. Thus, when the access door 704 is closed, solid debris may be moved to a disposal location, produced to the surface, etc. separate from hydrocarbons in the oil production path 708.

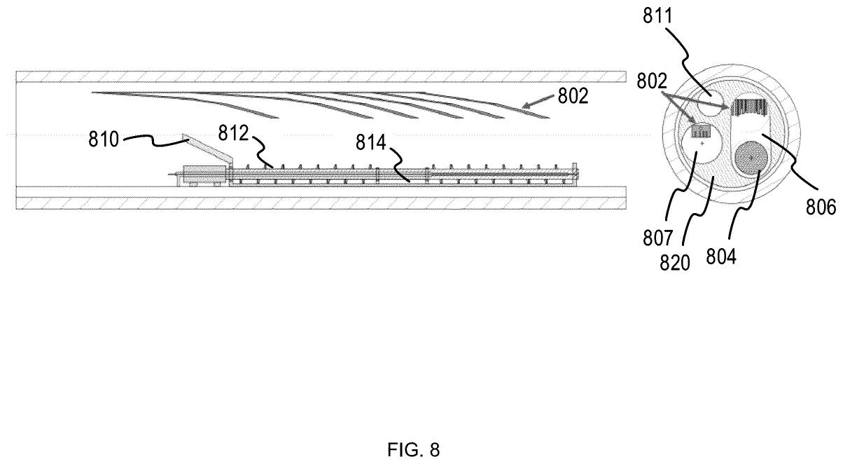

In some implementations, coalescing devices having one or more coalescer plates may be included in both high-oil cut and high-water cut flow paths. FIG. 8 is a first illustration depicting example coalescing devices in both high-oil cut and high-water cut flow paths, according to some implementations. A plurality of coalescing devices 802 may be positioned in a high-oil cut path 806. The coalescing devices 802 may be configured to separate solids from a production fluid within the high-oil cut flow path 806. The coalescing devices 802 may also be included in a high-water cut flow path 807. The high-oil cut flow path 806 and high water-cut flow path 807 may be separated by a separator 820. The high-water cut flow path 807 may function in parallel with the high-oil flow path 806.

In this depicted configuration, water and oil may separate by density along the flow paths 804 and 806. The solids and water produced via the flow path 804 may, for example, be injected into a storage formation via the coalescing devices 802 in the high-water cut flow path 807. The coalescing devices 802 in the high water-cut flow path may separate residual hydrocarbons and solid debris from a nonproduction fluid. In some implementations, the high-water cut flow path 807 may be produced to the surface, Thus, the high-water cut flow path 807 and high-oil cut flow path 806 may be rid of solid debris as their respective fluids are injected for storage, produced to the surface, etc. The coalescing devices 802 in the high-water cut flow path 807 may also limit an amount of oil that is re-injected into the subsurface. Solids separated from the high-oil cut flow path 806 and high-water cut flow path 807 may be collected and stored via a solids collector 810, solids transport device 812, and a solid debris storage unit 814. In some implementations, an upper water flow path 811 may act as a water discharge path such that water (once separated from the formation fluid and sediment) may be discharged to its destination location such as a subsurface formation surrounding a bore of a multi-bore well.

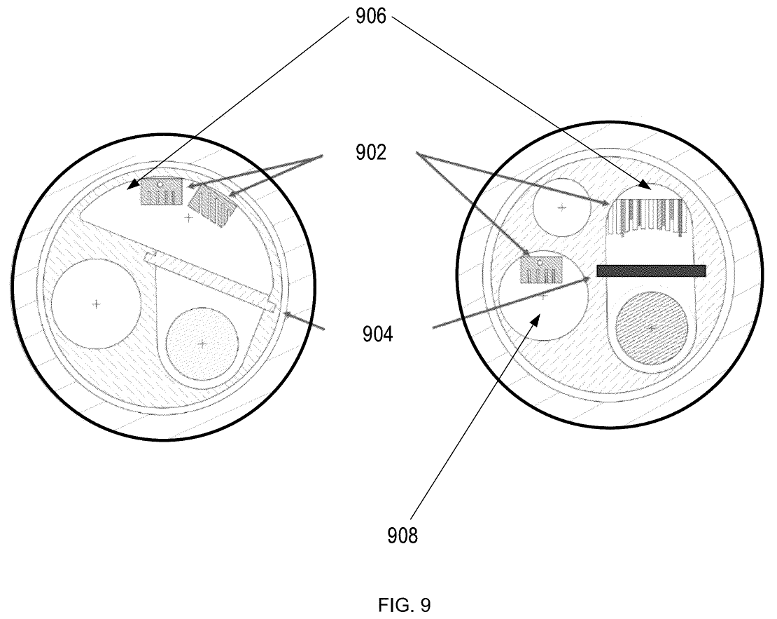

FIG. 9 is a second illustration depicting coalescing devices in both high-oil cut and high-water cut flow paths, according to some implementations. A plurality of coalescing devices 902 may be positioned along an upper surface of a high-oil cut flow path 906. The coalescing devices 902 may also be positioned along an upper surface of a high-water flow cut path 908. An access door 904 may be used to separate the high-oil cut flow path 906 from a separate flow path. Some implementations of the access door 904 may be hinged at one side and include a catching mechanism at an opposing end. However, other implementations may include an access door comprising two parts, where both parts of the access door are hinged at one side. Other configurations may be possible.

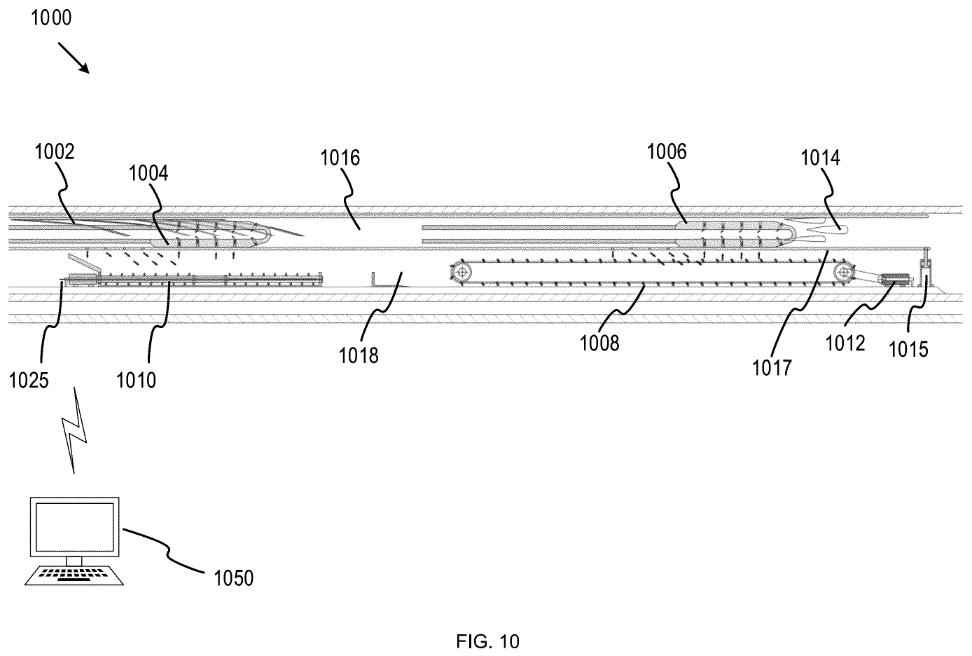

FIG. 10 is a side view of an example jet tool cleaning a downhole coalescer and then cleaning downhole solid consolidation and storage equipment, according to some implementations. A cleaning tool 1004 may be configured to pass through a section of pipe containing a coalescer 1002 having a plurality of coalescing plates. The coalescer 1002 may be positioned within an upper flow path 1016. A solids collection system 1010 may be positioned below the coalescer 1002 within a lower flow path 1018. For example, the solids collection system 1010 may include a solids catcher, a solids transport device including a dual-auger system, a solids debris storage unit, etc. The solids collection system may be coupled with a controller 1050 via an electric line 1025 or wireless connection (not shown). The wireless connection may be configured to provide communications and/or power. The electric line 1025 may be configured to transmit communications and power to and from the controller 1050 and solids collection system 1010. Some implementations of the electric line 1025 may be connected to other devices. In some implementations, one or more controllers similar to the controller 1050 may be used.

The cleaning tool 1004 may be configured to output a cleaning fluid pumped via a pump. The cleaning fluid may include produced water, oil, other produced fluids, etc. However, other implementations of the cleaning fluid may be possible. For example, the cleaning fluid may be hot oil. “Hot oiling” may be defined the process of heating a fluid at surface (usually oil or a petroleum derivative) that is then pumped downhole. The objective of the heated fluid is to melt paraffin that may have solidified and block the passage of fluid.

In some implementations, the cleaning fluid may not be a cleaning fluid, but a fluid designed to perform other tasks. The fluid may be an acid, base, surfactant, solvent, etchant, proppant-carrying fluid, emulsifier, de-emulsifier, detergent, a lubricant, a degreaser, a paraffin removing agent, cement, flushing agent, etc.

In some implementations, the cleaning fluid may be water in combination with at least one cleaning composition. In some implementations, a pump may pump a concentrate of cleaning fluid. The concentrate may be mixed with a fluid downhole. This mixture may then be applied to the screens. The controller and the pump may be at the surface of the well and/or at any location downhole. In some implementations, there may be a pump at the surface of the well and a pump downhole. For example, there may be a pump downhole that is part of the DOWSS such that the pump may pump the nonproduction fluid (that has been separated out during the DOWSS operation) into the area of the screens to clean off the solids from the screens. In some implementations, the controller may initiate the pump at the surface and/or the pump downhole. For example, if the level of flow rate of the formation fluid drops below a different threshold, the controller may initiate both pumps to clean the screens. As another example, the controller may use the pump downhole if there is a sufficient level of nonproduction fluid that is available to perform the cleaning operation. As further described below, an inner diameter and/or an outer diameter of the screens may be cleaned. Additionally, while described in reference to cleaning of screens, in some implementations, other parts of the DOWSS may be cleaned (similar to the cleaning of the screens).

After cleaning the coalescer 1002, a cleaning tool 1006 may be used to clean a flow diverter 1014. In some implementations, the flow diverter may at least partially laminarize (i.e., make laminar) a fluid flow that passes through the flow diverter 1014. Some implementations of the cleaning tools 1004 and 1006 may flush solid debris from the coalescer 1002 and flow diverter 1014 via a pump coupled to coiled tubing. Solids may fall from the fluid as it navigates around the flow diverter 1014. The solid debris may fall into a solids transport device 1008. Some implementations of the solids transport device 1008 may include a conveyor system (as depicted), an auger system, etc. The solids transport device 1008 may be powered by a motor 1012 which may be coupled to the controller 1050 via an electric line similar to the electric line 1025. Proximate to the motor 1012 is a lift 1015. The lift 1015 may be a hydraulic lift configured to raise or lower a flow divider 1017. For example, formation fluid may include a larger oil cut early in the life of the well and a higher water cut over time. The lift 1015 may lower the flow divider 1017 to capture more oil early in the life of the well, and the lift 1015 may raise the flow divider 1017 to account for an increased water cut.

The controller 1050 may be coupled to one or more sensors to initiate autonomous actions. For example, a sensor may be configured to measure a quantity of solid debris in the solids collection system 1010. One or more sensors may also be configured to monitor a flow rate through the upper flow path 1016, a flow rate through the lower flow path 1018, etc. The controller 1050 may use measurements from the sensors and other measurements obtained in the well to monitor and control a cleaning operation by the cleaning tool 1004. The controller 1050 may also control how and when the pump transmits the cleaning fluid downhole to clean the coalescer 1002. The controller 1050 may be positioned at the surface of the well and/or anywhere downhole. The controller 1050 may initiate the operation of the pump to clean using a selected cleaning fluid. In some implementations, the coalescer 1002 may be cleaned periodically and/or in response to the value of one or more parameters passing a threshold value. For example, a sensor may determine a flow rate downstream of the coalescer 1002 is lower than a flow rate indicative of normal operation. The controller 1050 may initiate an operation to clean the coalescer 1002 based on the reduced flow rate obtained by the sensor. However, other scenarios may be possible.

The controller 1050 may also perform other functions in concert with the one or more sensors. For example, the controller 1050 may be used in the separation system 200 of FIG. 2. Some implementations may monitor the start and operation of the separation system 200. The controller 1050 may be configured to monitor one or more parameters of the separation system 200 in real time. The controller 1050 may sidetrack the separation system 200 if an issue arises (e.g., an issue in the main bore). Some implementations of the controller 1050 may initiate an automatic shutdown and/or safe mode functions upon one or more parameters exceeding a shutdown threshold. For example, a flow rate upstream of the coalescer 1002 may drop to 5% of normal in an example scenario. This may be indicative of a flow obstruction. The controller 1050 may be configured to initiate a system shutdown to avoid an overpressure incident in the separation system 200 related to the flow obstruction. The controller 1050 may signal an operator (or other device) that the solids must be removed. Other scenarios and corrective actions may be possible.

In some implementations, a positional sensor may be coupled with the coalescer 1002 to measure one or more positional attributes of the coalescer 1002 (and/or individual coalescing plates). The coalescer 1002 may be placed in a movable/positional frame so the inclination, azimuthal position, height, and other positioned attributes may be adjusted. For example, the positional sensor may be coupled with the controller 1050 and used to adjust at least one of the above positioned attributes remotely.

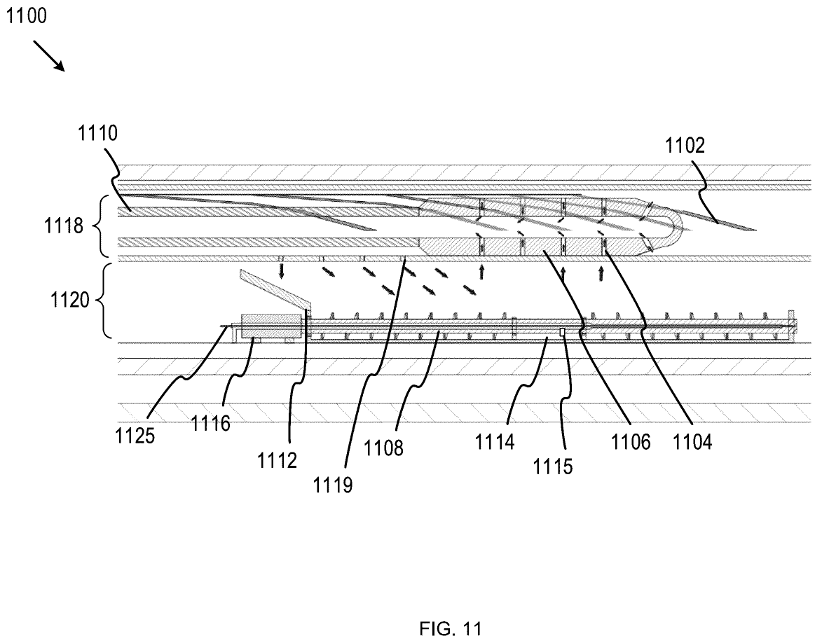

FIG. 11 is a cross sectional side view of an example cleaning of a downhole coalescer, according to some implementations. A downhole coalescer 1102 may be positioned within an upper flow path 1118. The downhole coalescer may include a plurality of coalescer plates or similar coalescing devices configured to separate hydrocarbons, water, gases, other fluids, and solids within the upper flow path 1118. A cleaning tool 1106 may be configured to clean the downhole coalescer 1102. The cleaning tool 1106 may be conveyed into the upper flow path via a coiled tubing 1110. A cleaning fluid may be pumped, via a pump, through an annulus of the coiled tubing 1110 through the cleaning tool 1106 and out of a plurality of ports 1104. Some implementations of the cleaning tool 1106 may include a jetting tool. The cleaning fluid may be pumped at a pressure sufficient to remove debris from the downhole coalescer 1102 and a solids transport device 1108, a solids catcher 1112, and a debris storage unit 1114. Prolonged solids deposition may induce a sludge to form that may clog ports and inhibit the function of various downhole equipment. One or more ports 1119 may allow the cleaning fluid to enter the lower flow path 1120 where it may dislodge solid debris from the solids catcher 1112, solids transport device 108, and debris storage unit 1114. This dislodged debris may be produced, injected for disposal, etc. along the lower flow path 1120, or stored within a storage tank. While depicted in the upper flow path 1118, the cleaning tool 1106 may be positioned within the lower flow path 1120, and the cleaning fluid may ascend into the upper flow path 1118 via the ports 1119. Some implementations of the solids transport device 1108 may include a dual-auger collection system rotated via a motor 1116. A controller (not shown) may control a function of the motor 1116, cleaning tool 1106, the pump, etc.

In some implementations, a debris storage sensor 1115 may be coupled to the debris storage unit 1114. The debris storage sensor 1115 may be coupled with an electric line 1125 which may be similar to the electric line 1025 of FIG. 10. The debris storage sensor 1115 may be configured to determine a quantity of solid debris in the debris storage unit 1114. The debris storage sensor 1115 may also be configured to determine whether the quantity of solid debris in the debris storage unit 1114 has exceeded a threshold value. If the threshold is exceeded, a controller, which may be similar to the controller 1050 of FIG. 10, may output a command to one or more equipment items to remove the solid debris. In some implementations, the solids may be mixed with an injection fluid and injected into a storage formation. For example, with reference to FIG. 2, the injection fluid including the solids may be injected via a sediment injector 299. The solids may be injected through a borehole into a storage formation. In some implementations, the solids may be produced to the surface via a production tubular coupled to the upper pump 293 of FIG. 2. The production of the solids may coincide or otherwise be coordinated with a production of a fluid to the surface, such as a non-production fluid (including water), a production fluid including oil, etc. Therefore, production of solids and production of the fluid to the surface may occur at the same time. The controller (not shown) may output commands to facilitate the production and injection operations described above. Other configurations and techniques may be possible. For example, a solid debris injection sensor may be coupled with the sediment injector to monitor the injection of solids into the disposal formation.

The downhole coalescer 1102 may be designed to be flexible and movable without uninstalling. For example, the coalescer 1102 may be constructed so one or more parts, such as the individual coalescing plates, may be moved out of the way to allow passage of tools such as the cleaning tool 1106 without causing damage to the coalescer 1102, the cleaning tool 1106, the coiled tubing 1110, etc.

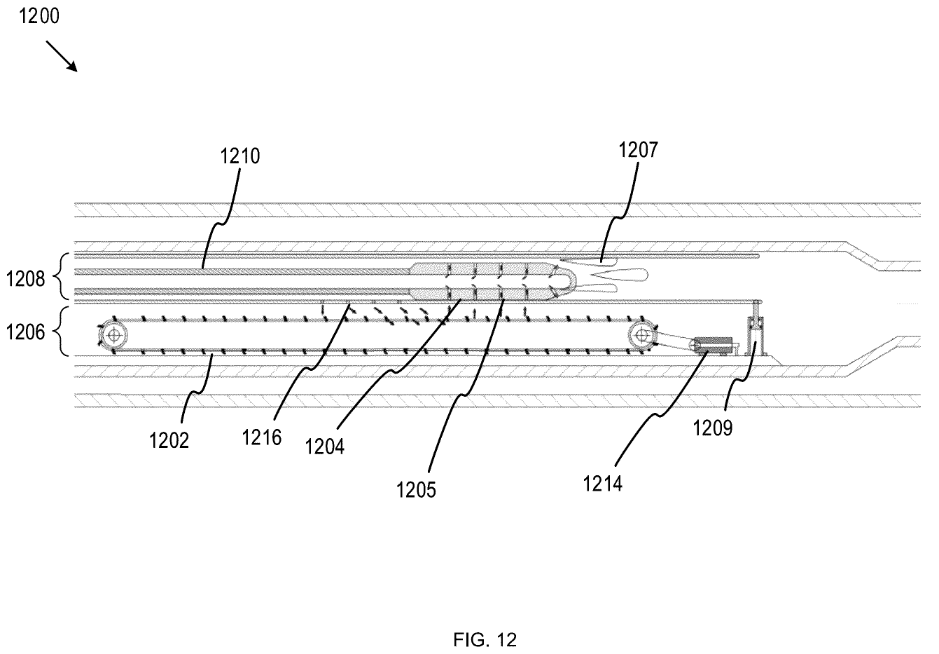

FIG. 12 is a cross sectional side view of an example cleaning of downhole solid consolidation and storage equipment, according to some implementations. FIG. 12 depicts a cleaning tool 1204 having a plurality of ports 1205. Some implementations of the cleaning tool 1204 may be a jetting tool. The cleaning tool 1204 may be configured to clean a solids transport device 1202 and one or more flow diverters 1207. The one or more flow diverters 1207 may be configured to convert an inlet flow (entering the upper flow path 1208 from the right) from turbulent to laminar flow. As the fluid passes across the flow diverters 1207, the flow diverters 1207 may disturb the fluid, thereby causing more turbulence in the fluid. After passing over the flow diverters 1207, the fluid may transition from a turbulent flow to a laminar flow. The solids transport device 1202 may be part of each of the sediment separators 290A-290N described above in reference to FIG. 2 for transporting the solids separated out via coalescing devices. As shown, a coiled tubing 1210 may function convey the cleaning tool 1204 into an upper flow path 1208. A lift 1209 may be configured to adjust a divider between the upper flow path 1208 and a lower flow path 1206. The coiled tubing 1210 may fluidly couple a pump to the cleaning tool 1204. Accordingly, a cleaning fluid may flow through the coiled tubing 1210 to the cleaning tool 1204 for removing and cleaning solids from the solids transport device 1202. In some implementations, cleaning fluid may be pumped down the annulus of coiled tubing 1210 and returned via the inside diameter of coiled tubing 1210. In some implementations, cleaning fluid may be pumped down the inside diameter of coiled tubing 1210 and transferred to the annulus of coiled tubing 1210. In the same fashion, the fluid returning up-hole from cleaning tool 1204 may travel up the inside diameter of coiled tubing 1210 to a certain location and then be transferred to the annulus of the coiled tubing 1210. Is some implementation, the device used to transfer the flow from the inside of coiled tubing 1210 to the annulus of coiled tubing 1210 may be called a crossflow device.

The cleaning fluid may also travel into the lower flow path 1206 via cleaning ports 1216. In some implementations, the solids transport device 1202 may be a conveyor system actuated via a motor 1214. The cleaning fluid output via the ports 1205 may dislodge solid debris on the solids transport device 1202 that build up over time as the DOWSS system operates to separate solids from the fluids downhole. In some implementations, a controller may be configured to operate the motor 1214, lift 1209, and cleaning tool 1204. In some implementations, the solids transport device 1202 may have ports, inlets, outlets, etc. to ensure the fluids may reach solids that may be hidden from direct line of sight.

Although FIG. 12 shows a rather simple tool with ports such as the port 1205, the tool may be more complex. For example, the cleaning tool 1204 may have sharp edges, cutting inserts, etc. for milling steel or removing large pieces of debris. The tool may have dogs, collets, keys, etc. for engaging one or more profiles within the wellbore or tools/devices in the well. The tool may have moving parts such as swivels, actuators, end effectors, grippers, hooks, wedges, drivers, etc. for moving components that are installed downhole or a component of a bottom hole assembly (BHA). The tool may have turbines, motors, hydraulic, electrical, pneumatic, fluidic, mechanical linkages and devices. Accordingly, the tool 1204 may be used to repair or replace parts in the wellbore, in a DOWS system, etc. Thus, some implementations may be such that different services may be conducted downhole.

Any other tool, device, object, obstruction may be transported with the one or more bores, zones, tubulars, etc. within the well. A production riser or other device in which the fluids, solids, gases, emfluents, etc. may pass or not pass. In some implementations, the bottom hole assembly (BHA) and/or this tool may comprise a Vac Tool.

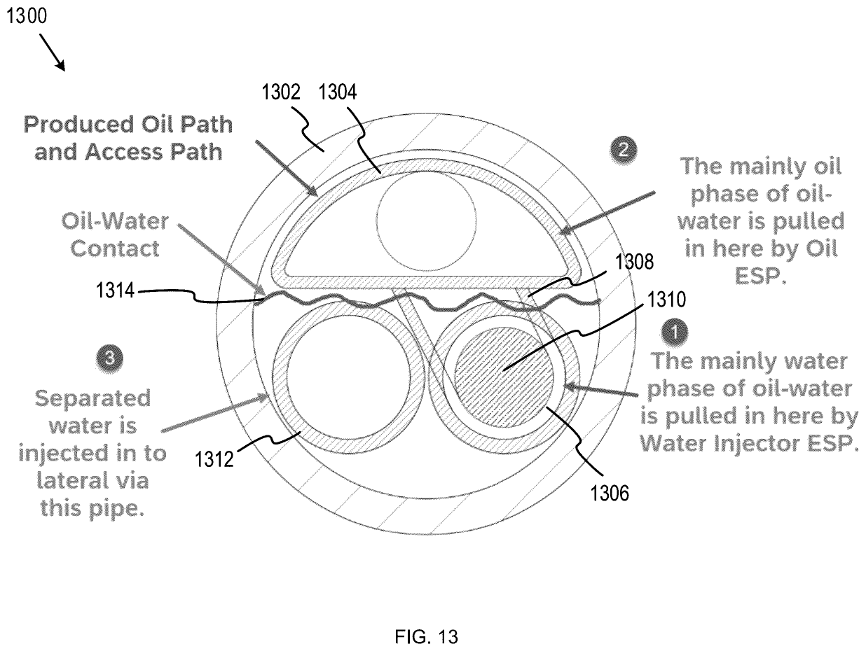

FIG. 13 is a cross sectional view of example flow paths, according to some implementations. In particular, FIG. 13 includes a partial cross sectional view of a separation system 1300 (that may be representative of separation system 200 described in FIG. 2) that includes a separator 1302 positioned downhole in a well. The separator 1302 may separate formation fluid by gravity and/or density separation. For example, formation fluid may separate into a high-oil cut fluid above an oil-water contact (OWC) 1314 and a high-water cut fluid below the OWC 1314. The high-oil cut fluid may flow through an upper flow path 1304 and water-cut fluid below the oil-water contact 1314 may flow through a lower flow path 1306. An injection flow path 1312 may act as a water discharge path such that the water (once separated from the formation fluid and sediment) may be discharged to its destination location such as a subsurface formation surrounding a bore of a multi-bore well.

A coalescer separator (such as the coalescer 402 or the coalescing devices 802) may be positioned within the injection flow path 1312, upper flow path 1304, and the lower flow path 1306. A solids catcher, transport device, and debris storage unit similar to the solids transport device 712, solids catcher 710, and solid debris storage unit 714 of FIG. 7 may be positioned in the lower flow path 1306, injection flow path 1312, etc. If any one or more of the coalescers, solids transport device, solids catcher, and solid debris storage unit needs to be retrieved, repaired and/or installed, the one or more components may be transferrable between the lower flow path 1306 and the upper flow path 1304 via the path 1308. In some examples, the one or more components may be transferrable between the injection flow path 1312 and the upper flow path 1304 via a path not shown.

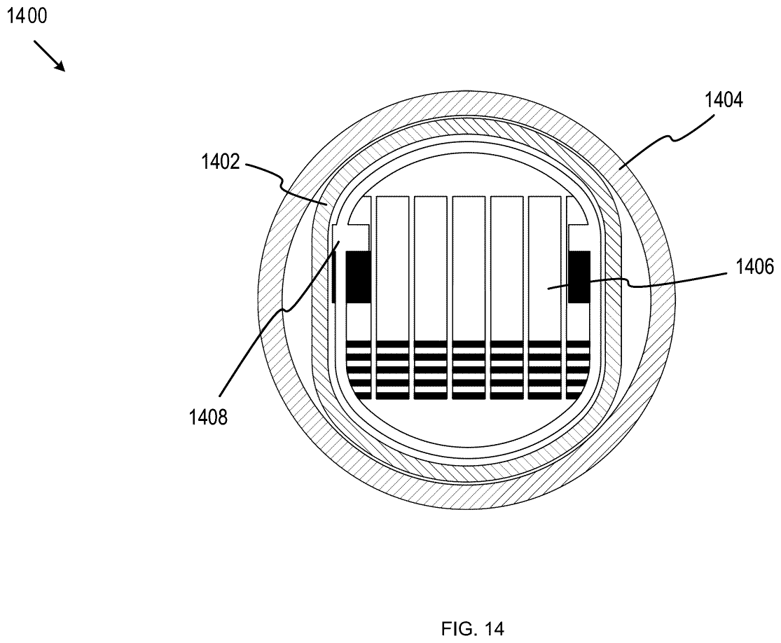

FIG. 14 is a first cross-sectional view of an example coalescer in a DOWS assembly, according to some implementations. A cross-section 1400 may include a casing 1404 having a DOWS assembly 1402 positioned within. Within the DOWS assembly 1402 may be a mounting mechanism 1408 by which a stack of coalescer media may be mounted. For example, a coalescer 1406 may be received by (and coupled to) the mounting mechanism 1408. The coalescer 1406 may be installed and retrieved by coil tubing, for example, and may mounted/dismounted from the mounting mechanism 1408. In some implementations, wireline, segmented piping, etc. may be used to run in hole to install and retrieve the coalescer 1406, as well as any other coalescer and/or coalescing element/device described herein. The coalescer 1406 may be redressable and refitted with new coalescing plates. The internals of the coalescer 1406, and any other coalescer/coalescing device described herein, may be replaced without pulling major components such as the upper pump 293 (which may be an ESP), motors such as the motor 1012, etc. The coalescer 1406 may be comprised of a flexible material, and the coalescer 1406 may be re-runnable into the DOWS Assembly 1402. In some examples, the DOWS assembly 1402 and/or components thereof (e.g., coalescer 1406, etc.) may have more than one mounting mechanism 1408. For example, coalescer 1406 may be mounted so that it may be oriented in more than one direction. For example, coalescer 1406 may be mounted so that it may be adjusted in pitch (rotation about a centerline that is perpendicular to the axis of the wellbore and perpendicular to a vector in nearly the same direction as the direction of gravity (or within −45°<θ<45°. The same coalescer 1406 may also be mounted so that it may be adjusted/rotated/tilted in roll (rotation about the axis of the wellbore.

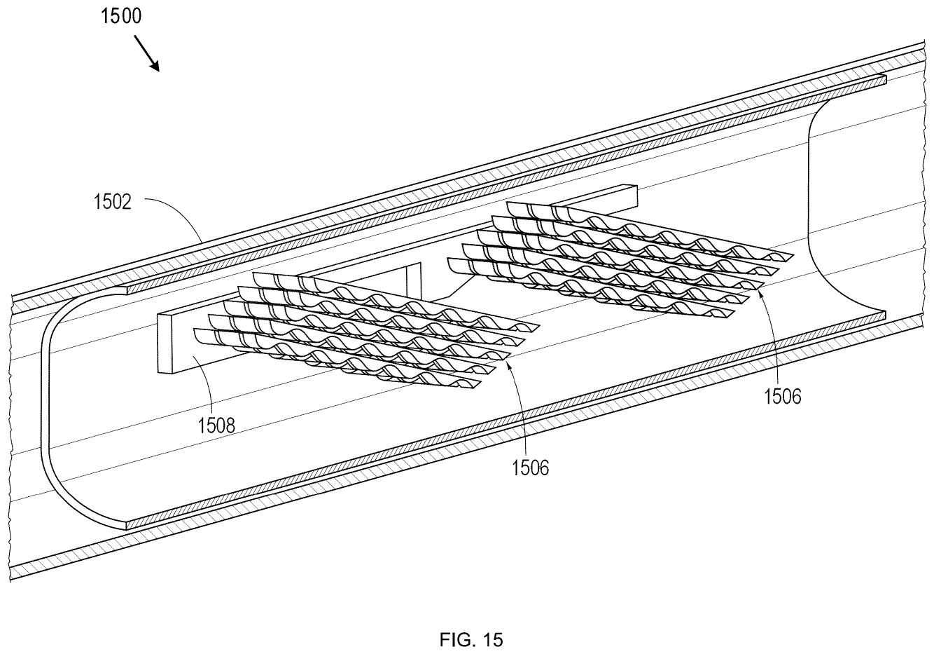

FIG. 15 is a second cross-sectional view of an example coalescer in a DOWS assembly, according to some implementations. A cross-section 1500 may be similar to the cross-section 1400 in which at least a portion of a DOWS assembly 1502 may include a flexible coalescer 1506. The flexible coalescer 1506 may be mounted on at least one side to a mounting mechanism 1508 positioned within the DOWS assembly 1502. In some implementations, the angle of approach of the coalescer 1506 may be adjusted via an attachment receptacle of the mounting mechanism 1508. For example, a controller similar to the controller 1050 of FIG. 10 may sense, via one or more sensors, one or more operational parameters relating to the operation of the flexible coalescer 1506, the DOWS Assembly 1502, etc. The controller may then control the coalescer 1506 via the mounting mechanism 1508 based on those sensed operational parameters and other information. Some implementations may include a motor (not shown) to adjust the angle of approach of the coalescer 1506. The coalescers 1406 and 1506 may separate, accumulate, transport, and dispose of coalesced solids to a location that will not interfere with the continued operation of the DOWS assembly 1502 and related equipment. In some implementations, maintenance may be performed on the coalescer 1506 when attached to the mounting mechanism 1508. The one or more flexible coalescers 1506 may be positioned in pitch at a desired or optimum angle. The same one or more flexible coalescers 1506 may be positioned in roll at a desired or optimum roll angle to give the best coalescing action.

In some examples, the DOWS assembly 1402 and/or components thereof (e.g., coalescer 1406, etc.) may have more than one mounting mechanism 1408. For example, coalescer 1406 may be mounted so that it may be oriented in more than one direction. For example, coalescer 1406 may be mounted so that it may be adjusted in pitch (rotation about a centerline that is perpendicular to the axis of the wellbore and perpendicular to a vector in nearly the same direction as the direction of gravity (or within −45°<θ<45°. The same coalescer 1406 may also be mounted so that it may be adjusted/rotated/tilted in roll (rotation about the axis of the wellbore.

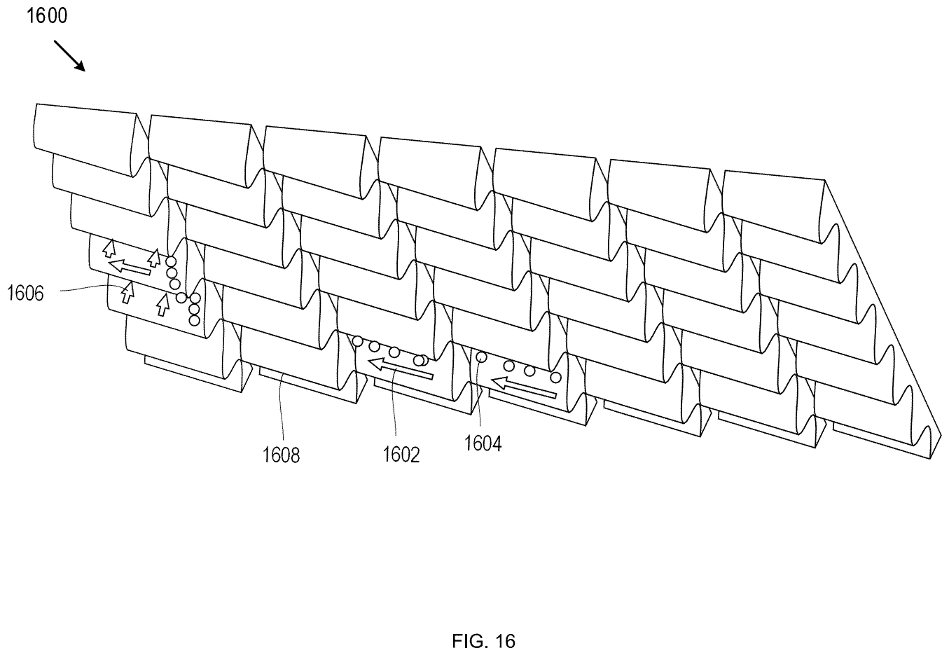

FIG. 16 is a first perspective view of an example offset coalescer, according to some implementations. In contrast to the coalescer 302, an offset coalescer 1600 may be positioned at an angle nonparallel to a direction of flow within a downhole tubular. The offset coalescer 1600 may include a plurality of offset coalescing plates 1608. A fluid 1604, such as a hydrocarbon, may coalesce along an underside of the offset coalescing plates 1608. The fluid 1604 may travel generally along the axis of the wellbore (within −30°<θ<60° of the axis of the wellbore) while the lighter constituents of fluid 1604 (shown as fluid 1606) may separate and float and/or coalesce and/or travel in a direction generally opposite of the direction of gravity. Fluid 1606 may have more than one flow paths, but fluid 1606 will comprise a vector component in the direction opposite the force of gravity. For example, fluid 1606 may flow from the general 3 o'clock and 9 o'clock positions towards the 12 o'clock position. In this example, the 12 o'clock position is on the high side of the wellbore with the axis of the clock's hands generally coincident to the axis of the wellbore. The fluid 1606 may also posses a flow vector towards the axis of the wellbore (i.e., the fluid 1606 may radially flow inward). The fluid 1606 may be urged to flow in a combination of these two flow vectors (opposite the pull of gravity and radially inwards) by at least one of 1) the shape of the coalescer plate(s) and/or coalescer strip(s), 2) the orientation of the wellbore, 3) the orientation of the coalescer plate(s) and/or coalescer strip(s), and/or 4) the orientation of the coalescer mounts, hangers, one or more mounting mechanism(s) (e.g., 1408, 1508, 1904, 1908, as disclosed below), etc., 5) etc. Lighter fluids and gases may therefore be channeled in 2-directions instead of one direction. In some implementations, this two way coalescing enhances (speeds up) the coalescence action.

One or more of the offset coalescer 1600 may be positioned with at least one of a desired or optimum yaw, pitch, and roll. Pitch may refer to a rotation of the offset coalescer 1600 about a transverse axis (a horizontal axis perpendicular to the axis of the wellbore and/or to the primary axis of fluid flow). Pitch may also be referred to as the coalescer's angle of approach or approach angle. Roll may refer to a rotation of the offset coalescer 1600 about the longitudinal axis (i.e., the axis of the wellbore and/or primary axis of fluid flow). In some examples, the one or more offset coalescer 1600 may be positioned in yaw to a desired or optimum angle. Yaw may refer to a rotation about a vertical axis. A combination of pitch, roll, and yaw may be used to angle the offset coalescer 1600. In some implementations, one or more flow sensors (not depicted) positioned downhole, one or more processes performed at the surface (such as chromatography), etc. may be used to determine an effectiveness of the coalescing action in the wellbore based on fluid flow rate, coalesced fluid composition, etc. The yaw, pitch, roll, and other positional attributes of the offset coalescer 1600 and other coalescers, coalescing plates, coalescing devices, coalescing components, etc. described herein may be adjusted based on the sensor measurements and/or processes. Other implementations may be possible. The offset coalescer 1600 may also coalesce fluids and solids axially (e.g. in the general direction of the flow of the fluid 1604) and radially. In some examples, the one or more offset coalescer(s) 1600 may be positioned in pitch to a desired or optimum angle. Likewise, the same one or more offset coalescer 1600 may be positioned in roll at a desired or optimum roll angle to give the best coalescing action.

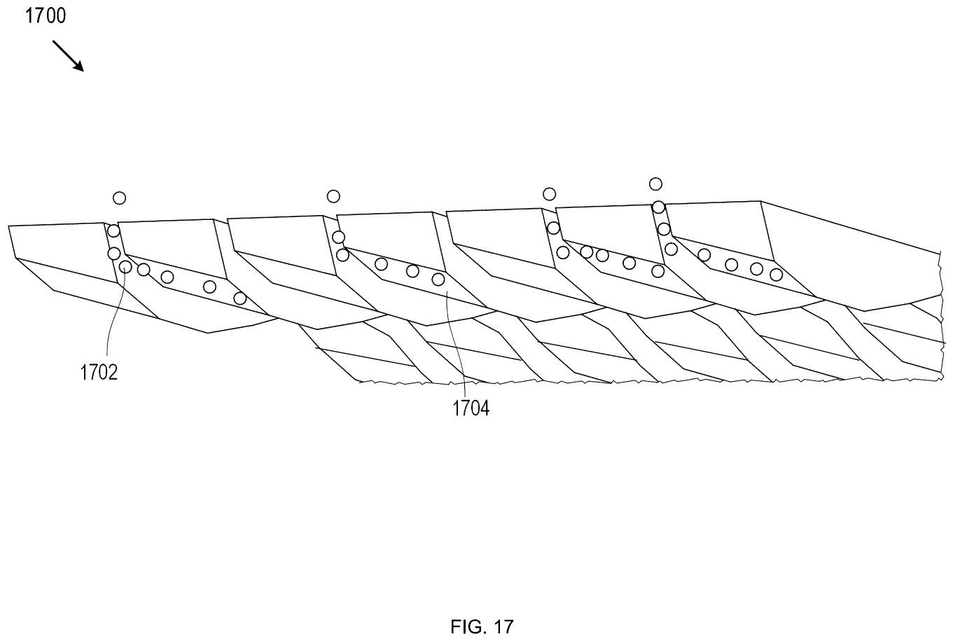

FIG. 17 is a second perspective view of an example offset coalescer, according to some implementations. At least a portion of an offset coalescer 1700 may be configured to coalesce a fluid 1702. The fluid 1702 may coalesce along an underside 1704 of the offset coalescer 1700. In some implementations, the offset coalescer 1700 may include tapered coalescer plates configured to allow gas and lighter liquids to coalesce and riser faster. Some implementations of the offset coalescer 1700 may include a strip coalescer configured to allow gap for gas and lighter liquids to rise faster. For example, the strip coalescer may include gaps between individual strips to allow fluids, such as gases, greater freedom in movement as they coalesce upward. In some implementations, the strip coalescer may allow tools to pass through them without damage to the strips or the tool. The strips may be rectangular shaped and flexible, although other geometries may be used. Strip coalescers may be hung by one or more positional devices such as a swivel to allow them to swivel out of the way of passing tools. Strip coalescers may also use positional devices such as one or more small springs to urge them back into the proper alignment (i.e., their original position) after a tool passes by. Coalescers may be placed in a movable/positional frame so the inclination, azimuthal position, height, and other features/geometries may be adjusted remotely (from surface or by a downhole computer-controller or both).

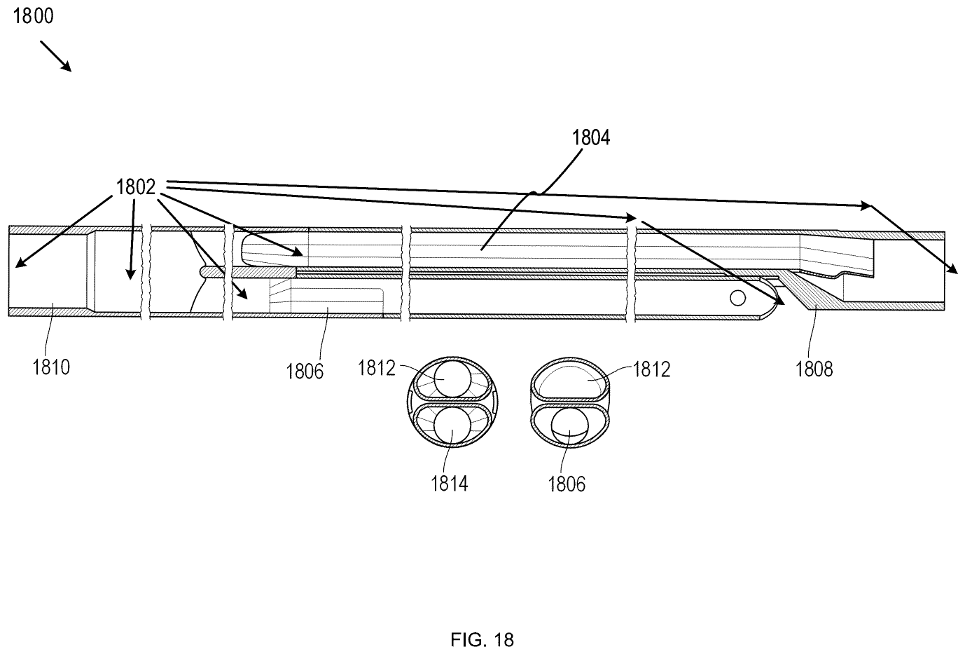

FIG. 18 is a cross-sectional side view of placement of a coalescer with respect to a junction 1800, according to some implementations. A coalescer 1802 may be placed above a junction, inside the top of a junction, above the y-block, in the mainbore leg, in the Lateral Leg, below the mainbore leg, below the Lateral Leg, in or below any leg of any junction, above or inside any type of junction, etc. For example, the coalescer 1802 may be placed along any point within the junction 1800 such as a lateral leg 1804 which may extend into a lateral bore. A coalescer 1802 may be placed within a lower bore 1806 which may extend into the main bore casing. Each of the lateral leg 1804 and lower bore 1806 may include upper and lower paths 1812 and 1814, respectively. Accordingly, each of the lateral leg 1804 and lower bore 1806 may be used for production, injection, etc. A coalescer 1802 may also be placed uphole 1810 within the main bore, downhole 1808 within the main bore, etc.

The implementations described herein may facilitate one or more of the capabilities described herein. Some implementations may coalesce fluids/solids/oil/water in downhole. Some implementations may allow solids to coalesce downhole and be accumulated downhole. Some implementations may collect coalesced oil and produce the oil. Some implementations may collect coalesced solids and either produce them to the surface, dispose of the solids into a solids disposal site, or both concurrently. Some implementations may collect coalesced water and produce and/or dispose of the produced water. Some implementations may perform maintenance on any one of the downhole coalescers described herein. Some implementations may include exchanging coalescer media. Some implementations may detect an accumulation of solids, oil, and other materials. Some implementations may detect the performance of a coalescer in the accumulation and processing of solids, oil, and other items. Some implementations may signal an operator (or other device) that accumulated solids may need to be removed. Some implementations may enable flushing, dislodging, scrapping, chemically treating, fluidically treating, mechanically treating, etc. of the downhole coalescer and its byproducts (solids and fluids) from one or more locales. Some implementations may displace solids and related debris from the downhole coalescer and DOWS system. Some implementations may collect solids and other materials from the downhole coalescer and DOWS system. Some implementations may transport the solids and other materials from the downhole coalescer and DOWS system. However, other implementations may be possible.

In some implementations, one or more sensors (not shown) may be positioned proximate to a downhole coalescer, such as the coalescer 1002, for cleaning operations, solids removal from a solid debris storage unit, etc. For example, the coalescer(s) may be cleaned periodically (independent of any condition). Alternatively or in addition, the coalescer may be cleaned in response to detecting or sensing a change in a value of any of a number of parameters. Sensors positioned at any number of locations may sense values of any number of parameters. For example, a sensor may be positioned behind the coalescer opposite the subsurface formation. In some implementations, the sensor may be positioned upstream of the coalescer within the DOWS system. Such a sensor may sense a flow rate of the formation fluid. If the flow rate of the formation fluid going through the coalescer drops below a flow rate threshold value, a controller may initiate cleaning of the coalescer.

Alternatively or in addition, a sensor may be positioned at a surface of the well and/or any location downhole. Such sensors may also sense a flow rate of a fluid (such as the formation fluid, the production fluid, the nonproduction fluid, etc.). If the flow rate of such a fluid drops below a flow rate threshold value for the given fluid, a controller may initiate cleaning of the coalescer. In some implementations, a given flow rate threshold value may be unique to the given type of fluid and the location of the sensor.

Alternatively or in addition, a sensor may sense a level of solids (or sediment) for a given unit of time being separated from the formation fluid, the production fluid and/or nonproduction fluid (as described herein). If this level of solids being separated out falls below a solids rate threshold value, a controller may initiate cleaning of the coalescer. In some implementations, a given solids rate threshold value may be unique to the given type of fluid from which the solids are being separated and the location of the sensor. In some implementations, a sensor may a float valve is a buoyant device.

In some implementations, a cleaning device may be built into a screen, a coalescer, or other downhole device-it automatically may sense when the screen/device needs to be cleaned and then initiate a cleaning cycle. Alternatively or in addition, the cleaning may be initiated manually from the surface of the well. In some implementations, the system may be powered by the ESP, its own pump and/or motor. Also, the system may be serviceable and/or replaceable without pulling the completion (or parts thereof).

In some implementations, the controller may initiate cleaning of the coalescer based on values of a combination of parameter values. For example, the controller may initiate cleaning of the coalescer if the level of solids being separated out from a given fluid falls below a solid threshold value and if a flow rate of a given fluid falls below a flow rate threshold value. The controller may also control one or more devices, such as the access door 904, motor 604, etc. to facilitate solids transport and removal. Other configurations of the sensors, controller, coalescer(s), and solids catching, transport, and storage devices may be possible. In some implementations, any other property of the given fluid may be used in determining whether initiation of applying the fluid (e.g., cleaning fluid) to the coalescers. Examples of other such properties may include a pressure drop or pressure change.

In some implementations, the controller may initiate cleaning of the coalescers, screens, etc. by causing a pump to activate to pump a cleaning fluid into the area of the screens to clean off the solids from the screens. In some implementations, the cleaning fluid may be water. In some implementations, the cleaning fluid (aka fluid) may not be for cleaning, but for other reasons-or it may be a fluid for multiple requirements. For example, the fluid may be a corrosion coating or corrosion inhibitor. If the fluid is primarily a corrosion coating, additional steps, processes, fluids, etc. may be required. For example, pre-flushes to remove buildup on one or more surfaces may be required to remove paraffin, scale, salts, etc. prior to applying a new coating or fluid. Physical cleaning may be required and implemented to remove deposits, films, etc. that may be hard to remove by only a flushing or jetting type action. In some implementations, the device and processes may also perform necessary actions to get to the surfaces to be cleaned such as sliding a sleeve open, actuating a port, unfastening a fastener, etc. The device and processes may include sliding a sleeve closed (after one or more operations are complete). The device and processes may also perform other operations such as replacing gaskets, injecting sealants, replacing parts on the equipment being cleaned, replacing parts or servicing other parts or assemblies during the same trip, etc.

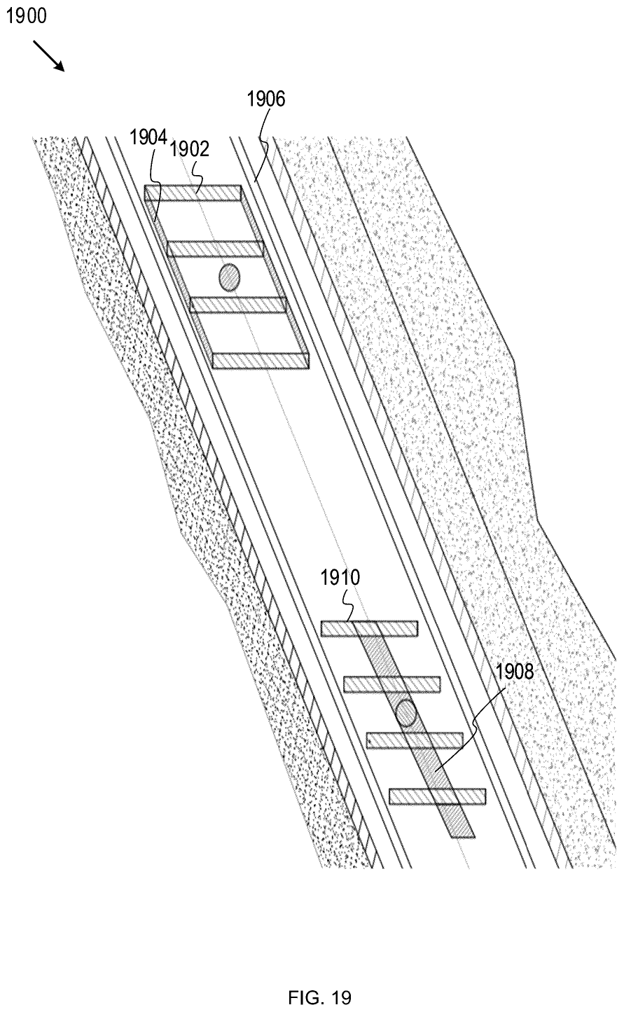

Some implementations of the coalescers may be used in an inclined or vertical section of the well. For example, FIG. 19 is an illustration depicting example coalescer configurations in an inclined portion of multi-bore well, according to some implementations. An illustration 1900 includes a coalescer 1902 having a plurality (four are depicted, although more may be possible) of coalescer sheets/plates. The coalescer 1902 may be coupled to a mounting mechanism 1904 within a tubing 1906. The tubing 1906 may be positioned within the multi-bore well upstream of the upper pump 293 of FIG. 2. The mounting mechanism 1904 may be similar to the mounting mechanism 1508 of FIG. 15. The mounting mechanism 1904 may be coupled to the ends of each coalescing plate. Thus, the coalescing plates may move in unison. A controller, such as the controller 1050 of FIG. 10, may adjust an approach angle of the coalescing plates of the coalescer 1902 via the mounting mechanism 1904. Other mounting mechanisms, such as a mounting mechanism 1908, may mount to a point of center mass of each of the coalescing plates of the coalescer 1910. In this configuration, the approach angle of each coalescing plate may be individually adjusted. In some implementations, individual coalescing plates of the coalescer 1910 may be installed and/or removed. The coalescer 1902 and all coalescing plates may be dismounted from the mounting mechanism 1904 simultaneously.

In some implementations, the coalescers 1902 and 1910 may be positioned in with a roll, pitch, and yaw a desired or optimum angle. Likewise, the coalescers 1902 and 1910 may be angled at a desired or optimum roll, pitch, and yaw to give the best coalescing action. For example, the mounting mechanisms 1904, 1908 may be adjusted (manually via one or more downhole tools, remotely via a controller and one or more motors/actuators, autonomously via the controller and measurements via one or more sensors, etc.) to attain a desired or optimum pitch, yaw, and roll of the coalescers 1902, 1910.

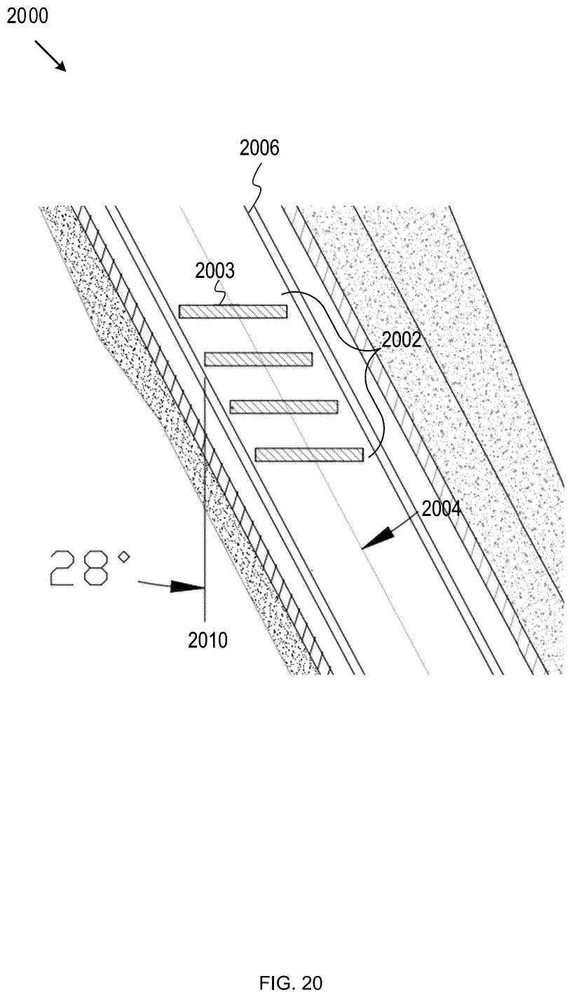

FIG. 20 is an illustration depicting an enhanced image of the coalescer of FIG. 19, according to some implementations. An illustration 2000 includes a coalescer 2002 including a plurality of coalescing plates 2003 positioned within a tubing 2006. In some implementations, the coalescer 2002 may be positioned in an inclined portion of a wellbore. The coalescing plates 2003 may each be angled at an approach angle 2010. The approach angle 2010 may be angled with reference to a central axis 2004 within the tubing 2006. As depicted, the approach angle may be equal to 28° from the central axis 2004, although other approach angles may be possible.

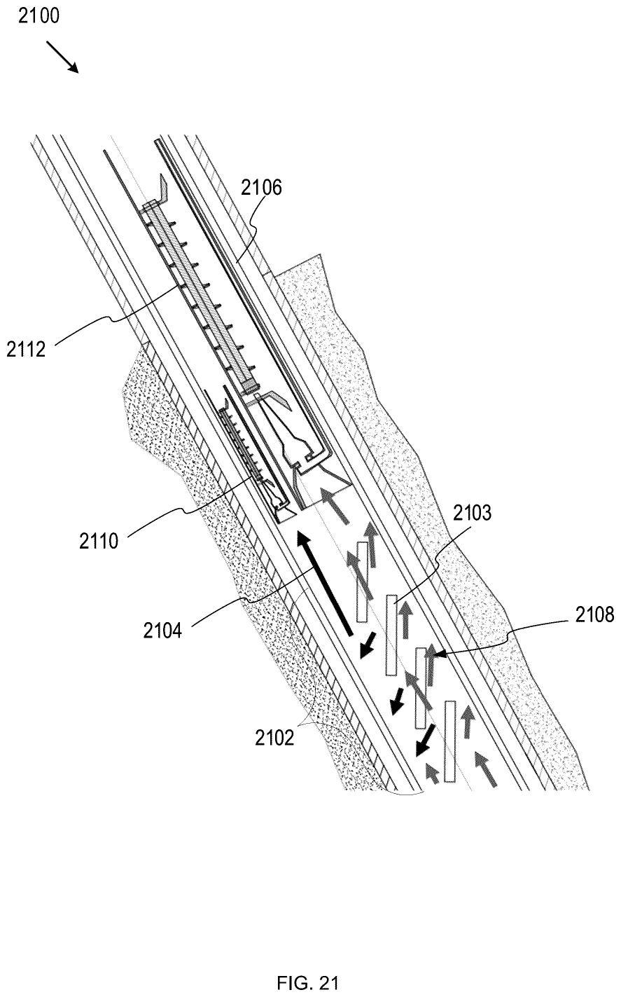

FIG. 21 is an illustration depicting an example coalescer and solids separation equipment positioned in an inclined portion of a multi-bore well, according to some implementations. A diagram 2100 includes a coalescer 2102 having a plurality of coalescing plates 2103. The coalescer 2102 may be positioned within a tubing 2106. The tubing 2106 may be positioned, at least in part, in an inclined portion of a multi-bore well upstream of the upper pump 293. An inlet flow having oil, water, and solids may enter the tubing 2106. As the inlet flow contacts the coalescer 2102, a hydrocarbon flow 2108 may coalesce along an underside of each coalescing plate 2103. The hydrocarbon flow 2108 may then flow into a solids separation system 2112 for additional processing. The solids separation system 2112 may include a solids catcher, a solids transport device, a solid debris storage unit, etc. A denser water flow 2104 may coalesce underneath the coalescer 2102 and flow into a solids separation system 2110 for additional processing as the fluid moves uphole. Solids may also contact the coalescing plates 2103, sink, and accumulate with the water flow 2104. The solids may flow into the solids separation system 2110, where the solids may be captured, transported, and temporarily stored. In addition to separating out various fluids and materials, the coalescer 2102 may also alter a flow state of the inlet flow. For example, the coalescing plates 2103 of the coalescer 2102 may perturbate the inlet flow, converting the flow state from turbulent to laminar flow. This may also further assist in the separation achieved by the coalescer 2102. In some implementations, the approach angle of the coalescing plates 2103 may be adjusted based on the flow state as fluid enters the solids separation system 2112, solids separation system 2110, etc. Other configurations may also be possible.

### Example Centrifugal Separation Devices

All the example coalescers described herein may operate in concert with one or more other devices including cyclonic separators and/or hydrocyclone separators. Some novel combinations may not be explicitly shown in the drawings but are with the scope of this disclosure. For example, a coalescer, which may coalesce hydrocarbons and separate out solid debris from a flowing medium, may be positioned proximate to an inlet, an outlet, etc. of the below described helical separation devices. In some instances, the coalescers may serve more than one purpose such as coalescing hydrocarbons and changing flow parameters (e.g. act as a perturbation device to change flow from turbulent to laminar). Also, coalescers that perform more than one function may have one or more function controllable/changeable due to the change of one or more sensed parameters.

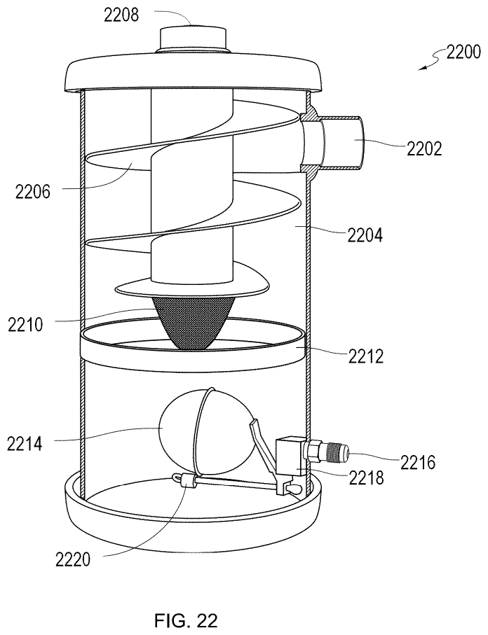

FIG. 22 is a perspective view of a helical oil separator, according to some implementations. A helical oil separator 2200 may include an inlet connection 2202, a mesh screen 2204, and a helical flighting 2206. A fluid including a mixture of gas and oil, such as a wet gas may include oil in an aerosol form, may enter via the inlet connection 2202. The gas/oil mixture may encounter the leading edge of the helical flighting 2206 as it travels through the separator 2200. The mixture is centrifugally forced along the spiral path of the helix. Heavier oil particles may spin to the perimeter due to centrifugal force. At the perimeter, the oil particles may impinge with the mesh screen 2204. The oil particles may also collide with a second mesh screen 2210. The oil may emerge from solution while the gas is vented via an outlet connection 2208. The oil may collect below an oil drain baffle 2212. An assembly including a ball float 2214, a magnet 2220, and a needle valve assembly 2218 may control a flow of oil out of the helical separator 2200 through an oil return connection 2216. Such a separator may efficiently remove oil from a discharge gas and return it to a compressor (either directly or indirectly). This helps maintain the compressor crankcase oil level and raise the efficiency of the system by preventing excessive oil circulation.

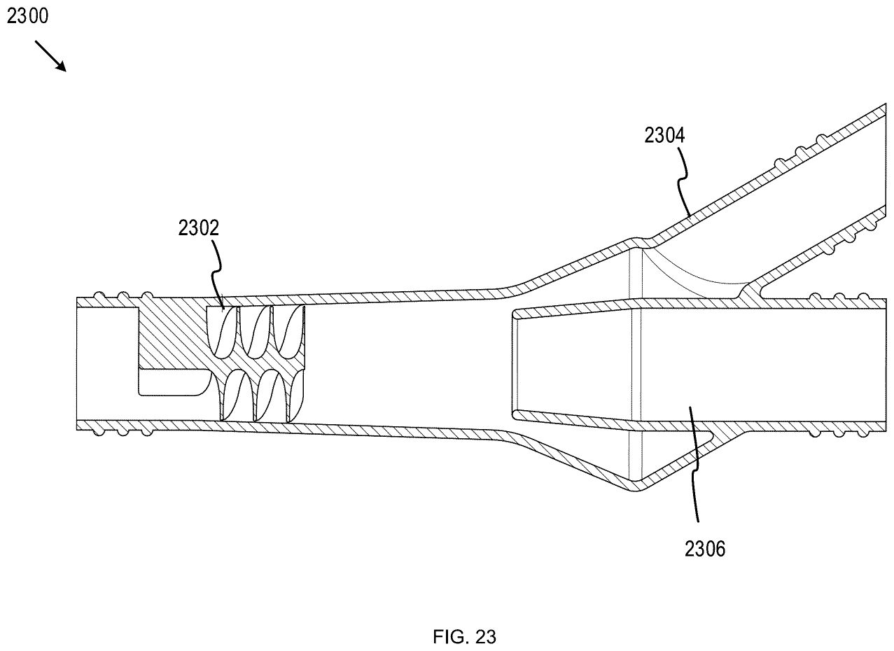

FIG. 23 is a perspective view of an example cyclonic separator, according to some implementations. A cyclonic separator 2300 may include a helical inlet 2302 having a hydrocyclone, although other devices may be possible. The cyclonic separator 2300 also includes an upper flow path 2304, and a lower flow path 2306. A fluid having solid debris may enter the cyclonic separator 2300 via the helical inlet 2302. Centrifugal force may induce centrifugal movement of solid debris outward from a center of flow. At least a portion of the upper flow path 2304 may surround the lower flow path 2306.

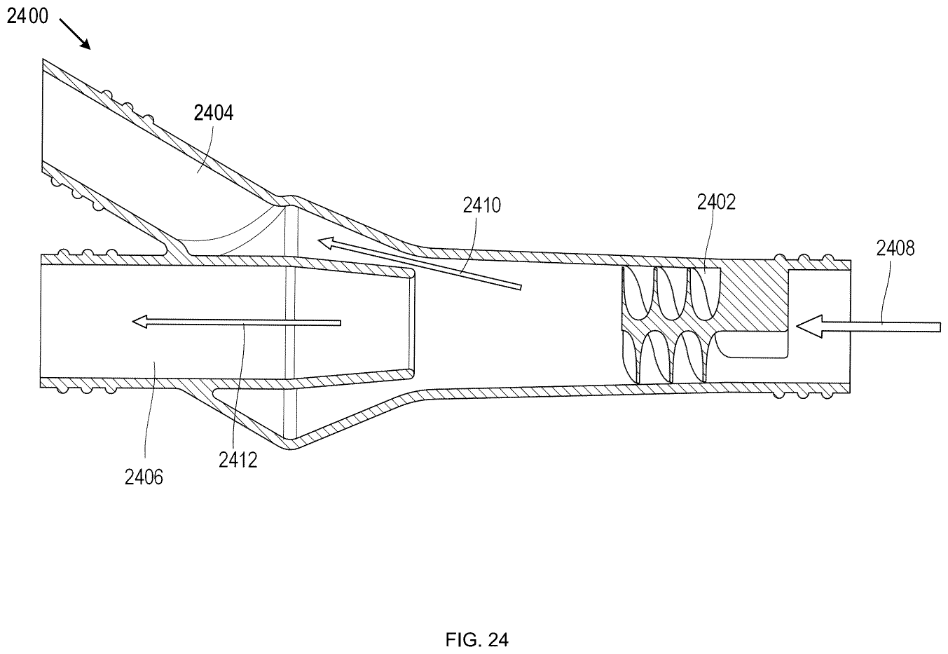

FIG. 24 is a perspective view of an example cyclonic separator performing separation on an intake fluid, according to some implementations. A cyclonic separator 2400 may include a helical inlet 2402, an upper flow path 2404, and a lower flow path 2406. An intake fluid 2408 having solid debris such as sediments may enter the cyclonic separator 2400. The intake fluid 2408 may be separated into a waste liquid flow path 2410 and a clean fluid flow path 2412.

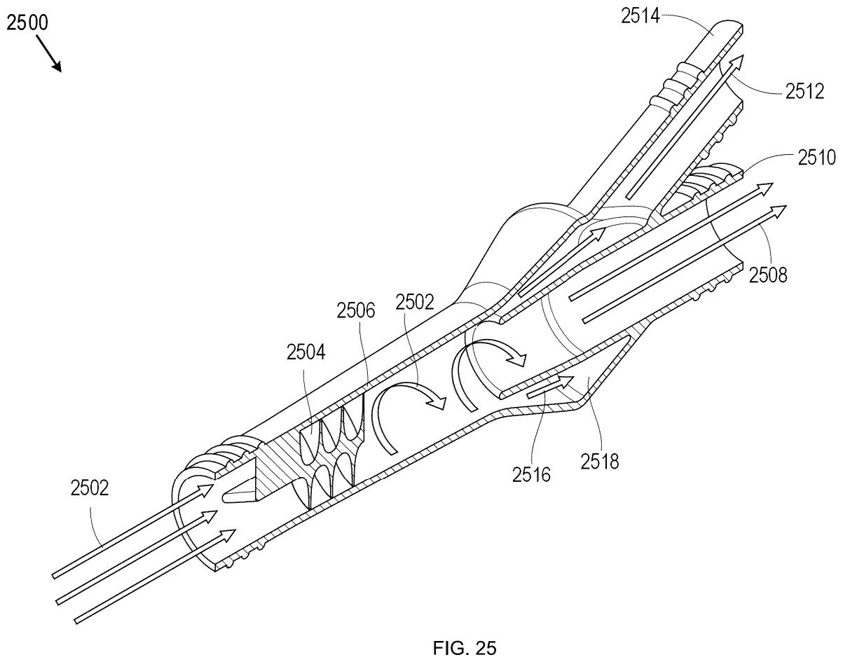

FIG. 25 is a partial cross sectional side view of an example cyclonic solids separator, according to some implementations. In particular, FIG. 25 includes a cyclonic solids separator 2500 that may be implemented in a separation system in a wellbore (such as separation system 200 described in FIG. 2). For example, the separator system may be configured with one or more cyclonic solids separators 2500 in the flow path of the high-oil cut fluid and/or the flow path of the high-water cut fluid. Fluid 2502 may enter the cyclonic solids separator 2500 and pass through a hydrocyclone 2504 (or any other suitable cyclonic solids separator, such as a desilter).

The cyclonic solids separator 2500 described herein may be a solids separator (also referenced as a hydrocyclone, helical separator, etc.) installed in hydrocarbon recovery wells. The function of the cyclonic solids separator is to utilize centrifugal movement of fluid and/or solids to separate fluid phases and/or solids from fluid. For example, water may be separated from hydrocarbons, gas may be separated from oil, sediment may be separated from water, sediment may be separated from formation fluid, etc. While described herein as a cyclonic solids separator configured to generate or otherwise induce a centrifugal movement in the fluid to separate sediment and/or fluid phases, the cyclonic solids separator described herein may utilize gravity to perform the aforementioned separation.

The hydrocyclone 2504 may be configured to generate a centripetal force inducing a centrifugal movement of the fluid as the fluid exits the separator and enters the pipe 2506. The centrifugal movement may push the heavier phases (such as sediment, water, etc.) outward toward the outer wall of the pipe 2506. In some implementations, the sediments 1516 in the rotating stream of fluid 2502 may have too much inertia to follow the tight curve of the stream. Such sediment 2516 may thus strike the outside wall and fall to the bottom of the pipe 2506 and enter the sediment discharge 2518. In some implementations, at least a portion of the heavier phased of fluid (such as water) may also enter the sediment discharge 2518. Thus, a sediment slurry may enter the sediment discharge 2518. The sediment 2516 may further be transported to its destination location (e.g., the surface, a storage area in the wellbore, injected into the subsurface formation, etc.). The heavier phases of fluid, i.e., waste liquid 2512 (such as water), may enter the waste liquid discharge 2514 and ultimately be transported to its destination location (such as injected into the subsurface formation of a bore of a multi-bore well). The lighter phases, i.e., clean liquid 2508 (such as hydrocarbons) may migrate towards the center of the pipe 2506 and proceed to the clean liquid discharge, where the clean liquid 2508 may ultimately be transported to the surface. In some implementations, the sediment discharge 1518 may be coupled with the clean liquid discharge 1510 such that the sediment may be injected into the stream of clean liquid to be transported to surface and removed from the wellbore. In some implementations, the cyclonic solids separator 2500 may be oriented with respect to gravity. Accordingly, the sediment discharge 2518 may be positioned at the bottom of the cyclonic solids separator 2500 to allow gravity to assist in the separation and ensure the sediments 2516 may eventually enter the sediment discharge 2518.

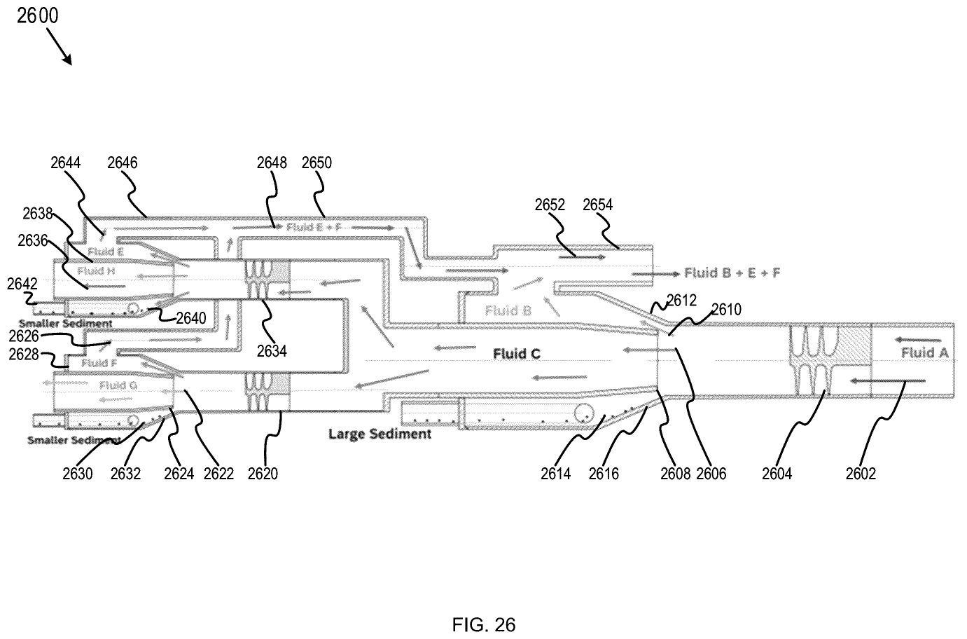

FIG. 26 is a partial cross sectional side view of an example group of cyclonic solids separators, according to some implementations. In particular, FIG. 26 includes a partial cross section of a separation system group 2600 (that may be representative of separation system 200 described in FIG. 2) positioned downhole in a wellbore. The separation system group 2600 depicts an example configuration of a group of separation systems each configured with hydrocyclones. In some implementations, each of the separation systems may be configured with any suitable cyclonic separation system, such as a helical separator. The group of separation systems may be configured to separate formation fluid from a subsurface formation into production fluid (e.g., hydrocarbons) and nonproduction fluid (e.g., water). Additionally, or alternatively, each of the separation systems may be configured to separate sediment from the formation fluid. A first separation system may be in series with a subset of separation systems (a second separation system and a third separation system). The second separation system and third separation system may be parallel to one another. Each of the separation systems may be representative of the cyclonic solids separator 2500 described in FIG. 25.

For example, fluid A (formation fluid) may enter the first hydrocyclone 2604. Sediment 2614 may be knocked out of the formation fluid 2602 and discharged to the sediment discharge 2616. In some implementations, the sediment discharge 2616 may be configured with a solids mover to transport the sediment to a destination location. Heavier phase liquids, i.e., fluid B 2610 (water), may be discharged to the waste liquid discharge 2612. Clean fluid, i.e., fluid C 2606 (hydrocarbons) may be discharged to the clean fluid discharge 2608. In some implementations, not all of the sediment and/or heavier phase liquids may be separated from the clean liquid. For example, emulsion may result in water being transported with the oil, silt may not be knocked out of the oil, etc. Thus, at least a portion of fluid C 2606 may then proceed to hydrocyclone 2620 and the remaining portion of fluid C 2606 may proceed to the hydrocyclone 2634 to further separate waste fluid from fluid C. Moreover, sediment smaller than the sediment knocked out from the hydrocyclone 2604 may be separated from fluid C via hydrocyclone 2620 and/or hydrocyclone 2634.

At least a portion of fluid C 2606 may enter the hydrocyclone 2620. The hydrocyclone 2620 may be configured to at least partially separate out any remaining sediment suspended in the fluid C and water in fluid C. Sediment 2630 may be knocked out of fluid C 2606 and discharged to the sediment discharge 2632. In some implementations, the sediment discharge 2632 may be configured with a solids mover to transport the sediment to a destination location. Heavier phase liquids, i.e., fluid F 2626 (water), may be discharged to the waste liquid discharge 2628. Clean fluid, i.e., fluid G 2622 (hydrocarbons) may be discharged to the clean fluid discharge 2624. The clean fluid discharge may lead to a tubing string, pump, etc. to transport the fluid G to the surface.

The other portion of fluid C 2606 may enter the hydrocyclone 2634. The hydrocyclone 2620 may be configured to at least partially separate out any remaining sediment suspended in the fluid C and water in fluid C. Sediment 2640 may be knocked out of fluid C 2606 and discharged to the sediment discharge 2642. In some implementations, the sediment discharge 2642 may be configured with a solids mover to transport the sediment to a destination location. In some implementations, sediment discharge 2642 may be coupled with sediment discharge 2630 and/or sediment discharge 2616 to dispose of the respective sediments 2640, 2630, 2614 in a destination location such as a sediment injector configured to inject the sediment to a tubular string with a fluid (production fluid and/or nonproduction fluid) to transport to surface, to inject into a subsurface formation surrounding a bore of a multi-bore well, etc.

Clean fluid, i.e., fluid H 2636 (hydrocarbons) may be discharged to the clean fluid discharge 2638. The clean fluid discharge may lead to a tubing string, pump, etc. to transport the fluid H to the surface. In some implementations, clean fluid discharge 2638 may be coupled with clean fluid discharge 2624 to combine clean fluid G with clean fluid H and transport said combined fluids to the surface.

Heavier phase liquids, i.e., fluid E 2644 (water), may be discharged to the waste liquid discharge 2646. Waste liquid discharge 2646 may be coupled with waste liquid discharge 2628 such that fluid E 2644 may be combined with 2626 in flow path 2650 to form fluid E+F 2648. The waste liquid discharge 2612 may be coupled with the flow path 2650 such that fluid B 2610 may be combined with fluid E+F 2648 to form fluid B+E+F 2652 in flow path 2654. The flow path 2654 may discharge fluid B+E+F 2652 to be disposed of, such as injected into a subsurface formation surrounding a bore of a multi-bore well.

In example implementations, cyclonic solids separator liners and parts may be of at least one of aluminum oxide (Al₂O₃), silicon carbide (SiC), Zirconium, monolithic castables, nitride bonded SiC, reaction bonded SiC, sintered alpha SiC, zirconia toughened alumina, fused cast alumina zirconia silica (AZS), silicon carbide, etc. In example implementations, the cyclone linings may be composed of ceramic.

The separation devices including the helical oil separator 2200, cyclonic separator 2300, cyclonic separator 2400, cyclonic separator 2500, and separation systems group 2600 in FIGS. 22-26 may be placed above, below, and/or alongside coalescing equipment. For example, with reference to FIG. 7, a cyclonic solids separator may be placed upstream or downstream of the solids catcher 710 in the water production path 706, upstream or downstream of the coalescing devices 702, etc. The cyclonic separators 2300, 2400, 2500 may be used for separating out sand, silt, oil, etc. depending on the size and configuration of the separator. In some implementations, the range of classification for cyclones and/or cyclonic separators may be 40 microns to 400 microns. Some applications may include a range as fine as five microns or as coarse as 1000 microns. Cyclones may be used in both primary and secondary grinding circuits as well as regrind circuits.

### Example Operations

All the example coalescers described herein may operate in concert with one or more other devices such as fluid separators, perturbation devices, and others. Some novel combinations may not be explicitly shown in the drawings but are with the scope of this disclosure. For example, a coalescer, which may coalesce hydrocarbons and separate out solid debris from a flowing medium, may be used with devices such as flow pipes, solids removers, cyclonic separators, perturbation devices, and other devices.

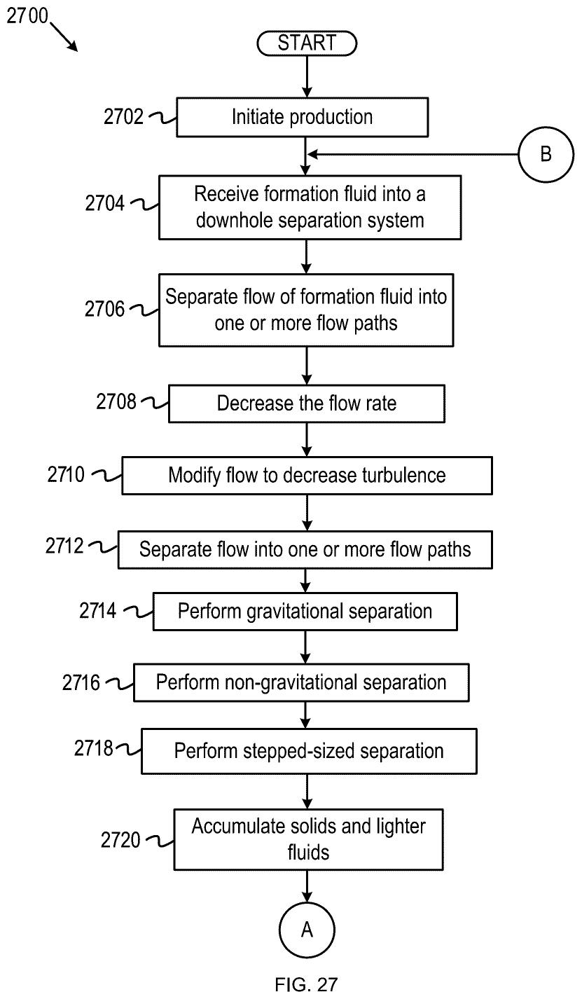

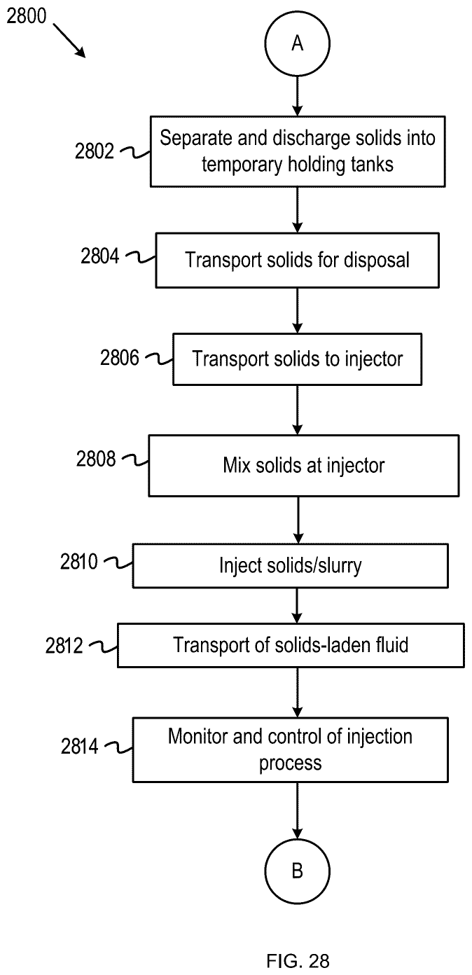

Example operations are now described. FIGS. 27-28 is a flowchart of example operations for downhole fluid and solid separation, according to some implementations. Flowcharts 2700-2800 of FIGS. 27-28, respectively, are described in reference to FIGS. 1-2. However, other systems and components may be used to perform the operations now described. Operations of the flowcharts 2700-2800 continue between each other through transition points A and B. Operations of the flowchart 2700 start at block 2702.

At block 2702, production is initiated. For example, with reference to FIGS. 1-2, production may be initiated by the formation fluid 118 entering the main bore 102 and/or the lateral bore 104. Flow progresses to block 2704.

At block 2704, formation fluid is received into a downhole separation system. For example, with reference to FIGS. 1-2, the formation fluid 118 may be received into the separation system 124. Flow progresses to block 2706.

At block 2706, flow of formation fluid may be separated into one or more flow paths. For example, with reference to FIGS. 1-2, the formation fluid 118 may flow into the fluid separator 296, wherein most or at least a majority of the production fluid 114 may separate into a flow above the separator 201, while most or at least a majority of the nonproduction fluid with sediment 294 may separate into a separate flow below the separator 201. Accordingly, if the formation fluid is at least partially segregated into oil-cut and water-cut, some example implementations may take advantage of such a segregation to separate these fluids into two flow paths. Lower-density (oil-cut) fluids may flow through a top flow path. Higher-density (water-cut) may flow through a bottom flow path. Flow progresses to block 2708.

At block 2708, the flow rate m decreased. For example, with reference to FIG. 2, the formation fluid 118 moves from a smaller to a larger diameter of the tubing 287. This may decrease the velocity of the flow of the formation fluid 118—which may allow the separation to occur. In particular, most or at least a majority of the production fluid 114 may separate into a flow above the separator 201, while most or at least a majority of the nonproduction fluid with sediment 294 may separate into a separate flow below the separator 201. This allows most of the sediment to be captured in the lower portion of the tubing 287 (below the separator 201). Accordingly, some implementations may reduce flow from a high-turbulent flow to a slower, less turbulent flow. Some implementations may induce laminar flow for separation of hydrocarbons, solids, and water. Some implementations may also provide more flow area (an increased pipe inner diameter, increased wellbore size, multilateral wellbore for settling ponds, distributing flow, etc.) to reduce the turbulence of the flow. Some implementations may also provide more time (start and stop flow, slow pumping action, etc.) to produce a less turbulent flow of the formation fluid 118. However, adjusting the rate of fluid flow may also be used for other means. For example, temporarily halting fluid flow may allow fluids to separate. The flow stoppage may be implemented by stopping a downhole pump, although other scenarios may be possible. Rather than halting flow entirely, reducing the flow rate of the formation fluid 118 via a speed reduction of the downhole pump may also induce greater fluid separation. Flow progresses to block 2710.

At block 2710, the flow of the formation fluid 118 may be modified to decrease turbulence. For example, example implementations may also destabilize turbulence and change the flow from a turbulent flow to a laminar flow (or transitional flow) by one or means (including those mentioned above). Flow progresses to block 2712.

At block 2712, flow may be separated into one or more flow paths. For example, with reference to FIG. 2, the formation fluid 118 may be separated into one or more flow paths via the fluid separator 296. Such separation may be applicable to different flows (e.g., formation fluids, oil-cut, water-cut, gas, liquid, liquid-gas, slurries (solids-laden fluids, production fluids, fluids to be disposed, fluids to be injected, etc.). The flow paths may include separation techniques such as those discussed in blocks 2714-2718. Flow progresses to block 2714.

At block 2714, gravitational separation may be performed. For example, with reference to FIG. 2, the fluid separator 296 may comprise a gravity-based separation that includes the separator 201. The gravitational separation may continue within each of the sediment separators 290A-N. For example, with reference to FIG. 4, the downhole coalescer 402 may allow lighter, less dense fluids to rise in an upwardly direction and accumulate along an underside 408 of the coalescer plates 404. Fluid may be introduced into the fluid separator 296 and the sediment separators 290A-N at a lower flow rate to allow time for lighter fluids and gases to separate from heavier, denser fluids. The lightest fluids, such as gases, may also accumulate and be channeled by the coalescer 402. Flow progresses to block 2716.

At block 2716, non-gravitational separation is performed. For example, with reference to FIG. 2, the formation fluid 118 may be separated using different types of non-gravitational operations. Such non-gravitational operations may include separating solids and a production fluid via the downhole coalescer 302. Flow progresses to block 2718. The order of the blocks of FIG. 27 may be changed or modified without deviating from the scope of this patent application. For example, block 2716 may occur before block 2714 without deviating from the scope of the implementations described herein. Likewise, blocks may be omitted, combined or duplicated. Blocks may be repeated sequentially or non-sequentially or both sequentially and non-sequentially.

At block 2718, stepped-sized separation is performed. For example, with reference to FIG. 2, the sediment separators 290A-290N may include a downhole coalescer having one or more stepped coalescer plates configured to separate the sediment 294 from the nonproduction fluid 116. Some implementations of the sediment separators 290A-290N may separate out the largest or densest solids first, then separate out the next largest or densest solids, etc. The stepped coalescer plates may be configured to separate solid debris based on a debris property, such as density, size, etc.

Some implementations may allow for settling and separation of solids to separate from fluid stream(s). Additionally, example implementations may allow time for the largest and/or densest solids to settle out from fluids. Example implementations may also allow lower flow rates to assist with the separation. Example implementations may use the sediment separators 290A-290N to allow the largest and/or densest solids to settle out, accumulate and be trapped. Example implementations may include allowing time for lighter fluids and gases to begin to segregate and separate from heavier fluids. Example implementations may include means, methods, and devices to subject one or more fluids to one or more force, acceleration, path (e.g., tortuous path, etc.), velocity, pressure, restriction (e.g., screen opening(s), screen size, nozzle, etc.), time, impulse, change in one or more of the above including step change, gradual change, etc. Some implementations may separate solids and oil droplets based on at least one of density, size, shape, surface tension, molecular makeup, other chemical, physical, molecular, electron properties, etc. Flow progresses to block 2720.

At block 2720, solids and lighter fluids are accumulated. For example, with reference to FIGS. 2 4, and 6, the different sediment separators 290A-290N may accumulate the sediment. Solid debris may fall from the top side 410 of each coalescer plate within the sediment separators while oil droplets, for example, may coalesce and accumulate as they travel along an underside 408 of the coalescer plates 404. The solid debris may fall from the coalescing devices 606-608 and into a solid debris storage unit 614 while a hydrocarbon may accumulate along the undersides of the coalescing devices 606-608.

Operations of the flowchart 2700 continue at transition point A, which continues at transition point A of FIG. 28. From transition point A of FIG. 28, operations continue at block 2802.

At block 2802, solids are separated and discharged into temporary holding tanks. For example, with reference to FIGS. 1-2, the different sediment separators 290A-290N may include temporary downhole disposal locations such as temporary holding tanks for storing the separated out solids. The temporary holding tank(s) may be similar to the solid debris storage unit 614. Some implementations may include utilize a transport device to transport solids, the transport device including at least one of an auger, drag chain, an inclined plane, a jetting device, etc. to keep the solids or slurry from accumulating at the discharge end of the solid separation device which may cause the device to plug and become inoperable. Flow progresses to block 2804.

At block 2804, solids are transported for disposal. For example, with reference to FIG. 2, these different collections of the sediment by the different sediment separators 290 may be injected into a same or different line or tubing for disposal. As shown, the sediment injector(s) 299 are coupled to receive the sediment collected by the different sediment separators 290. Flow progresses to block 2806.

At block 2806, solids are transported to an injector. For example, with reference to FIGS. 1-2, the sediment may be transported to the sediment injectors 299. Flow progresses to block 2808.

At block 2808, solids may be mixed at the injector. For example, with reference to FIG. 2, the sediment 295 may be mixed at the sediment injector 299. For example, the sediment 295 may be mixed with fluid (such as production fluid, nonproduction fluid, etc.). In some implementations, one or more type of mixers may be used. For example, a mechanical mixer, a fluid-type mixer, etc. may be used to mix the sediment 295 with fluid. In some implementations, solids may be stored in or near the injector 299 so that mixing may progress smoothly or consistently at a defined rate. For example, the solids may be stored in an enclosed tank, gravity-fed tank, auger-fed tank, etc. Flow progresses to block 2810.

At block 2810, solids (or slurry) are injected. For example, with reference to FIGS. 1-2, the sediment injectors 299 may deliver the sediment to a different downhole location (such as a different lateral well, a thief zone (having a high porosity, high permeability downhole zone that may include a low pressure), etc.). In some implementations, sediment may be disposed to different locations depending on their size. For example, for sediment having a size greater than X, such solids may be delivered to the surface of the multilateral well for disposal. For sediment having a size less than X but greater than Y, such sediment may be disposed in a first downhole location (such as a thief zone). For the remaining sediment that have a size less than Y, such solids may be disposed in a second downhole location (such as a lateral well). Flow progresses to block 2812.

At block 2812, solids-laden fluid is transported. For example, with reference to FIGS. 1-2, the sediment injector(s) 299 may dispose of these sediments by injecting them into a tubing for delivery to the surface of the multilateral well. For example, the sediment may be delivered to the surface using the production tubing or a separate tubing. If the production tubing is used, the solids may be included with the production fluid that is being delivered to the surface. In such implementations, separation operations may be performed at the surface to separate out the solids from the production fluid 114. Accordingly, if sediment is being included with the production fluid 114 being delivered to the surface, the production fluid 114 may be delivered to surface equipment that provides for separation of the sediment. Alternatively, during the time when the sediment is not being included with the production fluid 114, the production fluid 114 may be delivered to different surface equipment that does not include such separation of sediment.

In some implementations, the sediment injectors 299 may inject the solids or slurry into a string or tubular (e.g., a production tubing). Timing of the injection may be coordinated with production of production fluid. For example, a pump may switch between pumping (in the production tubing) production fluid to the solid-laden fluid. Example implementations may include communications to the surface regarding the switching, the volume of the solids, fluids, slurry to be pumped, how much has been pumped, how much remains to be pumped, etc. Additionally, some implementations may enable communication from the surface to downhole to control and override the switching. Flow progresses to block 2814.

At block 2814, an injection process is monitored and controlled. For example, with reference to FIGS. 1-2, controllers may be coupled to the sediment injectors 299 for monitoring and controlling the injection and disposal of the sediment (either to the surface of the multilateral well or to a disposal location downhole).

Operations of the flowchart 2800 continue at transition point B, which continues at transition point B of FIG. 28. From transition point B of FIG. 28, operations return to operations at block 2704 where a production mode is resumed after the injection process, and additional formation fluid is received into the separation system 124.

### Example Method

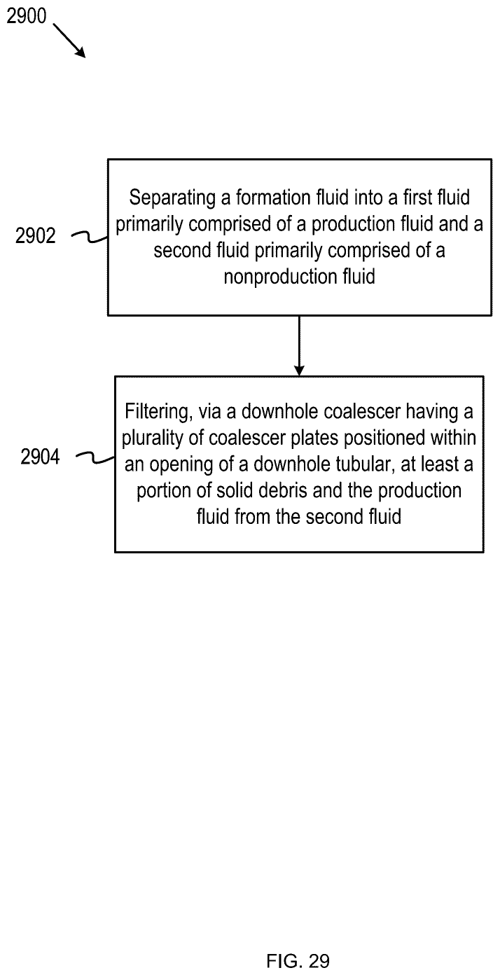

FIG. 29 is a flowchart of an example method of operations, according to some implementations. A flowchart 2900 of FIG. 29 is described in reference to FIGS. 1 and 3. However, other systems and components may be used to perform the operations now described. Operations of the flowchart 2900 start at block 2902.

At block 2902, a formation fluid from a subsurface formation is separated into a first fluid primarily comprised of a production fluid and a second fluid primarily comprised of a nonproduction fluid. For example, with reference to FIG. 1, a fluid separator may separate the formation fluid 118 into a production fluid (including hydrocarbons such as oil) 114 and a nonproduction fluid (such as water) 116. The nonproduction fluid 116 may contain residual oil, and the production fluid 114 may contain residual water. Both fluids 114, 116 may contain solids. Flow progresses to block 2904.

At block 2904, a downhole coalescer having a plurality of coalescer plates positioned within a downhole tubular may filter at least a portion of solid debris and the production fluid from the second fluid. For example, with reference to FIG. 3, the downhole coalescer 302 may be configured to coalesce oil and filter out solid debris from a fluid flow primarily comprised of a nonproduction fluid. However, other implementations of the downhole coalescer 302 may be positioned in fluid flows of varying compositions. Downhole oil, water, and solids separation may enable low-maintenance material separation downhole. Removing solid debris from the nonproduction fluid 116 may enable optimized injection operations when the nonproduction fluid is injected into a separate borehole, as solid debris may not clog or obstruct the injection equipment used to inject the nonproduction fluid. Flow of the flowchart 2900 ceases.

The order of the blocks of FIGS. 28 and 29 may be changed or modified without deviating from the scope of this patent application. For example, block 2814 may occur before block 2804 without deviating from the scope of the implementations described herein. Likewise, blocks may be omitted, combined, or duplicated. Blocks may be repeated sequentially or non-sequentially or both sequentially and non-sequentially.

Example Multilateral Wells

All the example coalescers described herein may operate in concert with one or more other devices such as fluid separators, perturbation devices, and others. Some novel combinations may not be explicitly shown in the drawings but are with the scope of this disclosure. For example, a coalescer, which may coalesce hydrocarbons and separate out solid debris from a flowing medium, may be used with devices such as flow pipes, solids removers, hydrocyclone separators, perturbation devices, and other devices.

Example implementations may be performed in different Technology Advancement of Multilaterals (TAML) Level wells. In particular, multilateral wells are characterized according to definitions established in 1997 during a Technology Advancement of Multilaterals (TAML) Forum held in Aberdeen. These standards classify junctions as TAML Level 1, 2, 3, 4, 5, or 6 based on mechanical complexity, connectivity, and hydraulic isolation. The ascending order of these levels reflects an increasing mechanical and pressure capability of the junction. Consequently, cost, complexity, and risk also generally increase at the higher TAML levels. However, other considerations of the well design also influence the overall complexity of the well-for example, a TAML Level 2 well with an advanced intelligent completion may be more complex and costly than a TAML Level 5 well with a simpler completion system.

In a TAML 1 well, the main bore, lateral, and junction are uncased. This basic lateral is designed to enhance reservoir drainage from consolidated formations. It has the advantage of low drilling and completion costs, but the open hole junction makes reentry into the lateral wellbore and control of flow from the lateral impossible.

Wells that have cased and cemented main bores and open hole laterals are designated TAML Level 2. A cemented main bore significantly reduces the risk of wellbore collapse and provides isolation between laterals. By placing sliding sleeves and packers in the main bore, operators may produce the bores singly or in commingle production.

Placing a liner in the lateral and mechanically connecting it to the cased and cemented main bore results in a TAML Level 3 well. A liner is a string of casing that does not extend to the surface but is anchored or suspended inside a previously run casing string. This TAML Level 3 well includes a lateral that is cased but not cemented at the junction. It is a relatively low-cost option that includes reentry capabilities and a lateral that is better supported than that of Levels 1 and 2. Using sliding sleeves and packer plugs, operators may produce the bores singly or in commingle production. A TAML Level 3 junction does not provide hydraulic isolation, and its use is restricted to consolidated formations.

TAML Level 4 junctions are applicable in both consolidated and unconsolidated formations because both the lateral and the main bore are cased and cemented at the junction. The junction provides full bore access to the lateral, and mechanical support is supplied by the tubulars and cement. However, because the cement may only withstand limited differential pressure, the junction does not provide hydraulic isolation.

TAML Level 5 wells do provide hydraulic isolation at the junction because pressure integrity is provided by the completion, which includes production tubing connecting a packer in the main wellbore above the junction and a packer in the lateral wellbore. Because hydraulic isolation and support are provided by the completion hardware, the junction may be a TAML Level 2, 3, or 4 before the Level 5 completion is installed. TAML Level 6 wells also provide hydraulic isolation at the junction. A well at this level differs from a TAML Level 5 well in that pressure integrity is provided by the main wellbore casing and a cemented or uncemented liner in the lateral. The cost and complexity of creating a single-metal-element dual-bore casing junction downhole has prevented TAML Level 6 wells from being developed. As of today, the category exists as a result of early experiments. Because multilateral wells that have higher TAML designations are generally more complex, they are more costly, and their configurations are more flexible. As they do with multilateral geometry, engineers choose a TAML level junction based primarily on reservoir characteristics, costs, and function.

The ability to reenter the lateral for well intervention operations is another multilateral well design consideration. Because it is a directionally drilled section that has no junction, the lower lateral is almost always easily accessed using standard intervention methods. Operators must make an economics-based decision during the well planning stage to include junctions that allow lateral access after pulling the upper completion, through-tubing access, junctions that may be adopted to allow access after installation or junctions through which no access is possible to main bore, lateral, or both. If the well includes more than one lateral, a selective through-tubing access system would need to be considered. The decision to deploy lateral junctions that allow full bore or restricted access is a function of the overall well design. Engineers usually opt for full bore access if a packer is to be placed below the junction or if an artificial lift system must be located near the lower lateral. In addition, based on their knowledge of the reservoir, operators may require full bore access to perform perforating, stimulation, logging, water shutoff, gravel packing, cleanout, and other remedial operations. Full bore access may be adapted to all TAML level junctions but must be specified before installation; some commercially available junctions allow no access or only restricted access to either the lateral or the main bore and cannot be adapted after installation.

The decision to use a multilateral well system and what type to use are the result of cost benefit analyses. In general, the less-complex junctions present operators with lower risks and costs. But risk mitigation and cost savings must be balanced against individual well and field development expectations. In low-value reservoirs, a simple open hole lateral that has no reentry capability may increase ultimate reserve recovery or accelerate production while having little impact on overall drilling and completion costs. In high-value deepwater plays, installing a hydraulically sealed TAML Level 5 or 6 junction may drive total well costs into millions of dollars and still be a good investment because it may save drilling another well with a complex and tortuous trajectory, preserve a well slot on an existing production platform, or eliminate the need entirely to procure and install additional subsea infrastructure.

In some implementations, a multilateral well may be drilled and completed with a TAML Level 4 junction. The junction includes a pump and a fluid separator. The pump includes any pump capable of drawing in fluid through the pump intake, pressurizing it, and lifting it to the surface such as an electrical submersible pump, sucker-rod and pump jack, progressive cavity pump, gas lift and intermittent gas lift, reciprocating and jet hydraulic pumping systems, etc. The fluid separator and the pump may be above, at, or below the junction. The upper completion includes a retrievable electrical submersible pump packer while the lower completion has an orientation liner hanger or other orientation device.

In some implementations, a mechanical junction (not to be confused with the earthen junction of 2 earthen wellbores) may comprise a junction with a monolithic Y-Block. In some implementations, a monolithic Y-Block may provide for more robust connections to the other components of a junction assembly (i.e., mainbore leg, lateral leg, tank, etc.).

To illustrate, FIG. 30 is a perspective view of an example of a Level 5 (mechanical) junction assembly for use with a downhole oil, water, and solids separator system, according to some implementations. FIG. 30 depicts a system 3000 having a multilateral well that includes a main bore 3001, a lateral bore 3050, and a lateral bore 3051. Formation fluid 3002 from the surrounding subsurface formation enters the main bore 3001. The formation fluid 3002 is transported through the main bore 3001 uphole to a level 5 monolithic Y-block 3004 and into a DOWSS 3008.

The DOWSS 3008 may refer to a system for Downhole Oil, Water, and Solids separation. The DOWSS 3008 may be used with a DOWS (Downhole Oil and Water Separation) system and/or components of the DOWS. The DOWSS 3008 may process the formation fluid 3002 to separate out nonproduction fluid 3006 from production fluid 3022. The DOWSS 3008 may also process the formation fluid 3002 to separate sediment from at least one of the nonproduction fluid 3006 or the production fluid 3022. The DOWSS 3008 may transport the nonproduction fluid 3006 into the lateral bore 3050 for disposal in a disposal zone 3020 for the nonproduction fluid 3006 in the subsurface formation around the lateral bore 3050. The DOWSS 3008 may also transport sediment 3025 into the lateral bore 3051 for disposal in a disposal zone 3024 for the sediment 3025 in the subsurface formation around the lateral bore 3051. The DOWSS 3008 may also transport the production fluid 3022 and sediment 3010 to a surface of the multilateral well. Accordingly, in this example, the sediment may be disposed downhole into a highly permeable zone downhole and/or may be transported to the surface of the multilateral well and/or a subsea/seafloor location.

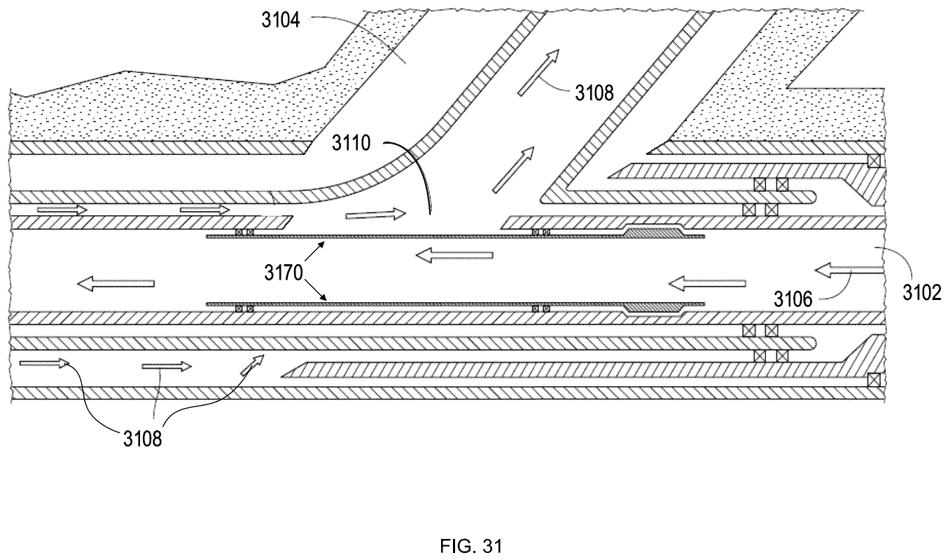

FIG. 31 is a cross-sectional view of an example of a Level 5 junction assembly for use with a downhole oil, water, and solids separator system, according to some implementations. In this implementation, a main bore junction 3110 is used to provide a main bore 3102 for large tools to be passed through, or landed, in the y-block and/or main bore area of the junction 3110. A lateral bore 3104 is formed off the main bore 3102 at the junction 3110. In the example shown, an isolation sleeve 3170 may be landed in the junction. As shown, the isolation sleeve 3170 may provide pressure isolation between the formation fluids 3106 and the nonproduction fluids 3108. This main bore junction 3110 may be used with a variety of different Downhole Oil Water Separator Systems (DOWSS) and/or components including the DOWSS and/or its components disclosed within herein. The main bore junction 3110 may have a main bore leg inside diameter (ID) of 30% the outer diameter (OD) of the Junction's Y-Block. The main bore leg's ID may be 40% the OD of the Junction's Y-Block. The main bore leg's ID may be 50%, 53%, 55%, 60%, 67% or more of the Junction's Y-Block OD.

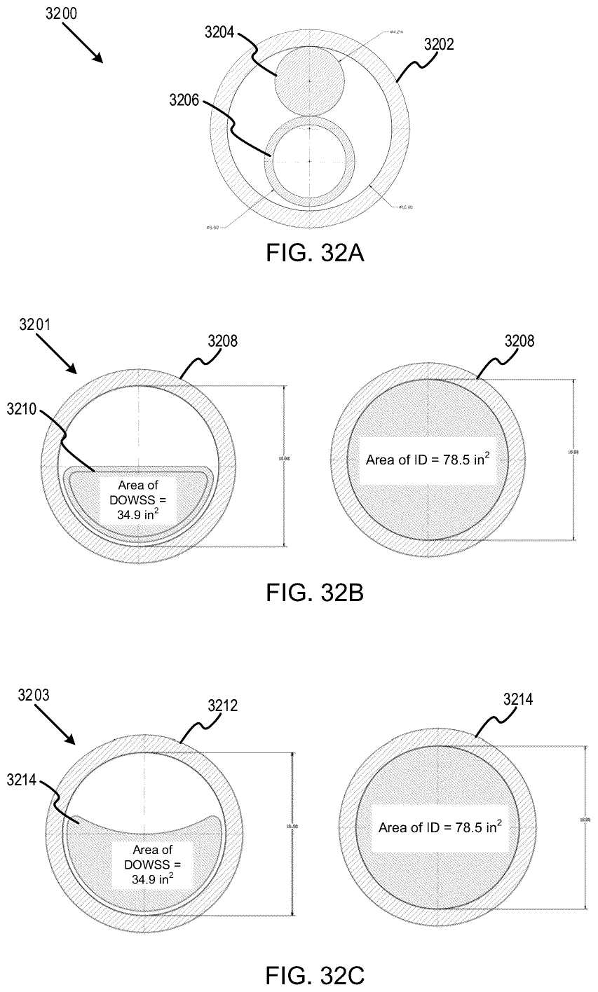

To help illustrate, FIGS. 32A-32C are cross-sectional views of an example DOWSS positioned in a casing, according to some implementations. FIG. 32A includes a DOWSS cross section view 3200 of a DOWSS 3206 in the inner bore of a casing 3202. As shown, the DOWSS 3206 and/or related equipment occupies approximately 55% of the inner diameter of the casing 3202. Accordingly, the remaining diameter may allow for a tool 3204 or to pass by the DOWSS. FIG. 32B includes a DOWSS cross section view 3201 of a DOWSS 3210 in the inner bore of a casing 3208. As shown in this implementation, the inner bore of the casing 3208 is approximately 78.5 square inches and the DOWSS 3210 occupies about 34.9 square inches, or approximately 44% of the flow area. Thus, the remaining area may remain open for tools to pass by the DOWSS 3210 for cleaning, servicing, parts replacement, etc. on the DOWSS 3210, related equipment, or other equipment/areas past the DOWSS 3210 in a well. The DOWSS 3210 may occupy any suitable space of the inner bore of the casing 3208. FIG. 32C includes a DOWSS cross section view 3203 of a DOWSS 3214 in the inner bore of a casing 3212. Similarly to FIG. 32B, the inner bore of the casing 3212 is approximately 78.5 square inches and the DOWSS 3214 occupies about 34.9 square inches, or approximately 44% of the flow area. Thus, the remaining area may remain open for tools to pass by the DOWSS 3214 for cleaning, servicing, parts replacement, etc. on the DOWSS 3214, related equipment, or other equipment/areas past the DOWSS 3214 in a well. In some implementations, the outer profile of the DOWSS 3214 may be shaped to provide functions such as support tools that pass over the DOWSS 3214, provide a sealing surface for service tools to seal against, provide features for the service tools to attach themselves to (such as to replace components, flush debris, lubricate one or more components, etc.), etc.

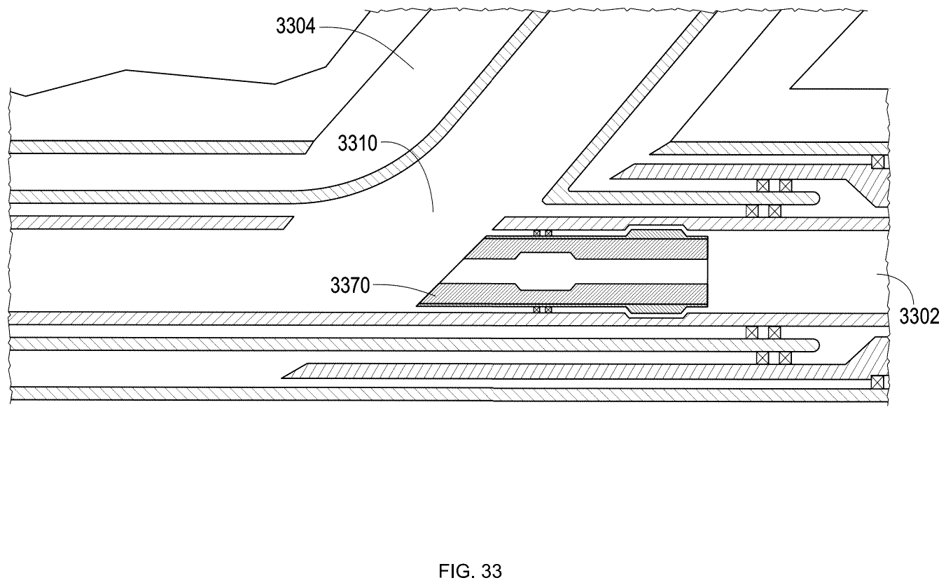

FIG. 33 is a cross-sectional view of an implementation where the isolation sleeve may be shifted out of the way (or retrieved) and a deflection device installed to aid in deflecting one or more tools or devices out into a lateral bore, according to some implementations. FIG. 33 depicts a main bore 3302 and a lateral bore 3304 that is formed off the main bore 3302 at the junction 3310. An isolation sleeve 3370 may be shifted out of the way (or retrieved) to allow for a deflection device to be installed to aid in deflecting one or more tools or devices out into the lateral bore 3304.

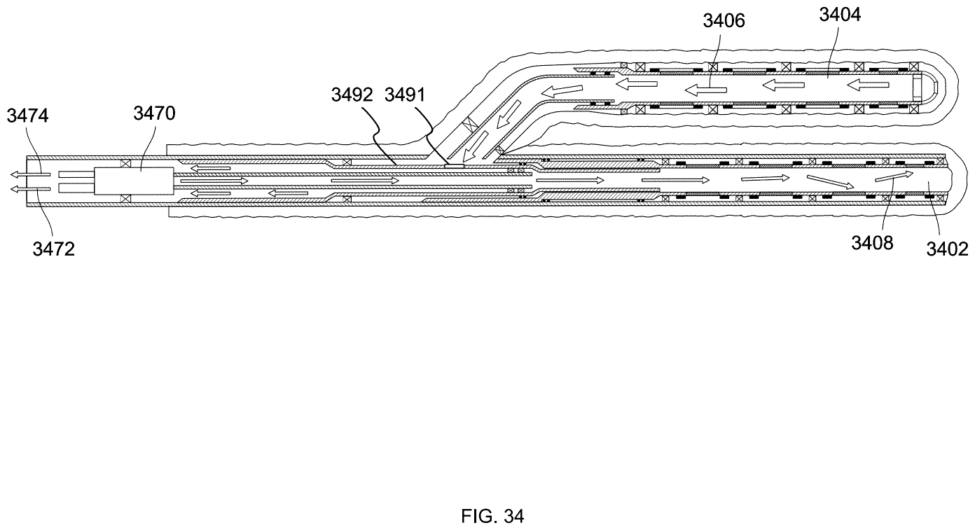

FIG. 34 is a cross-sectional view of a multilateral tool implementation of one or more DOWSS implementations with a non-Level 5 junction, according to some implementations. In this example, the multilateral well is producing from a lateral bore 3404 (instead of the main bore 3402) so the earthen junction isn't over-pressure by fluid being injected in its surroundings. Formation fluid 3406 is being produced from a subsurface formation surrounding the lateral bore 3404. A tubular 3492 in the main bore may include a port 3491 to enable the flow of the formation fluid 3406 to flow into the main bore 3402. A DOWSS 3470 may receive the formation fluid 3406 and separate the formation fluid 3406 into a nonproduction fluid 3408, a sediment 3472, and a production fluid 3474. As shown, the nonproduction fluid 3408 may be disposed of downhole by being transported into the main bore 3402 for disposal in the surrounding subsurface formation. The sediment 3472 may be disposed of downhole and/or transported to the surface of the multilateral well. The production fluid 3474 may be transported to the surface of the multilateral well.

The above examples of junctions are provided as nonlimiting examples—as other type of junctions may be used. The placement of the DOWSS, the DOWSS components, the tubing/fluid paths are also non-limiting examples—as other placements, components, paths may be used. The terms “downhole” and “below” may or may not be considered equivalent depending on the type of wellbore. For example, “downhole” and “below” may be considered the same for vertical wellbores. However, “downhole” and “below” may be considered different for horizontal wellbores.

### Example Subsea DOWSS (Downhole Oil Water Solids Separation)

Example implementations may include Subsea Oil Water Solids Separation (SOWSS). Example implementations may include disposal of solids, storage of water, and oil maybe subsea-on the seafloor or in storage wells or in storage vessels embedded in the seafloor, positioned on the seafloor, or a combination thereof.

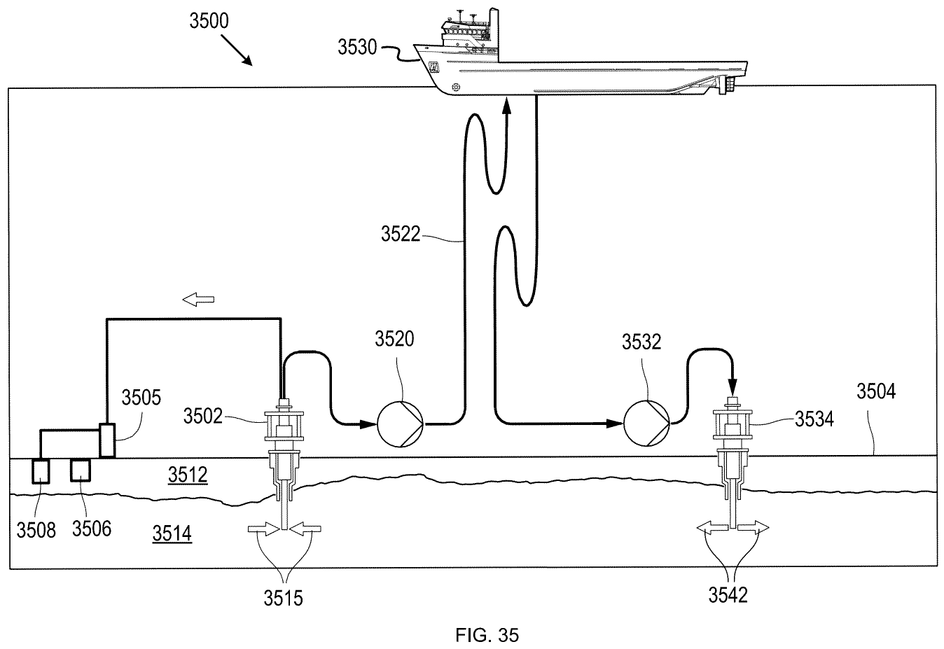

FIG. 35 is a perspective view of a first example subsea DOWSS, according to some implementations. FIG. 35 includes a subsea DOWSS 3500 that includes a subsea production well 3502 formed in a subsea surface 3504. The subsea production well 3502 may be formed through rock 3512 and a reservoir 3514. As described herein, production fluid (such as hydrocarbons 3515) and possibly nonproduction fluid, sediment, etc. may be transported from downhole to a surface of the subsea production well 3502.

In some implementations, this fluid transported to the surface of the subsea production well 3502 may be transported to a ship 3530 via a multiphase pump 3520 and risers 3522. The ship 3530 may include equipment to separate out nonproduction fluid (such as water) from the production fluid. The ship 3530 may also include storage for the production fluid. As shown, the nonproduction fluid (such as water) separated out from the production fluid by equipment of the ship 3530 may be transported down below to a subsea injection well 3534 via a water injection pump 3532. The water 3542 may be pumped downhole into the subsea injection well 3534. As shown, the water 3542 may be returned for storage in the reservoir 3514, although other uses may be possible. For example, the water 3542 may be injected into the reservoir 3514 to pressurize the reservoir 3514 for enhanced oil recovery (EOR), to encourage fluid to flow to the low pressure area near well 3502 (i.e., waterflooding), etc.

In some implementations, at least some of the fluid transmitted to the surface of the subsea production well 3502 may remain below (instead of being transported to the ship 3530). For example, after being transported to the surface, the fluid may be transported to a location 3505 at the subsea surface 3504 for processing, separating, pumping, etc. Then, the nonproduction fluid (separated out from this fluid) may be stored below the subsea surface 3504 at a location 3508. Additionally, the production fluid (separated out from this fluid) may be stored below the subsea surface 3504 at a location 3506. In some implementations (even though not shown), sediment (solids) separated out from this fluid may be stored at or under the subsea surface 3504.

Accordingly, fluid from the subsea production well 3502 may be pumped to subsea surface 3504 for processing, temporary storage, transport, water injection to maintain reservoir pressure, water flood from the subsea injection well 3534 to push hydrocarbons to the subsea production well 3502 and/or disposal.

In some implementations, the solids may be flowed to the sea floor and then injected into a disposal well (or other designated well). In some implementations, the solids, non-commercial fluids, a combination of both, etc. may be produced, separated, processed, stored, and then injected into the disposal well (or other designated well).

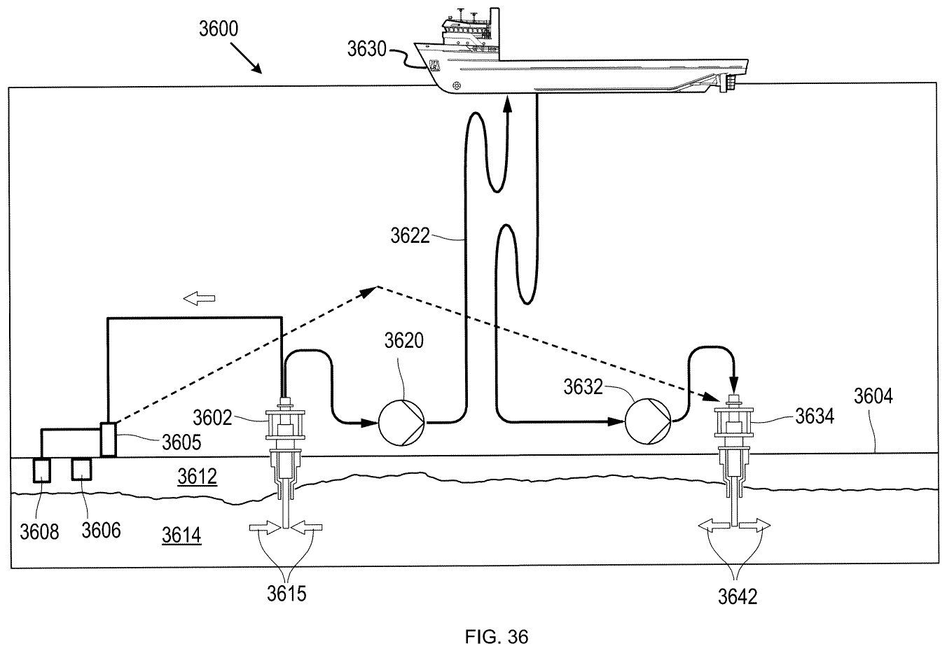

To illustrate, FIG. 36 is a perspective view of a second example subsea DOWSS, according to some implementations. Offshore drilling rigs may (on occasion) inject used drilling mud into a disposal well. FIG. 36 includes a subsea DOWSS 3600 that includes a subsea disposal well 3634 used for injection of an injection fluid 3642 which may include used drilling mud (solids, (drill cuttings, etc.) 3642. The subsea DOWSS 3600 also includes a subsea production well 3602. As shown, the subsea disposal well 3634 and the subsea production well 3602 may be formed in a subsea surface 3604. The subsea disposal well 3634 and the subsea production well 3602 may be formed through rock 3612 and a reservoir 3614. As described herein, production fluid (such as hydrocarbons 3615) and possibly nonproduction fluid, sediment, etc. may be transported from downhole to a surface of the subsea production well 3602.

In some implementations, this fluid transported to the surface of the subsea production well 3602 may be transported to a ship 3630 via a multiphase pump 3620 and risers 3622. The ship 3630 may include equipment to separate out nonproduction fluid (such as water) from the production fluid. The ship 3630 may also include storage for the production fluid. As shown, the solids (drill cuttings) separated out from the production fluid by equipment of the ship 3630 may be transported down below to the subsea disposal well 3634 via a pump 3632. The solids (drill cuttings) may be pumped within the injection fluid 3642, the injection fluid pumped downhole into the subsea disposal well 3634 for storage in the reservoir 3614.

In some implementations, at least some of the fluid transmitted to the surface of the subsea production well 3602 may remain below (instead of being transported to the ship 3630). For example, after being transported to the surface, the fluid may be transported to a location 3605 at the subsea surface 3604 for processing, separating, pumping, etc. Then, the nonproduction fluid (separated out from this fluid) may be stored below the subsea surface 3604 at a location 3608. Additionally, the production fluid (separated out from this fluid) may be stored below the subsea surface 3604 at a location 3606. The solids (drill cuttings) separated out from this fluid may be stored downhole in the subsea disposal well 3634.

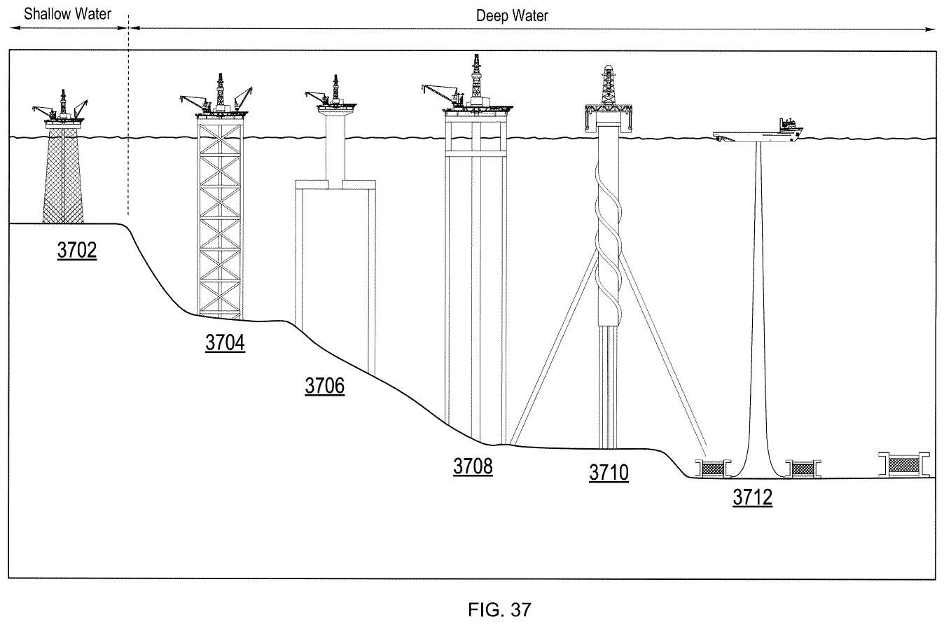

FIG. 37 is a perspective view of types of offshore well that may benefit from example implementations, according to some implementations. The lifting cost of producing formation water from 3500 meters (m) is very costly. The cost of lifting solids in a high-velocity rate is extremely erosive and costly. Separating out the solids and then lifting them at a slower rate will decrease the amount erosion. FIG. 37 depicts a number of offshore wells at different depths. In particular, FIG. 37 depicts a fixed platform well 3702 (that may be used up to 200 m), a compliant piled tower well 3704 (that may be used between 200-500 m), a tension leg platform (TLP) well 3706 (that may be used between 300-1500 m), a semi floating production system (FPS) well 3708 (that may be used between 300-2000 m), a single point anchor reservoir (SPAR) platform well 3710 (that may be used between 300-2000 m), a floating production storage and offloading system (FPSO), and a subsea well 3712 (that may be used up to 3000 m).

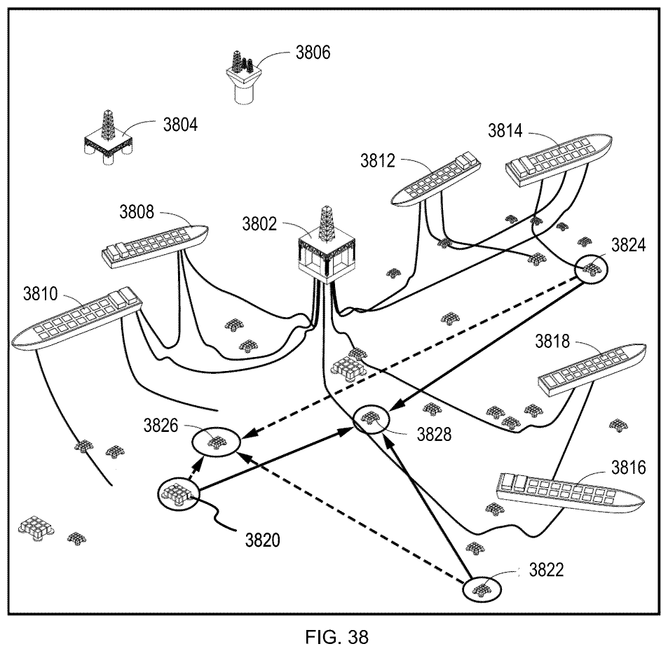

FIG. 38 is a perspective view of an example subsea downhole oil water solids separation, according to some implementations. FIG. 38 depicts a number of offshore rigs - an offshore rig 3802, an offshore rig 3804, and an offshore rig 3806. FIG. 38 also depicts a number of ships-a ship 3808, a ship 3810, a ship 3812, a ship 3814, a ship 3816, and a ship 3818. The offshore rigs 3802-3806 and the ships 3808-3818 may include equipment to separate out nonproduction fluid (such as water) from the production fluid. The offshore rigs 3802-3806 and the ships 3808-3818 may also include storage for the production fluid, the nonproduction fluid, etc.

FIG. 38 also depicts a number of production wells—a production well 3820, a production well 3822, and a production well 3824. FIG. 38 also depicts a water disposal well 3826 and a solids disposal well 3828. The fluids/solids from the production wells 3820-3824 may be transported to any of the oil rigs 3802-3806, any of the ships 3808-3818 or another subsurface well. For example, the nonproduction fluid and the solids from the production wells 3820-3824 may be transported to the water disposal well 3826 and the solids disposal well 3828, respectively. Additionally, production fluid processing and separation, nonproduction fluid processing and/or solids processing may occur at one of more of the locations identified in FIG. 38.

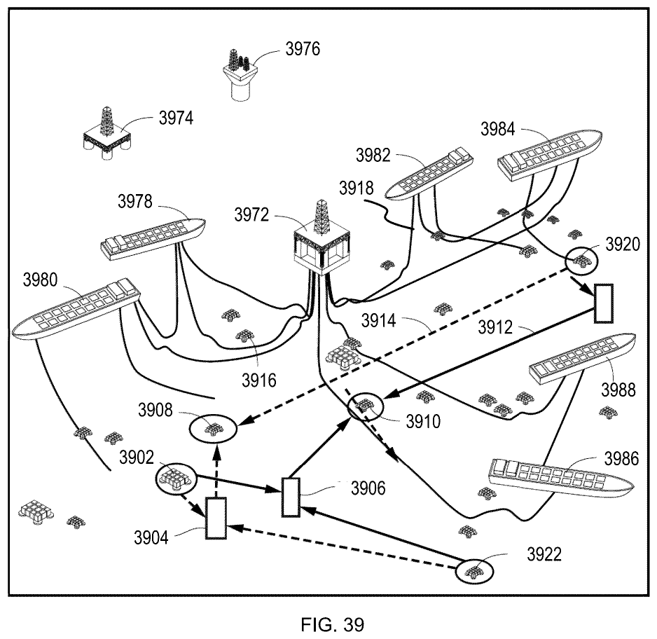

FIG. 39 is a perspective view of example locations in which example implementations may be used. FIG. 39 includes 11 example locations. A first example location includes a well 3902 where fluids may exit the well or are injected therein. A second example location includes an oil-cut processing unit 3904. For example, a flow diverter may divert oil-cut fluid to an oil-cut processing unit 3904. The oil-cut processing unit 3904 may include a flow diverter to remove more water from an oil-cut fluid. In some implementations, a flow diverter may divert solids, slurry, sludge, etc. to a processing unit 3906. Such solids, slurry, sludge, etc. may then be stored in a storage container or disposal well 3910. Flow diverter may be part of the storage container or disposal well 3910 to remove more oil from the slurry. The processing unit 3906 may include a flow diverter to remove more oil from the slurry.

FIG. 39 also depicts a number of offshore rigs-an offshore rig 3972, an offshore rig 3974, and an offshore rig 3976. FIG. 39 also depicts a number of ships-a ship 3978, a ship 3980, a ship 3982, a ship 3984, a ship 3986, and a ship 3988. The offshore rigs 3972-3976 and the ships 3978-3988 may include equipment to separate out nonproduction fluid (such as water) from the production fluid. The offshore rigs 3972-3976 and the ships 3978-3988 may also include storage for the production fluid, the nonproduction fluid, etc.

Another example location may include an oil storage and transfer unit 3908. Another example location may include a solids or slurry transfer line 3912. For example, a flow diverter may help mix, remix, stir, or agitate solids to keep them in suspension in the solids or transfer line 3912. Another example location may include a production fluids/oil-cut fluid/fluid transfer line 3914. For example, a flow diverter may help mix, remix, stir, or agitate solids and the fluids to keep them flowing properly in the production fluids/oil-cut fluid/fluid transfer line 3914. Another example location may include a well 3916 with vertical, inclined, sloped, deviated, tortuous paths.

Another example location may include a multilateral well 3918 (that includes a lateral wellbore, junction, etc.). Another example location may include a horizontal well 3920. Another example location may include a main production transfer line 3922 to another subsea pumping, gathering, and/or processing station or to land-based pumping, gathering, and/or processing facility.

The processing steps described herein mention “DOWS equipment”. Such DOWS equipment may imply the Coalescing System, its components and/or related equipment (i.e., solid gathering, storage, disposal system, etc.). “DOWS equipment” may also imply the one or more of the other systems related to the overall DOWS system, and/or the DOWS in total, and/or the entire Well System and its components.

Example implementations may include one or more of the following steps that may be used in manual (human-controlled, partially human controlled), programmed (software-controlled), AI controlled (Supervised, Unsupervised, etc.), etc. modes.

It should be noted that the coalescing System, the DOWS system and components (including coalescer) may be inclusive of items from the wellhead to the toe of each wellbore and more (such as a subsea Christmas tree, subsea pumping, processing, storage, DOW-related equipment, etc.). The cables/energy conduits that provide power to the one or more ESPs and/or other pumps and prime movers (downhole and on surface) may be inclusive. The surface components that transport the fluids and solids (everything) out of the well may be included. Subsea trees, subsea DOWS equipment, platform, land-base, jack up, drillship, etc. types of equipment may be inclusive. All data lines, data processing, sensors, in the well and outside of the well may be inclusive. All fluid processing equipment and processes in the well and outside of the well may be inclusive. All solids processing equipment and processes in the well and outside of the well may be inclusive.

The above examples of junctions are provided as nonlimiting examples—as other type of junctions may be used. The placement of the DOWS systems, the DOWS components, the tubing/fluid paths are also non-limiting examples—as other placements, components, paths may be used. The terms “downhole” and “below” may or may not be considered equivalent depending on the type of wellbore. For example, “downhole” and “below” may be considered the same for vertical wellbores. However, “downhole” and “below” may be considered different for horizontal wellbores.

The hardware and data processing apparatus used to implement the various illustrative logics, logical blocks, modules and circuits described in connection with the implementations disclosed herein may be implemented or performed with a general purpose single-or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, e.g., one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™M disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described as acting in certain combinations and even initially claimed as such, one or more features from a claimed combination may in some cases be excised from the combination, and the claimed combination may be directed to a sub-combination or variation of a sub-combination.

While operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well may be horizontal or even slightly directed upwards. Unless otherwise specified, use of the terms “subsurface formation” or “subterranean formation” shall be construed as encompassing both areas below exposed earth and areas below earth covered by water such as ocean or fresh water.

While the aspects of the disclosure are described with reference to various implementations and exploitations, it will be understood that these aspects are illustrative and that the scope of the claims is not limited to them. Many variations, modifications, additions, and improvements are possible. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed. As used herein, the term “or” is inclusive unless otherwise explicitly noted. Thus, the phrase “at least one of A, B, or C” is satisfied by any element from the set {A, B, C} or any combination thereof, including multiples of any element.

### Example Implementations

Implementation #1: A downhole separation system comprising: the downhole separation system configured to be positioned downhole in a well formed in a subsurface formation, wherein the downhole separation system is configured to receive a formation fluid from the subsurface formation and configured to separate the formation fluid into a first fluid primarily comprised of a production fluid and a second fluid primarily comprised of a nonproduction fluid, the downhole separation system including, at least a first coalescer to be positioned within a downhole tubular, wherein the first coalescer is configured to separate out at least a portion of debris and the production fluid from the second fluid.

Implementation #2: The downhole separation system of Implementation 1, wherein the well comprises a multi-bore well, wherein the formation fluid is to be received from the subsurface formation surrounding a first bore of the multi-bore well, and wherein the downhole separation system comprises a pump configured to pump the nonproduction fluid into a second bore of the multi-bore well for disposal into the subsurface formation surrounding the second bore.

Implementation #3: The downhole separation system of any one or more of Implementations 1-2, wherein the downhole separation system comprises, at least one debris injector configured to inject the debris separated out via the first coalescer into a downhole disposal location.

Implementation #4: The downhole separation system of any one or more of Implementations 1-3, wherein the downhole disposal location comprises the subsurface formation surrounding a third bore of the multi-bore well.

Implementation #5: The downhole separation system of any one or more of Implementations 1-4, wherein the first coalescer includes one or more coalescer plates, wherein each of the one or more coalescer plates is oriented with respect to gravity.

Implementation #6: The downhole separation system of any one or more of Implementations 1-5, wherein each of the one or more coalescer plates are removable from the well without a removal of the pump.

Implementation #7: The downhole separation system of any one or more of Implementations 1-6, further comprising: a solids catcher positioned below the first coalescer, wherein the solids catcher is configured to receive the debris separated via the first coalescer; a transport device coupled to the solids catcher, wherein the transport device is configured to move the debris; and a debris storage unit, wherein the debris storage unit is configured to store the debris moved by the transport device.

Implementation #8: The downhole separation system of any one or more of Implementations 1-7, further comprising: a processor; a computer-readable medium having instructions executable by the processor, the instructions including: instructions to determine a quantity of the debris in the debris storage unit; instructions to determine that the quantity of the debris in the debris storage unit has exceeded a threshold; instructions to mix the debris in the debris storage unit with a third fluid; and instructions to inject, via a debris injector, the debris and the third fluid into a debris storage formation.

Implementation #9: The downhole separation system of any one or more of Implementations 1-8, further comprising: instructions to move the debris into a production tubular; and instructions to produce the debris to a location of the well via the production tubular, wherein the production of the debris to another location of the well is timed, via the processor, to be coordinated with a production of the first fluid to a surface of the well.

Implementation #10: The downhole separation system of any one or more of Implementations 1-9, further comprising: a mounting mechanism positioned downhole and configured to receive the first coalescer, wherein the first coalescer is configured to couple with the mounting mechanism via an attachment receptacle of the first coalescer, wherein an angle of approach of the first coalescer is adjustable via the attachment receptacle.

Implementation #11: The downhole separation system of any one or more of Implementations 1-10, further comprising: instructions to adjust, via the processor, the angle of approach of the first coalescer, wherein the instructions to adjust the angle of approach of the first coalescer include instructions to adjust an angle of approach of each of one or more coalescer plates of the first coalescer.

Implementation #12: The downhole separation system of any one or more of Implementations 1-11, wherein an angle of roll of the first coalescer is adjustable via the attachment receptacle.

Implementation #13: The downhole separation system of any one or more of Implementations 1-12, further comprising: instructions to adjust, via the mounting mechanism, a yaw of the first coalescer.

Implementation #14: The downhole separation system of any one or more of Implementations 1-13, further comprising: at least a first sensor positioned upstream of the first coalescer and configured to sense one or more flow parameters; and at least a second sensor configured to measure one or more operational parameters of the first coalescer, wherein the instructions further comprise, instructions to initiate a cleaning of the first coalescer based, at least in part, on a flow rate measurement obtained by at least the first sensor, wherein a flow rate measurement lower than a flow rate threshold initiates the cleaning, and instructions to adjust a positional attribute of the first coalescer based, at least in part, on measurements obtained via at least the second sensor.

Implementation #15: An apparatus comprising: a coalescer to be positioned within a downhole tubular, the coalescer including: one or more coalescer plates configured to separate debris from a first fluid, wherein the first fluid includes at least a formation fluid, a production fluid or a nonproduction fluid.

Implementation #16: The apparatus of Implementation 15, wherein each of the one or more coalescer plates are retrievable from the downhole tubular.

Implementation #17: The apparatus of any one or more of Implementations 15-16, wherein the one or more coalescer plates are substantially flexible to allow passage of a first tool through the downhole tubular.

Implementation #18: The apparatus of any one or more of Implementations 15-17, wherein the one or more coalescer plates include strip coalescers formed from one or more rectangular strips, wherein the strips coalescers are configured to allow passage of the first tool through the tubular, and wherein the strip coalescers include one or more gaps configured to allow a lighter fluid of the production fluid to coalesce.

Implementation #19: The apparatus of any one or more of Implementations 15-18, wherein the strip coalescers include one or more positional devices, wherein the one or more positional devices allow the strip coalescers to move and allow passage of the first tool, and wherein the one or more positional devices are configured to return the strip coalescers to their original position after the passage of the first tool.

Implementation #20: The apparatus of any one or more of Implementations 15-19, wherein the coalescer includes a plurality of offset coalescer plates configured to be actuated in at least one of a roll and a pitch.

Implementation #21: The apparatus of any one or more of Implementations 15-20, wherein the coalescer is configured to change one or more flow parameters of the first fluid as the first fluid flows through the coalescer.

Implementation #22: A method comprising: performing a downhole fluid separation in a well that is formed in a subsurface formation, the performing including, introducing a formation fluid from the subsurface formation into the well; separating the formation fluid into a first fluid primarily comprised of a production fluid and a second fluid primarily comprised of a nonproduction fluid; and filtering, via a downhole coalescer having a plurality of coalescer plates positioned within a downhole tubular, at least a portion of debris and the production fluid from the second fluid.

Implementation #23: The method of Implementation 22, wherein the well comprises a multi-bore well, wherein the formation fluid is to be received from the subsurface formation surrounding a first bore of the multi-bore well, wherein the method comprises, disposing of the nonproduction fluid into the subsurface formation surrounding a second bore of the multi-bore well.

Implementation #24: The method of any one or more of Implementations 22-23, further comprising: coalescing, via one or more coalescer plates of the downhole coalescer, the production fluid, wherein each of the one or more coalescer plates includes a top side portion configured for filtering the debris from the second fluid and a corrugated underside configured for coalescing the production fluid from the second fluid, wherein the debris falls from the top side portion of the one or more coalescer plates.

Implementation #25: The method of any one or more of Implementations 22-24, further comprising: receiving, via a solids catcher positioned below the one or more coalescer plates, the debris separated via the one or more coalescer plates; transporting, via a transport device coupled to the solids catcher, the debris to a debris storage unit; storing, via the debris storage unit, the debris transported by the transport device; and cleaning, via a cleaning tool, the one or more coalescer plates and the debris storage unit, wherein the one or more coalescer plates are comprised of a substantially flexible material configured to allow passage of the cleaning tool through the downhole tubular.

Implementation #26: The method of any one or more of Implementations 22-25, further comprising: determining, via a sensor coupled to the debris storage unit, a quantity of the debris in the debris storage unit; determining that the quantity of the debris in the debris storage unit has exceeded a threshold; mixing the debris in the debris storage unit with a third fluid; injecting, via a debris injector, the debris and the third fluid into a debris storage formation; and injecting at least a portion of the nonproduction fluid into the subsurface formation.

Implementation #27: The method of any one or more of Implementations 22-26, further comprising: moving the debris into a production tubular; producing the debris to a surface of the well via the production tubular; and producing the first fluid to the surface of the well coordinated with the producing of the debris to the surface of the well.

Implementation #28: The method of any one or more of Implementations 22-27, further comprising: positioning the downhole coalescer within an inclined portion of the well; and setting an approach angle of the downhole coalescer within the inclined portion of the well based, at least in part, on a central axis of the downhole tubular.

Implementation #29: The method of any one or more of Implementations 22-28, further comprising: positioning the downhole coalescer within the well with respect to gravity.

Implementation #30: The method of any one or more of Implementations 22-29, further comprising: measuring, via one or more sensors, a flow parameter of the first fluid; and initiating a cleaning operation of the downhole coalescer based, at least in part, on the measured flow parameter of the first fluid.

Implementation #31: The method of any one or more of Implementations 22-30, further comprising: measuring, via the one or more sensors, one or more operational parameters of the downhole coalescer; and adjusting a positional attribute of the downhole coalescer based, at least in part, on the measured one or more operational parameters obtained via the one or more sensors.

Implementation #32: The method of any one or more of Implementations 22-31, further comprising: positioning the downhole coalescer with respect to a downhole junction, wherein at least the first bore and the second bore meet at the downhole junction.

1. A downhole separation system comprising:
the downhole separation system configured to be positioned downhole in a well formed in a subsurface formation, wherein the downhole separation system is configured to receive a formation fluid from the subsurface formation and configured to separate the formation fluid into a first fluid primarily comprised of a production fluid and a second fluid primarily comprised of a nonproduction fluid, the downhole separation system including,
at least a first coalescer to be positioned within a downhole tubular, wherein the first coalescer is configured to separate out at least a portion of debris and the production fluid from the second fluid.

2. The downhole separation system of claim 1,
wherein the well comprises a multi-bore well, wherein the formation fluid is to be received from the subsurface formation surrounding a first bore of the multi-bore well, and
wherein the downhole separation system comprises a pump configured to pump the nonproduction fluid into a second bore of the multi-bore well for disposal into the subsurface formation surrounding the second bore.

3. The downhole separation system of claim 2, wherein the downhole separation system comprises,
at least one debris injector configured to inject the debris separated out via the first coalescer into a downhole disposal location.

4. The downhole separation system of claim 3, wherein the downhole disposal location comprises the subsurface formation surrounding a third bore of the multi-bore well.

5. The downhole separation system of claim 2, wherein the first coalescer includes one or more coalescer plates, wherein each of the one or more coalescer plates is oriented with respect to gravity.

6. The downhole separation system of claim 5, wherein each of the one or more coalescer plates are removable from the well without a removal of the pump.

7. The downhole separation system of claim 1, further comprising:
a solids catcher positioned below the first coalescer, wherein the solids catcher is configured to receive the debris separated via the first coalescer;
a transport device coupled to the solids catcher, wherein the transport device is configured to move the debris; and
a debris storage unit, wherein the debris storage unit is configured to store the debris moved by the transport device.

8. The downhole separation system of claim 7, further comprising:
a processor;
a computer-readable medium having instructions executable by the processor, the instructions including:
instructions to determine a quantity of the debris in the debris storage unit;
instructions to determine that the quantity of the debris in the debris storage unit has exceeded a threshold;
instructions to mix the debris in the debris storage unit with a third fluid; and
instructions to inject, via a debris injector, the debris and the third fluid into a debris storage formation.

9. The downhole separation system of claim 8, further comprising:
instructions to move the debris into a production tubular; and
instructions to produce the debris to a location of the well via the production tubular,
wherein the production of the debris to another location of the well is timed, via the processor, to be coordinated with a production of the first fluid to a surface of the well.

10. The downhole separation system of claim 8, further comprising:
a mounting mechanism positioned downhole and configured to receive the first coalescer, wherein the first coalescer is configured to couple with the mounting mechanism via an attachment receptacle of the first coalescer,
wherein an angle of approach of the first coalescer is adjustable via the attachment receptacle.

11. The downhole separation system of claim 10, further comprising:
instructions to adjust, via the processor, the angle of approach of the first coalescer, wherein the instructions to adjust the angle of approach of the first coalescer include instructions to adjust an angle of approach of each of one or more coalescer plates of the first coalescer.

12. The downhole separation system of claim 10, wherein an angle of roll of the first coalescer is adjustable via the attachment receptacle.

13. The downhole separation system of claim 10, further comprising:
instructions to adjust, via the mounting mechanism, a yaw of the first coalescer.

14. The downhole separation system of claim 8, further comprising:
at least a first sensor positioned upstream of the first coalescer and configured to sense one or more flow parameters; and
at least a second sensor configured to measure one or more operational parameters of the first coalescer, wherein the instructions further comprise,
instructions to initiate a cleaning of the first coalescer based, at least in part, on a flow rate measurement obtained by at least the first sensor, wherein a flow rate measurement lower than a flow rate threshold initiates the cleaning, and
instructions to adjust a positional attribute of the first coalescer based, at least in part, on measurements obtained via at least the second sensor.

15. An apparatus comprising:
a coalescer to be positioned within a downhole tubular, the coalescer including:
one or more coalescer plates configured to separate debris from a first fluid, wherein the first fluid includes at least a formation fluid, a production fluid or a nonproduction fluid.

16. The apparatus of claim 15, wherein each of the one or more coalescer plates are retrievable from the downhole tubular.

17. The apparatus of claim 15, wherein the one or more coalescer plates are substantially flexible to allow passage of a first tool through the downhole tubular.

18. The apparatus of claim 17, wherein the one or more coalescer plates include strip coalescers formed from one or more rectangular strips, wherein the strips coalescers are configured to allow passage of the first tool through the tubular, and wherein the strip coalescers include one or more gaps configured to allow a lighter fluid of the production fluid to coalesce.

19. The apparatus of claim 18, wherein the strip coalescers include one or more positional devices, wherein the one or more positional devices allow the strip coalescers to move and allow passage of the first tool, and wherein the one or more positional devices are configured to return the strip coalescers to their original position after the passage of the first tool.

20. The apparatus of claim 15, wherein the coalescer includes a plurality of offset coalescer plates configured to be actuated in at least one of a roll and a pitch.

21. The apparatus of claim 15, wherein the coalescer is configured to change one or more flow parameters of the first fluid as the first fluid flows through the coalescer.

22. A method comprising:
performing a downhole fluid separation in a well that is formed in a subsurface formation, the performing including, introducing a formation fluid from the subsurface formation into the well;
separating the formation fluid into a first fluid primarily comprised of a production fluid and a second fluid primarily comprised of a nonproduction fluid; and
filtering, via a downhole coalescer having a plurality of coalescer plates positioned within a downhole tubular, at least a portion of debris and the production fluid from the second fluid.

23. The method of claim 22,
wherein the well comprises a multi-bore well, wherein the formation fluid is to be received from the subsurface formation surrounding a first bore of the multi-bore well,
wherein the method comprises,
disposing of the nonproduction fluid into the subsurface formation surrounding a second bore of the multi-bore well.

24. The method of claim 22, further comprising:
coalescing, via one or more coalescer plates of the downhole coalescer, the production fluid, wherein each of the one or more coalescer plates includes a top side portion configured for filtering the debris from the second fluid and a corrugated underside configured for coalescing the production fluid from the second fluid, wherein the debris falls from the top side portion of the one or more coalescer plates.

25. The method of claim 24, further comprising:
receiving, via a solids catcher positioned below the one or more coalescer plates, the debris separated via the one or more coalescer plates;
transporting, via a transport device coupled to the solids catcher, the debris to a debris storage unit;
storing, via the debris storage unit, the debris transported by the transport device; and
cleaning, via a cleaning tool, the one or more coalescer plates and the debris storage unit, wherein the one or more coalescer plates are comprised of a substantially flexible material configured to allow passage of the cleaning tool through the downhole tubular.

26. The method of claim 25, further comprising:
determining, via a sensor coupled to the debris storage unit, a quantity of the debris in the debris storage unit;
determining that the quantity of the debris in the debris storage unit has exceeded a threshold;
mixing the debris in the debris storage unit with a third fluid;
injecting, via a debris injector, the debris and the third fluid into a debris storage formation; and
injecting at least a portion of the nonproduction fluid into the subsurface formation.

27. The method of claim 22, further comprising:
moving the debris into a production tubular;
producing the debris to a surface of the well via the production tubular; and
producing the first fluid to the surface of the well coordinated with the producing of the debris to the surface of the well.

28. The method of claim 22, further comprising:
positioning the downhole coalescer within an inclined portion of the well; and
setting an approach angle of the downhole coalescer within the inclined portion of the well based, at least in part, on a central axis of the downhole tubular.

29. The method of claim 22, further comprising:
positioning the downhole coalescer within the well with respect to gravity.

30. The method of claim 22, further comprising:
measuring, via one or more sensors, a flow parameter of the first fluid; and
initiating a cleaning operation of the downhole coalescer based, at least in part, on the measured flow parameter of the first fluid.

31. The method of claim 30, further comprising:
measuring, via the one or more sensors, one or more operational parameters of the downhole coalescer; and
adjusting a positional attribute of the downhole coalescer based, at least in part, on the measured one or more operational parameters obtained via the one or more sensors.

32. The method of claim 23, further comprising:
positioning the downhole coalescer with respect to a downhole junction, wherein at least the first bore and the second bore meet at the downhole junction.
